(19) United States
(12) Patent Application Publication
(10) Pub. No.: US 2007/0065660 A1
(43) Pub. Date: Mar. 22, 2007

(54) Antireflection film, polarizing plate, and image display device

(75) Inventors: Yasuhiro Okamoto, Minami-Ashigara-shi (JP); Hiroyuki Yoneyama, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 11/521,453

(22) Filed: Sep. 15, 2006

(30) Foreign Application Priority Data
Sep. 16, 2005 (JP) 2005-270279

(51) Int. Cl. B32B 5/16; B32B 27/00; B32B 27/20

(52) U.S. Cl. 428/328; 428/421; 428/447

(57) ABSTRACT

An antireflection film comprising a support and a low refractive index layer made from a coating composition containing: a fluorine-containing polymer containing at least one fluorine-containing vinyl monomer polymerization unit and at least one hydroxyl group-containing vinyl monomer polymerization unit; and a particle having a conductive metal oxide-coated layer.

### FIELD OF THE INVENTION

The present invention relates to an antireflection film, a polarizing plate using the antireflection film and an image display device using the antireflection film or the polarizing plate for the outermost surface of a display.

### BACKGROUND OF THE INVENTION

In general, in image display devices such as a cathode ray tube display device (CRT), a plasma display (PDP), an electroluminescence display (ELD), and a liquid crystal display device (LCD), for the purpose of preventing a lowering of contrast or reflection of an image due to the reflection of external light, an antireflection film is disposed on the outermost surface of a display so as to reduce a reflectance by using a principle of optical interference.

In general, such an antireflection film can be prepared by forming on a support a low refractive index layer having a refractive index lower than that of the support and having an appropriate thickness. In order to realize a low refractive index, it is desired to use a material having a low refractive index as far as possible for the low refractive index layer.

Also, since the antireflection film is used for the outermost surface of a display, it must have high scar resistance. In a thin film having a thickness of about 100 nm, in order to realize high scar resistance, the film must have strength by itself and adhesiveness to a lower layer.

Also, since the antireflection film is used for the outermost surface of a display device, it is required to have excellent resistance to attachment against various stains centering fingerprints in exhibition or daily use, or even in the case where the film is stained, it is required to have excellent stain wiping properties (the both properties will be hereinafter collectively referred to as “antifouling properties”). Also, it is desired that the surface is hardly charged and is less in the attachment of dusts or that even when dusts are attached, they can be wiped off.

In order to decrease the refractive index of a material, there are measures such as (1) introduction of a fluorine atom and (2) decrease of density (introduction of voids). However, in all of these measures, the film strength or adhesiveness at an interface is lowered so that the scar resistance tends to be lowered. Thus, it was a difficult problem to make low refractive index and high scar resistance compatible with each other. In particular, in the case where a fluorine atom is introduced, the antireflection film is likely negatively charged so that prevention of the attachment of dusts is of a problem.

Also, from the viewpoint of improving the antifouling properties, though the antifouling properties are improved by a method of containing a silicone in a polymer as described in JP-A-11-189621, such was not always sufficient from the viewpoint of practical use. Also, it is known that the improvement of antifouling properties is achieved by a fluorine based antifouling agent. Though a terminal silanol-modified fluorine based antifouling agent is a representative compound, it is likely negatively charged, and its resistance to attachment of dusts is liable to be remarkably deteriorated.

Also, a method of providing a so-called “antistatic layer” containing a conductive particle is known by JP-A-2005-196122. However, this method involves a problem that a layer must be newly provided so that loads of equipment and time at the time of manufacture are large. Also, the major part of antistatic conductive particles which have hitherto been generally used has a refractive index of particle of from about 1.6 to 2.2, and the refractive index of the antistatic layer containing such a particle inevitably increases. Because of a high refractive index of the antistatic layer, in optical films, non-intended interference unevenness is generated due to a difference in the refractive index from adjacent layers, or the color taste of an opposite color becomes strong. Thus, improvements in these points are being demanded.

From the viewpoint of lowering the refractive index of a conductive particle, JP-A-2005-119909 (corresponding to US 2005/0121654 A1) describes that a particle resulting from coating a surface of a silica particle with antimony oxide is used in a low refractive index layer. However, JP-A-2005-119909 (corresponding to US 2005/0121654 A1) does not describe a technology for improving the antifouling properties so that this technology is in a level requiring a further improvement in view of the antifouling properties.

### SUMMARY OF THE INVENTION

An object of the invention is to provide an antireflection film which is low in reflection, excellent in scar resistance and antifouling properties, high in conductivity and excellent in dustproof properties. In addition, another object of the invention is to provide a polarizing plate and an image display device using such an antireflection film.

In order to overcome the foregoing problems, the present inventor made extensive and intensive investigations. As a result, it has been found that the following constitutions can solve the foregoing problems to attain the foregoing objects, leading to accomplishment of the invention.

That is, the invention has attained the foregoing objects by the following constitutions.
(1) An antireflection film comprising a support having provided thereon a low refractive index layer made of a coating composition containing the following components (A) and (B):

(A) a fluorine-containing polymer containing at least one fluorine-containing vinyl monomer polymerization unit and at least one hydroxyl group-containing vinyl monomer polymerization unit; and

(B) a fine particle having a conductive metal oxide-coated layer.
(2) The antireflection film as set forth in (1), wherein the fine particle having a conductive metal oxide-coated layer is a fine particle which is porous in the inside thereof or has voids in the inside thereof.
(3) The antireflection film as set forth in (1) or (2), wherein the fine particle having a conductive metal oxide-coated layer is a silica based fine particle having an antimony oxide-coated layer and having a refractive index in the range of from 1.35 to 1.60 and a volume resistivity value in the range of from 10 to 5,000 Ω·cm.
(4) The antireflection film as set forth in (3), wherein the silica based fine particle is a porous silica based fine particle or a silica based fine particle having voids in the inside thereof.
(5) The antireflection film as set forth in any one of (1) to (4), wherein the coating composition further contains (C) a crosslinking agent capable of reacting with a hydroxyl group.
(6) The antireflection film as set forth in any one of (1) to (5), wherein the coating composition further contains (D) an organosilane compound or a hydrolyzate of the organosilane compound and/or a partial condensate thereof.
(7) The antireflection film as set forth in any one of (1) to (6), wherein the coating composition further contains (E) a compound containing two or more (meth)acryloyl groups in one molecule thereof.
(8) The antireflection film as set forth in any one of (1) to (7), wherein the coating composition further contains (F) a compound having a polysiloxane structure represented by the following formula (1) and having a hydroxyl group or a structure capable of reacting with a hydroxyl group to form a bond.

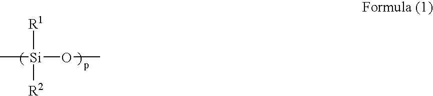

In the formula (1), R¹ and R² may be the same or different and each represents an alkyl group or an aryl group; and p represents an integer of from 2 to 500.
(9) The antireflection film as set forth in any one of (1) to (8), wherein the coating composition further contains (G) a fluorine-containing antifouling agent containing a hydroxyl group or having a structure capable of reacting with a hydroxyl group to form a bond.
(10) The antireflection film as set forth in any one of (1) to (9), wherein the fluorine-containing polymer is a fluorine-containing polymer in which a principal chain thereof is made of only carbon atoms and the content of the hydroxyl group-containing vinyl monomer polymerization unit exceeds 20% by mole.
(11) The antireflection film as set forth in any one of (1) to (10), wherein the fluorine-containing polymer is a copolymer having a polysiloxane structure represented by the following formula (1) in a partial structure thereof.

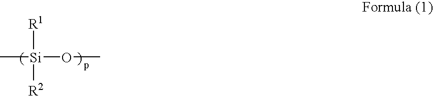

In the formula (1), R¹ and R² may be the same or different and each represents an alkyl group or an aryl group; and p represents an integer of from 2 to 500.
(12) The antireflection film as set forth in any one of (1) to (11), wherein the coating composition further contains at least one salt comprising an organic base and an acid and having a pKa of from 5.0 to 10.5 in terms of a conjugated acid thereof.
(13) The antireflection film as set forth in any one of (1) to (12), wherein the coating composition further contains at least one salt comprising a nitrogen-containing organic base and an acid and having a boiling point of 35° C. or higher and not higher than 85° C.
(14) A polarizing plate comprising two protective films and a polarizing film provided between the protective films, wherein one of the protective films is the antireflection film as set forth in any one of (1) to (13).
(15) An image display device comprising the antireflection film as set forth in any one of (1) to (13) or the polarizing plate as set forth in (14), wherein the antireflection film or the polarizing plate is used for the outermost surface of a display.

Nevertheless the antireflection film of the invention has sufficient antireflection properties, it is excellent in both scar resistance and antifouling properties, high in conductivity and excellent in dustproof properties. Furthermore, since the antireflection film of the invention is produced by using a coating solution in which storage properties and hardening activity are made compatible with each other, it has high production adaptability. In addition, the image display device provided with the antireflection film of the invention and the image display device provided with the polarizing plate using the antireflection film of the invention are less in reflection by external light and reflection of the background and extremely high in visibility.

### BRIEF DESCRIPTION OF THE DRAWINGS

FIG. 1 is an outline cross-sectional view to schematically show a preferred embodiment of the film of the invention.

FIG. 2 is an outline cross-sectional view to schematically show a preferred embodiment of the film of the invention.

FIG. 3 is an outline cross-sectional view to schematically show a preferred embodiment of the film of the invention.

FIG. 4 is an outline cross-sectional view to schematically show a preferred embodiment of the film of the invention.

FIG. 5 is an outline cross-sectional view to schematically show a preferred embodiment of the film of the invention.

### DESCRIPTION OF REFERENCE NUMERALS AND SIGNS

1: Support

2: Hard coat layer

3: Middle refractive index layer

4: High refractive index layer

5: Low refractive index layer

### DETAILED DESCRIPTION OF THE INVENTION

The invention will be hereunder described in more detail. Incidentally, in this specification, in the case where a numeral value exhibits a physical property value, a characteristic value or the like, the terms “from (numeral value 1) to (numeral value 2)” means “(numeral value 1) or more and not more than (numeral value 2)”. Also, in this specification, the term “(meth)acrylate” means “at least one of acrylate and methacrylate”. The same is also applicable to “(meth)acrylic acid” and so on.

The low refractive index layer of the invention is provided by coating a coating composition containing the following components (A) and (B).
(A) Fluorine-containing polymer containing at least one fluorine-containing vinyl monomer polymerization unit and at least one hydroxyl group-containing vinyl monomer polymerization unit
(B) Fine particle having a conductive metal oxide-coated layer

A refractive index of the low refractive index layer of the invention is preferably from 1.20 to 1.46, more preferably from 1.25 to 1.46, and especially preferably from 1.30 to 1.46. A surface resistivity (log SR) of the antireflection film containing a low refractive index layer of the invention is preferably 5 or more and not more than 13, more preferably 7 or more and not more than 12, and most preferably 8 or more and not more than 10. According to the invention, by making the refractive index and the surface resistivity fall within the foregoing ranges, respectively, it is possible to keep favorable scar resistance while keeping the low refractive index and the dustproof properties in favorable levels.

A thickness of the low refractive index layer is preferably from 50 to 200 nm, and more preferably from 70 to 100 nm. A haze of the low refractive index layer is preferably not more than 3%, more preferably not more than 2%, and most preferably not more than 1%. A concrete strength of the low refractive index layer is preferably H or more, more preferably 2H or more, and most preferably 3H or more according to a pencil hardness test with a load of 500 g.

Furthermore, for the purpose of improving the antifouling performance of an optical film, a contact angle of the surface against water is preferably 90 degrees or more, more preferably 95 degrees or more, and especially preferably 100 degrees or more.

First of all, the constitutional components which can be used in the low refractive index layer of the invention will be hereunder described.

<Fluorine-Containing Polymer Binder [Constitutional Component (A) of Low Refractive Index Layer of the Invention]>

In the low refractive index layer of the invention, there is used a polymer, a principal chain of which is made of only carbon atoms and which contains at least one fluorine-containing vinyl monomer polymerization unit and at least one hydroxyl group-containing vinyl monomer polymerization unit, wherein the content of the hydroxyl group-containing vinyl monomer polymerization unit exceeds 20% by mole, provided that the polymer does not have a polysiloxane structure in the principal chain.

(Fluorine-Containing Vinyl Monomer Polymerization Unit)

In the invention, a structure of the fluorine-containing vinyl monomer polymerization unit which is contained in the fluorine-containing polymer to be used for forming a low refractive index layer is not particularly limited, and examples thereof include polymerization units based on a fluorine-containing olefin, a perfluoroalkyl vinyl ether, a fluorine-containing alkyl group-containing vinyl ether or (meth)acrylate, and so on. In view of production adaptability and properties which are required in the low refractive index layer, such as refractive index and film strength, the fluorine-containing polymer is preferably a copolymer of a fluorine-containing olefin and a vinyl ether, and more preferably a copolymer of a perfluoroolefin and a vinyl ether. Furthermore, a perfluoroalkyl vinyl ether, a fluorine-containing alkyl group-containing vinyl ether or (meth)acrylate, or the like may be contained as a copolymerization component for the purpose of lowering the refractive index.

As the perfluoroolefin, ones having from 3 to 7 carbon atoms are preferable; perfluoropropylene and perfluorobutylene are preferable from the viewpoint of polymerization reactivity; and perfluoropropylene is especially preferable from the viewpoint of easiness of availability.

The content of the perfluoroolefin in the polymer is from 25 to 75% by mole. In order to realize a low refractive index of the material, though it is desired to increase a rate of introduction of the perfluoroolefin, the introduction of from about 50 to 70% by mole is a limit in a general solution based radical polymerization reaction from the standpoint of polymerization reactivity, and the introduction exceeding the foregoing range is difficult. In the invention, the subject content is preferably from 30% to 70% by mole, more preferably from 30% to 60% by mole, further preferably from 35% to 60% by mole, and especially preferably from 40 to 60% by mole.

Furthermore, in the invention, in order to realize a low refractive index, a fluorine-containing vinyl ether represented by the following M2 may be copolymerized. The subject copolymerization component may be introduced into the polymer in the range of from 0 to 40% by mole, preferably from 0 to 30% by mole, and especially preferably from 0 to 20% by mole.

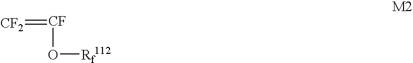

In M2, Rf¹¹² represents a fluorine-containing alkyl group having from 1 to 30 carbon atoms, preferably a fluorine-containing alkyl group having from 1 to 20 carbon atoms, especially preferably a fluorine-containing alkyl group having from 1 to 10 carbon atoms, and further preferably a perfluoroalkyl group having from 1 to 10 carbon atoms. Furthermore, the subject fluorine-containing alkyl group may have a substituent. Specific examples of Rf¹¹² include —CF₃ {M2-(1)}, —CF₂CF₃ {M2-(2)}, —CF₂CF₂CF₃ {M2-(3)}, and —CF₂CF(OCF₂CF₂CF₃)CF₃ {M3-(4)}.

(Hydroxyl Group-Containing Vinyl Monomer Polymerization Unit)

It is required that the fluorine-containing polymer which is used in the invention contains a hydroxyl group-containing vinyl monomer polymerization unit, the content of which is more than 20% by mole in the polymer. Though its content is not particularly limited, since the hydroxyl group has a function such that it is hardened upon reaction with a crosslinking agent, what the content of the hydroxyl group is high is preferable because a hard film can be formed. Its content is preferably more than 20% by mole and not more than 70% by mole, more preferably more than 20% by mole and not more than 60% by mole, and further preferably 25% by mole or more and not more than 55% by mole.

So far as the hydroxyl group-containing vinyl monomer is copolymerizable with the foregoing fluorine-containing vinyl monomer polymerization unit, it can be used without particular limitations, and examples thereof include vinyl ethers, (meth)acrylates, and styrenes. For example, in the case where a perfluoroolefin (for example, hexafluoropropylene) is used as the fluorine-containing vinyl monomer, it is preferred to use a hydroxyl group-containing vinyl ether with good copolymerizability. Specific examples thereof include 2-hydroxyethyl vinyl ether, 4-hydroxybutyl vinyl ether, 6-hydroxyhexyl vinyl ether, 8-hydroxyoctyl vinyl ether, diethylene glycol vinyl ether, triethylene glycol vinyl ether, and 4-(hydroxymethyl)cyclohexylmethyl vinyl ether. But, it should not be construed that the invention is limited thereto.

Furthermore, in the invention, in order to realize a low refractive index, a fluorine-containing vinyl ether represented by the following M1 may be copolymerized. The subject copolymerization component may be introduced into the polymer in the range of from 0 to 40% by mole, preferably from 0 to 30% by mole, and especially preferably from 0 to 20% by mole.

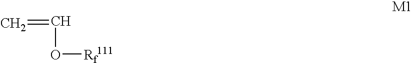

In M1, Rf¹¹¹ represents a fluorine-containing alkyl group having from 1 to 30 carbon atoms, preferably a fluorine-containing alkyl group having from 1 to 20 carbon atoms, and especially preferably a fluorine-containing alkyl group having from 1 to 15 carbon atoms; may be linear {for example, —CF₂CF₃, —CH₂(CF₂)ₐH, and —CH₂CH₂(CF₂)ₐF (a: an integer of from 2 to 12)}; may have a branched structure {for example, —CH(CF₃)₂, —CH₂CF(CF₃)₂, —CH(CH₃)CF₂CF₃, and —CH(CH₃)(CF₂)₅CF₂H}; may have an alicyclic structure (preferably a 5-membered ring or a 6-membered ring, for example, a perfluorocyclohexyl group, a perfluorocyclopentyl group, and an alkyl group substituted with such a group); and may contain an ether bond {for example, —CH₂OCH₂CF₂CF₃, —CH₂CH₂OCH₂(CF₂)_{b}H, —CH₂CH₂OCH₂(CF₂)_{b}F (b: an integer of from 2 to 12), and —CH₂CH₂OCF₂CF₂OCF₂CF₂H}. Incidentally, it should not be construed that the substituent represented by Rf¹¹¹ is limited to the substituents as enumerated herein.

The foregoing monomer represented by M1 can be, for example, synthesized by a method of making a fluorine-containing alcohol act to a split-off group-substituted alkyl vinyl ether such as vinyloxyalkyl sulfonates and vinyloxyalkyl chlorides in the presence of a base catalyst as described in Macromolecules, Vol. 32 (21), p.7122 (1999), JP-A-2-721, and so on; a method of mixing a fluorine-containing alcohol and a vinyl ether such as butyl vinyl ether in the presence of a palladium catalyst, thereby undergoing exchange of the vinyl group as described in WO 92/05135; and a method of making a fluorine-containing ketone and dibromoethane react with each other in the presence of a potassium fluoride catalyst and then undergoing a dehydrobrimination reaction by an alkaline catalyst as described in U.S. Pat. No. 3,420,793.

Preferred examples of the constitutional component represented by M1 will be given below, but it should not be construed that the invention is limited thereto. 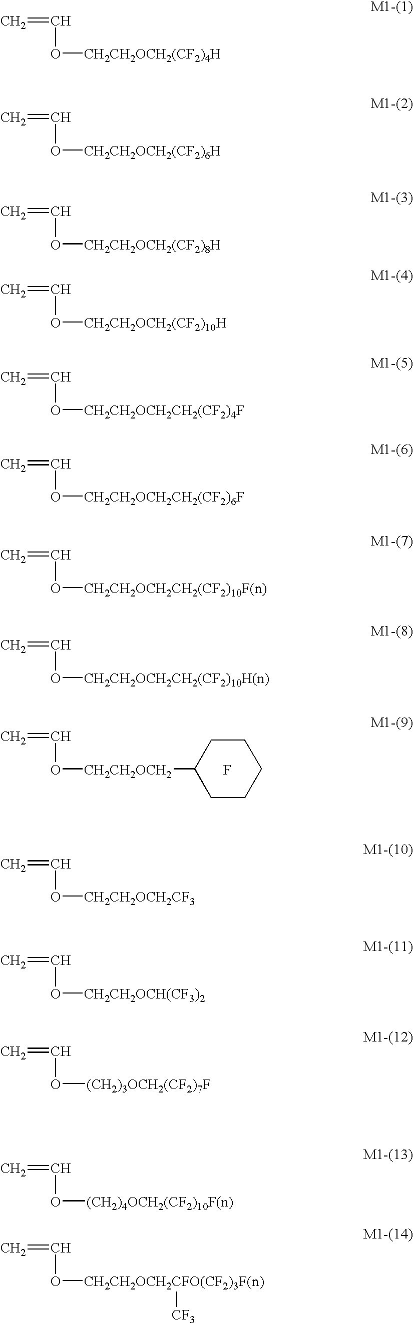 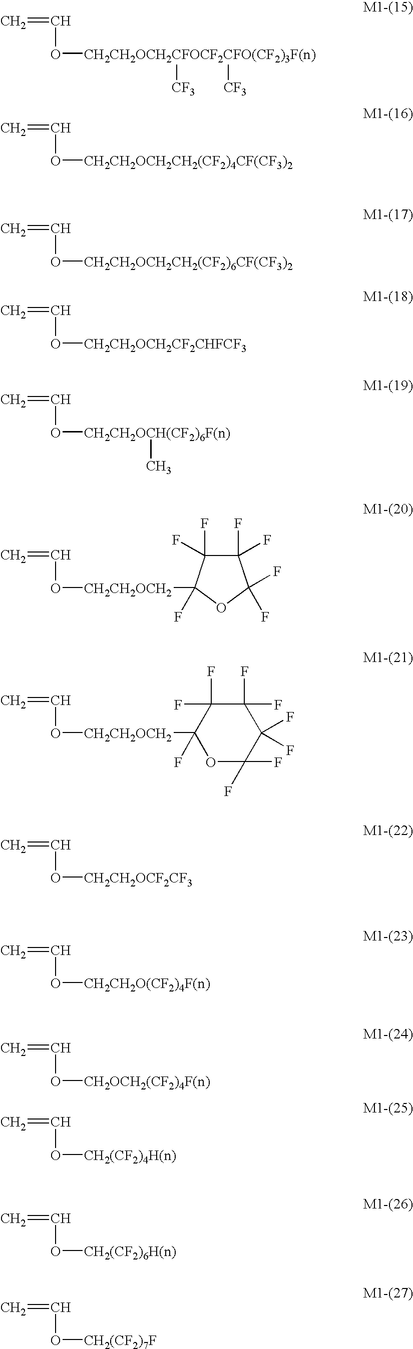 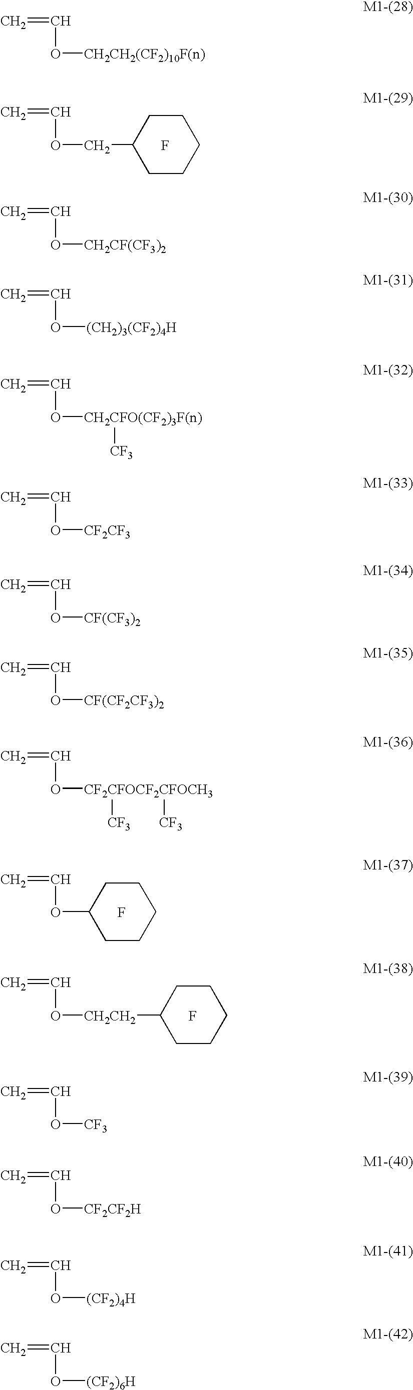
(Constitutional Unit Having a Polysiloxane Structure)

In order to impart antifouling properties, it is also preferable that the fluorine-containing polymer of the invention contains a constitutional unit having a polysiloxane structure in its partial structure. Preferable examples of the fluorine-containing polymer having a polysiloxane structure which is useful in the invention include a fluorine-containing polymer which contains (a) at least one fluorine-containing vinyl monomer polymerization unit, (b) at least one hydroxyl group-containing vinyl monomer polymerization unit and (c) at least one polymerization unit having a polysiloxane structure (repeating unit) capable of forming a graft site in a side chain thereof and represented by the following formula (1), and in which a principal chain thereof is made of only carbon atoms; and a fluorine-containing polymer which contains (a) at least one fluorine-containing vinyl monomer polymerization unit and (b) at least one hydroxyl group-containing vinyl monomer polymerization unit and (d) containing a polysiloxane repeating unit represented by the following formula (1) in a principal chain thereof

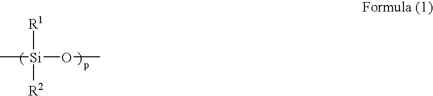

In the formula (1), R¹ and R² may be the same or different and each represents an alkyl group or an aryl group. The alkyl group preferably has from 1 to 4 carbon atoms, and examples thereof include a methyl group, a trifluoromethyl group, and an ethyl group. The aryl group preferably has from 6 to 20 carbon atoms, and examples thereof include a phenyl group and a naphthyl group. Of these, a methyl group and a phenyl group are preferable; and a methyl group is especially preferable. p represents an integer of from 2 to 500, preferably from 5 to 350, and especially preferably from 8 to 250.

The polymer having a polysiloxane structure represented by the formula (1) in a side chain thereof can be synthesized by a method in which with respect to a polymer containing a reactive group (for example, an epoxy group, a hydroxyl group, a carboxyl group, and an acid anhydride group), a polysiloxane containing a corresponding reactive group (for example, an amino group, a mercapto group, a carboxyl group, and a hydroxyl group with respect to the epoxy group or acid anhydride group) at one terminal thereof (for example, SILAPLANE Series (manufactured by Chisso Corporation) is introduced by a polymerization reaction as described in, for example, J. Appl. Polym. Sci., 78, 1955 (2000) and JP-A-56-28219; and a method of polymerizing a polysiloxane-containing silicon macromer, and the both methods can be preferably employed. In the invention, a method for achieving the introduction by polymerizing a silicon macromer is more preferable.

As the silicon macromer, any silicon macromer containing a polymerizable group which is able to undergo copolymerization with a fluorine-containing olefin is useful. Structures represented by any one of the following formulae (2) to (5) are preferable.

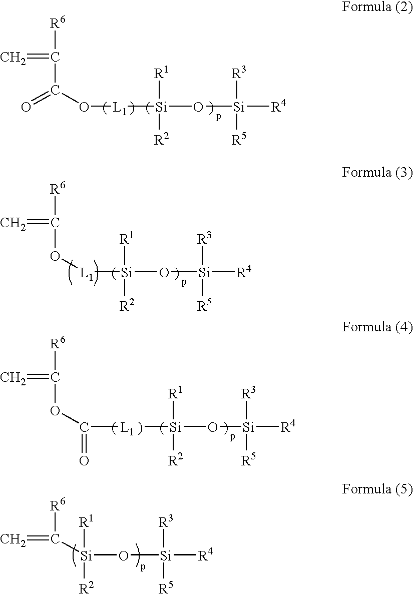

In the formulae (2) to (5), R¹, R² and p have the same meanings as in the formula (1); and preferred ranges thereof are also the same. R³ to R⁵ each independently represents a substituted or unsubstituted monovalent organic group or a hydrogen atom. Above all, an alkyl group having from 1 to 10 carbon atoms (for example, a methyl group, an ethyl group, and an octyl group), an alkoxy group having from 1 to 10 carbon atoms (for example, a methoxy group, an ethoxy group, and a propyloxy group), and an aryl group having from 6 to 20 carbon atoms (for example, a phenyl group and a naphthyl group) are preferable; and an alkyl group having from 1 to 5 carbon atoms is especially preferable. R⁶ represents a hydrogen atom or a methyl group. L₁ represents an arbitrary connecting group having from 1 to 20 carbon atoms; and examples thereof include a substituted or unsubstituted, linear branched or alicyclic alkylene group and a substituted or unsubstituted arylene group. Above all, an unsubstituted linear alkylene group having from 1 to 20 carbon atoms is preferable; and an ethylene group and a propylene group are especially preferable. These compounds can be synthesized by a method as described in, for example, JP-A-6-322053.

All of the compounds represented by the formulae (2) to (5) can be preferably used in the invention. Above all, compounds having a structure represented by the formula (2), (3) or (4) are especially preferable from the viewpoint of copolymerizability with a fluorine-containing olefin. The foregoing polysiloxane site preferably accounts for from 0.01 to 20% by weight, more preferably from 0.05 to 15% by weight, and especially preferably from 0.5 to 10% by weight in the graft copolymer.

Preferred examples of the polymerization unit of the polymer graft site containing a polysiloxane site in a side chain thereof which is useful in the invention will be given below, but it should not be construed that the invention is limited thereto.

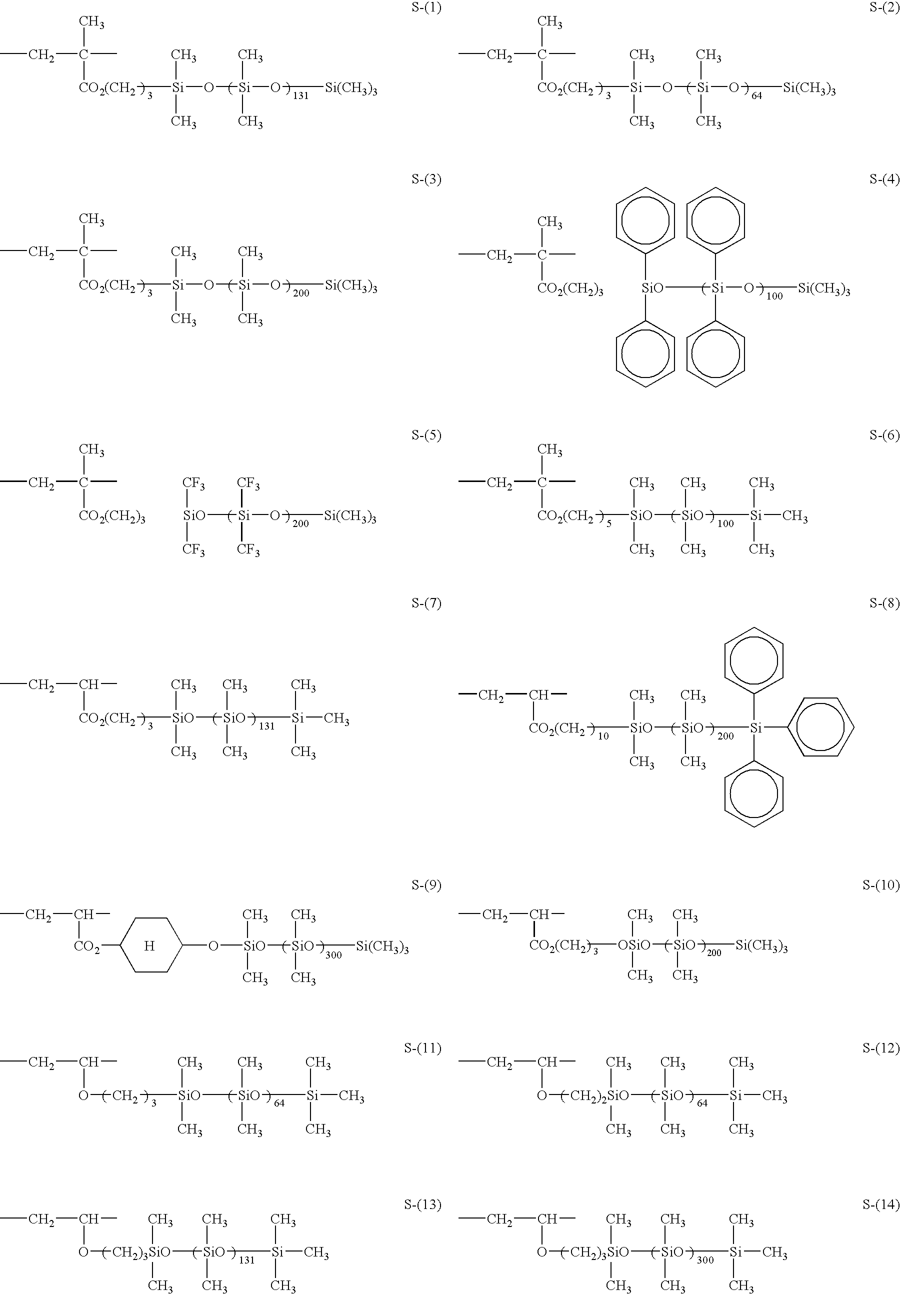

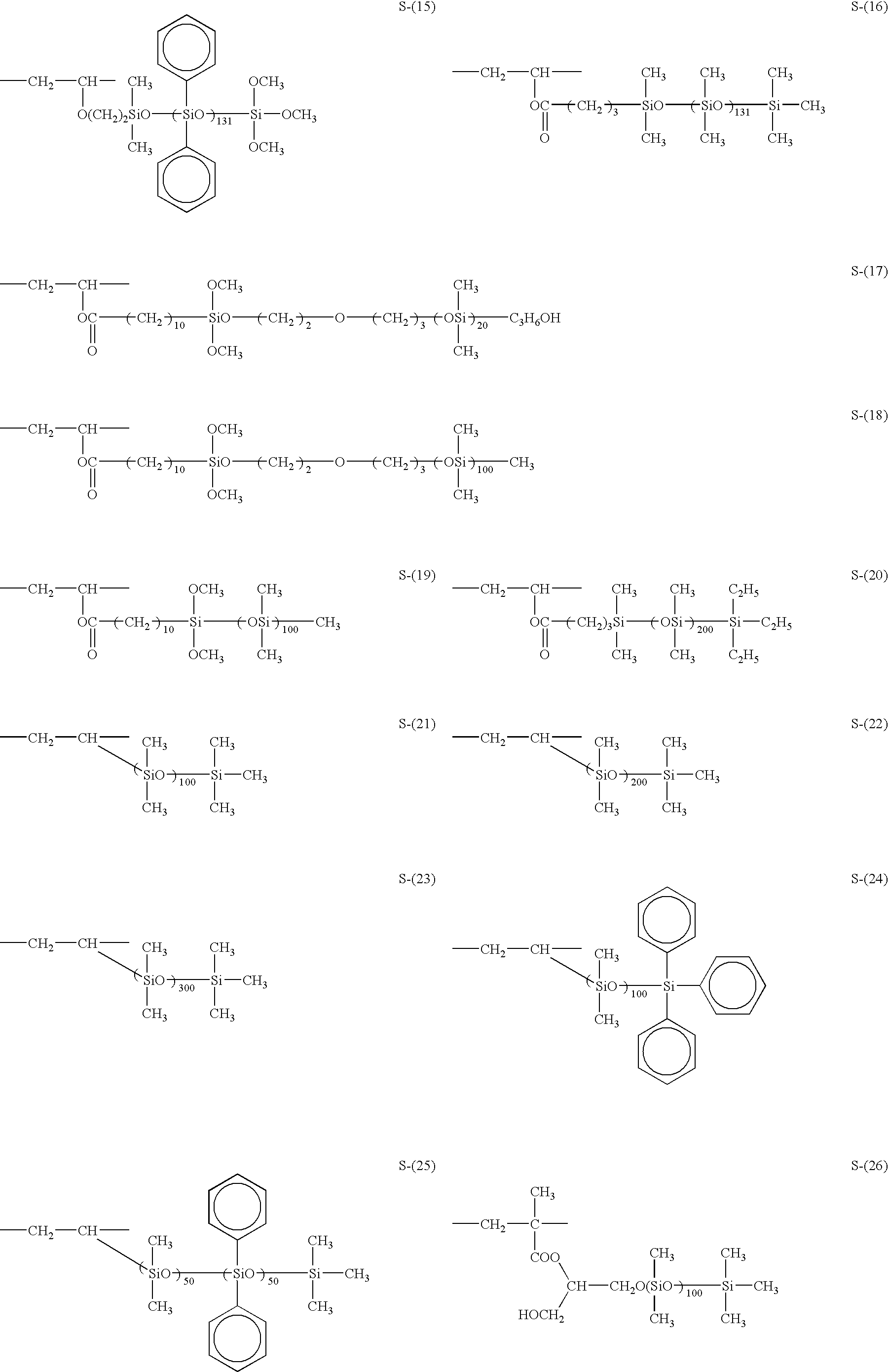

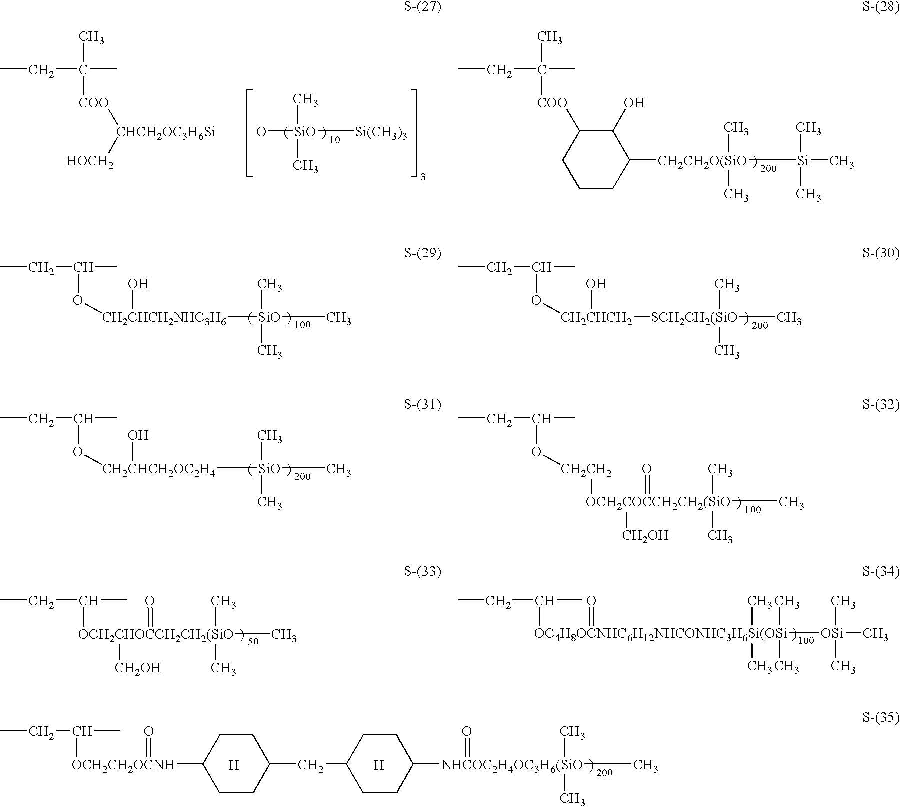

S-(36) SILAPLANE FM-0711 (manufactured by Chisso Corporation)

S-(37) SILAPLANE FM-0721 (manufactured by Chisso Corporation)

S-(38) SILAPLANE FM-0725 (manufactured by Chisso Corporation)

By introducing the polysiloxane structure, not only antifouling properties and dust removal properties are imparted to the film, but also slipperiness is imparted to the film surface. Also, such is advantageous with respect to the scar resistance.

(Other polymerization Units)

Other copolymerization components capable of forming the polymerization unit can be properly selected from various viewpoints of, for example, hardness, adhesiveness to a substrate, solubility in a solvent, and transparency. Examples thereof include vinyl ethers such as methyl vinyl ether, ethyl vinyl ether, t-butyl vinyl ether, n-butyl vinyl ether, cyclohexyl vinyl ether, and isopropyl vinyl ether; and vinyl esters such as vinyl acetate, vinyl propionate, vinyl butyrate, and vinyl cyclohexanecarboxylate. The amount of introduction of such a copolymerization component is in the range of from 0 to 40% by mole, preferably from 0 to 30% by mole, and especially preferably from 0 to 20% by mole.

(Configuration of Preferred Fluorine-Containing Polymer)

A configuration of the polymer which is especially preferable in the invention is a configuration represented by the following formula (7).

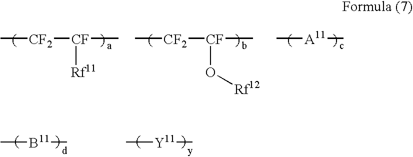

In the formula (7), Rf¹¹ represents a perfluoroalkyl group having from 1 to 5 carbon atoms. With respect to the site represented by —CF₂CF(Rf¹¹), the foregoing explanation regarding the perfluoroolefin as an example is applicable. In the formula (7), Rf¹² is the same as defined above for the fluorine-containing vinyl ether (Rf¹¹² in the compound represented by the foregoing formula M2); and a preferred range thereof is also the same. A¹¹ and B¹¹ each represents a hydroxyl group-containing vinyl monomer polymerization unit or an arbitrary constitutional unit. A¹¹ is the same as defined above for the hydroxyl group-containing vinyl monomer polymerization unit. Though B¹¹ is not particularly limited, it is preferably a vinyl ether or a vinyl ester from the viewpoint of copolymerizability. Concretely, there are enumerated the foregoing enumerated monomers (other polymerization units) and the monomers represented by the foregoing formula M1.

Y¹¹ represents a constitutional unit having a polysiloxane structure; and its configuration may be a polymerization unit having a graft site containing, in a side chain thereof, a polysiloxane repeating unit represented by the foregoing formula (1). Its definition and preferred range are the same as described above (the constitutional unit having a polysiloxane structure).

a to d each represents a molar fraction (%) of each of the constitutional components; and (a+b+c+d) is equal to 100. There are satisfied the relationships: 30≦a≦70 (more preferably 30≦a≦60, and further preferably 35≦a≦60), 0≦b≦40 (more preferably 0≦b≦30, and further preferably 0≦b≦20), 20≦c≦70 (more preferably 20≦c≦60, and further preferably 25≦c≦55), and 0≦d≦40 (more preferably 0≦d≦30).

y represents a weight fraction (%) of the polysiloxane-containing constitutional unit against the whole of the fluorine-containing polymer. There is satisfied the relationship: 0.01≦y≦20 (more preferably 0.05≦y≦15, and further preferably 0.5≦y≦10).

In the invention, as another embodiment for introducing a polysiloxane structure into the fluorine-containing polymer of the invention, there is enumerated an embodiment for introducing a polysiloxane structure into the principal chain. Though a method of introducing a polysiloxane partial structure into the principal chain is not particularly limited, examples thereof include a method of using a polymer type initiator such as an azo group-containing polysiloxane amide (for example, commercially available VPS-0501 and VPS-1001 (trade names of Wako Pure Chemicals Industries, Ltd.)) as described in JP-A-6-93100; a method in which a reactive group derived from a polymerization initiator or a chain transfer agent (for example, a mercapto group, a carboxyl group, and a hydroxyl group) is introduced into a polymer terminal and then made to react with a polysiloxane containing a reactive group (for example, an epoxy group and isocyanate group) on one terminal or both terminals thereof; and a method of copolymerizing a cyclic siloxane oligomer such as hexamethylcyclotrisiloxane by anionic ring-opening polymerization. Above all, a method of utilizing an initiator having a polysiloxane partial structure is easy and preferable.

In the invention, a number average molecular weight of the fluorine-containing polymer which is used for forming a low refractive index layer is preferably from 5,000 to 1,000,000, more preferably from 8,000 to 500,000, and. especially preferably from 10,000 to 100,000.

Here, the number average molecular weight is a molecular weight as reduced into polystyrene by means of detection with a differential refractometer in THF as a solvent by a GPC analyzer using columns of TSKgel GMHxL, TSKgel G4000HxL and TSKgel G2000HxL (all of which are a trade name of Tosoh Corporation).

Specific examples of the polymer which is useful in the invention are given in Tables 1 to 5, but it should not be construed that the invention is limited thereto.

Incidentally, in Tables 1 to 5, combinations of polymerization units are written.

TABLE 1

| | | | | | | | | | | | | |
|---|---|---|---|---|---|---|---|---|---|---|---|---|
| Fluorine-containing | | | | | | | | | | | | |
| polymer | P1 | P2 | P3 | P4 | P5 | P6 | P7 | P8 | P9 | P10 | P11 | P12 |

Silicone-containing constitutional component (% by weight)

| | | | | | | | | | | | | |
|---|---|---|---|---|---|---|---|---|---|---|---|---|
| Hexafluoro- | 50 | 50 | 50 | 50 | 50 | 50 | 50 | 50 | 50 | 50 | 50 | 50 |
| propylene | | | | | | | | | | | | |
| M1-(2) | | | | | | | | | | | | |
| M1-6 | | | | | | | | | | | | |
| M2-3 | | | | | | | | | | | | |
| HEVE | 50 | 50 | 50 | 50 | 50 | 50 | 50 | 50 | 50 | 50 | 50 | 50 |
| HBVE | | | | | | | | | | | | |
| HOVE | | | | | | | | | | | | |
| DEGVE | | | | | | | | | | | | |
| HMcHVE | | | | | | | | | | | | |
| EVE | | | | | | | | | | | | |
| cHVE | | | | | | | | | | | | |
| tBuVE | | | | | | | | | | | | |
| VAc | | | | | | | | | | | | |

Fluorine-containing polymer constitutional component (molar fraction (%))

| | | | | | | | | | | | | |
|---|---|---|---|---|---|---|---|---|---|---|---|---|
| VPS-0501 | | 2.5 | | | | | | | | | | |
| VPS-1001 | | | 2.3 | | | | | | | | | |
| S-(1) | | | | 2 | | | | | | | | |
| S-(2) | | | | | 2.1 | | | | | | | |
| S-(11) | | | | | | 2 | | | | | | |
| S-(13) | | | | | | | 2 | | | | | |
| S-(16) | | | | | | | | 1.8 | | | | |
| S-(21) | | | | | | | | | 2 | | | |
| S-(29) | | | | | | | | | | 2 | | |
| S-(30) | | | | | | | | | | | 1.7 | |
| S-(36) | | | | | | | | | | | | 2.1 |
| S-(37) | | | | | | | | | | | | |
| S-(38) | | | | | | | | | | | | |
| Other Component | | | | | | | | | | | | |
| NE-30 | | | | | | | | | | | | |
| Molecular weight | 1.5 | 2.5 | 2.4 | 1.7 | 2.2 | 2.6 | 1.9 | 2.4 | 2.9 | 3.5 | 4.1 | 2.5 |
| (×10,000) | | | | | | | | | | | | |

TABLE 2

| | | | | | | | | | | | | |
|---|---|---|---|---|---|---|---|---|---|---|---|---|
| Fluorine-containing | | | | | | | | | | | | |
| polymer | P13 | P14 | P15 | P16 | P17 | P18 | P19 | P20 | P21 | P22 | P23 | P24 |

Fluorine-containing polymer constitutional component (molar fraction (%))

| | | | | | | | | | | | | |
|---|---|---|---|---|---|---|---|---|---|---|---|---|
| Hexafluoro- | 50 | 50 | 50 | 50 | 50 | 50 | 50 | 50 | 50 | 50 | 50 | 50 |
| propylene | | | | | | | | | | | | |
| M1-(2) | | | | | | | | | | | 10 | |
| M1-(6) | | | | | | | | | | | | 10 |
| M2-3 | | | | | | | | | | | | |
| HEVE | 50 | 50 | 40 | 40 | 40 | 40 | 40 | 40 | 40 | 40 | 40 | 40 |
| HBVE | | | | | | | | | | | | |
| HOVE | | | | | | | | | | | | |
| DEGVE | | | | | | | | | | | | |
| HMcHVE | | | | | | | | | | | | |
| EVE | | | 10 | 10 | 10 | 10 | 10 | 10 | 10 | 10 | | |
| cHVE | | | | | | | | | | | | |
| tBuVE | | | | | | | | | | | | |
| VAc | | | | | | | | | | | | |

Silicone-containing constitutional component (% by weight)

| | | | | | | | | | | | | |
|---|---|---|---|---|---|---|---|---|---|---|---|---|
| VPS-0501 | | | | 2.5 | 2.5 | | | | | | | |
| vPS-1001 | | | | | | | | | | | | |
| S-(1) | | | | | | 2.5 | | | | | | |
| S-(2) | | | | | | | | | | | | |
| S-(11) | | | | | | | 2.3 | | | | | |
| S-(13) | | | | | | | | | | | | |
| S-(30) | | | | | | | | 2.5 | | | | |
| S-(36) | | | | | | | | | | | | |
| S-(37) | | | | | | | | | 6.6 | | | |
| S-(38) | | | | | | | | | | 3.8 | | 3.6 |
| Other Component | | | | | | | | | | | | |
| NE-30 | | | | | 0.9 | | | | | | | |
| Molecular weight | 2.2 | 1.7 | 1.5 | 2.5 | 2.4 | 1.7 | 2.1 | 4.5 | 2.8 | 2.5 | 1.6 | 3.1 |
| (×10,000) | | | | | | | | | | | | |

TABLE 3

| | | | | | | | | | | | | |
|---|---|---|---|---|---|---|---|---|---|---|---|---|
| Fluorine-containing | | | | | | | | | | | | |
| polymer | P25 | P26 | P27 | P28 | P29 | P30 | P31 | P32 | P33 | P34 | P35 | P36 |

Fluorine-containing polymer constitutional component (molar fraction (%))

| | | | | | | | | | | | | |
|---|---|---|---|---|---|---|---|---|---|---|---|---|
| Hexafluoro- | 45 | 50 | 50 | 40 | 40 | 40 | 40 | 40 | 50 | 50 | 50 | 50 |
| propylene | | | | | | | | | | | | |
| M1-(2) | | | | 10 | | | | | | | 10 | |
| M1-(6) | | | | | 10 | | | | | | | 5 |
| M2-3 | 5 | | | | | 10 | 10 | 10 | | | | |
| HEVE | 40 | 30 | 20 | 15 | 15 | 15 | 15 | 25 | | | | |
| HBVE | | | | | | | | | 40 | 30 | 40 | 20 |
| HOVE | | | | | | | | | | | | |
| DEGVE | | | | | | | | | | | | |
| HMcHVE | | | | | | | | | | | | |
| EVE | | | 30 | 35 | 35 | 35 | 35 | 25 | 10 | 20 | | |
| cHVE | 10 | | | | | | | | | | | |
| tBuVE | | 20 | | | | | | | | | | |
| VAc | | | | | | | | | | | | 25 |

Silicone-containing constitutional component (% by weight)

| | | | | | | | | | | | | |
|---|---|---|---|---|---|---|---|---|---|---|---|---|
| VPS-0501 | | | | | 2.5 | | 2.5 | | | | | |
| VPS-1001 | | | | 2.5 | | 2.5 | | | | | | |
| S-(1) | | | 1.8 | | | | | | | | | |
| S-(2) | | | | | | | | | 3.1 | | | |
| S-(11) | 1.9 | | | | | | | | | | 1.9 | |
| S-(13) | | | | | | | | | | | | |
| S-(30) | | | | | | | | | | | | 3.1 |
| S-(36) | | | | | | | | | | | | |
| S-(37) | | 4.2 | | | | | | 1.7 | | | | |
| S-(38) | | | | | | | | | | 2.8 | | |
| Other Component | | | | | | | | | | | | |
| NE-30 | | | | | | 0.8 | 0.8 | | | | | |
| Molecular weight | 2.5 | 3.1 | 1.9 | 2.5 | 2.4 | 2.4 | 2.5 | 4.1 | 3.1 | 2.9 | 1.9 | 2.6 |
| (×10,000) | | | | | | | | | | | | |

TABLE 4

| | | | | | | | | | | | | |
|---|---|---|---|---|---|---|---|---|---|---|---|---|
| Fluorine-containing | | | | | | | | | | | | |
| polymer | P37 | P38 | P39 | P40 | P41 | P42 | P43 | P44 | P45 | P46 | P47 | P48 |

Fluorine-containing polymer constitutional component (molar fraction (%))

| | | | | | | | | | | | | |
|---|---|---|---|---|---|---|---|---|---|---|---|---|
| Hexafluoro- | 40 | 50 | 50 | 45 | 50 | 50 | 50 | 50 | 50 | 50 | 50 | 45 |
| propylene | | | | | | | | | | | | |
| M1-(2) | | | | | | | | 5 | | | | |
| M1-(6) | | | | | | 10 | | | | | | |
| M2-3 | 10 | | | 5 | | | | | | | | 5 |
| HEVE | | | | | | | | | 30 | 30 | 30 | 30 |
| HBVE | 50 | | | | | | | | | | | |
| HOVE | | 40 | 25 | 50 | | | | | | | | |
| DEGVE | | | | | 40 | 40 | | | | | | |
| HMcHVE | | | | | | | 15 | 40 | | | | |
| EVE | | | 25 | | 10 | | 35 | | 20 | 20 | 20 | 20 |
| cHVE | | 10 | | | | | | | | | | |
| tBuVE | | | | | | | | | | | | |
| VAc | | | | | | | | 5 | | | | |

Silicone-containing constitutional component (% by weight)

| | | | | | | | | | | | | |
|---|---|---|---|---|---|---|---|---|---|---|---|---|
| VPS-0501 | | | | | | | | | | | | |
| VPS-1001 | | | | | | | | | | | | |
| S-(1) | | | | 2.9 | | | | | | | | |
| S-(2) | | | | | | 1.3 | | | | | | |
| S-(11) | | | | | | | | | | | | |
| S-(13) | | 1.9 | | | | | | | | | | |
| S-(30) | | | | | | | | | | | | |
| S-(36) | | | 3.2 | | | | | | | | | |
| S-(37) | 3.1 | | | | | | 3.1 | | | 3.8 | | |
| S-(38) | | | | | 1.9 | | | 3.4 | | | 3.8 | |
| Other Component | | | | | | | | | | | | |
| NE-30 | | | | | | | | | | | | |
| Molecular weight | 4.2 | 2.3 | 3.1 | 3.4 | 2.4 | 2.7 | 2.4 | 3.1 | 2.4 | 2.6 | 2.6 | 2.8 |
| (×10,000) | | | | | | | | | | | | |

TABLE 5

| | | | | | | | | |
|---|---|---|---|---|---|---|---|---|
| Fluorine- | | | | | | | | |
| containing | | | | | | | | |
| polymer | P49 | P50 | P51 | P52 | P53 | P54 | P55 | P56 |

Fluorine-containing polymer constitutional component (molar
fraction (%))

| | | | | | | | | |
|---|---|---|---|---|---|---|---|---|
| Hexafluoro- | 45 | 45 | 50 | 45 | 50 | 45 | 45 | 45 |
| propylene | | | | | | | | |
| M1-(2) | | | | | | | | |
| M1-(6) | | | | | | | | |
| M2-3 | 5 | 5 | | | | 5 | 5 | 5 |
| HEVE | 30 | 30 | 25 | 25 | 25 | 25 | 25 | 25 |
| HBVE | | | | | | | | |
| HOVE | | | | | | | | |
| DEGVE | | | | | | | | |
| HMcHVE | | | | | | | | |
| EVE | 20 | 20 | 25 | 25 | 25 | 25 | 25 | 25 |
| cHVE | | | | | | | | |
| tBuVE | | | | | | | | |
| VAc | | | | | | | | |

Silicone-containing constitutional component (% by weight)

| | | | | | | | | |
|---|---|---|---|---|---|---|---|---|
| VPS-0501 | | | | | | | | |
| VPS-1001 | | | | | | | | |
| S-(1) | | | | | | | | |
| S-(2) | | | | | | | | |
| S-(11) | | | | | | | | |
| S-(13) | | | | | | | | |
| S-(30) | | | | | | | | |
| S-(36) | | | | | | | | |
| S-(37) | 3.8 | | | 3.8 | | | 3.8 | |
| S-(38) | | 3.8 | | | 3.8 | | | 3.8 |
| Other | | | | | | | | |
| Component | | | | | | | | |
| NE-30 | | | | | | | | |
| Molecular | 2.9 | 2.9 | 2.6 | 2.6 | 2.7 | 2.6 | 2.7 | 2.7 |
| weight | | | | | | | | |
| (×10,000) | | | | | | | | |

With respect to the fluorine-containing polymer constitutional components in the tables, a molar ratio of the respective components was shown. The abbreviations are as follows.

HEVE: 2-Hydroxyethyl vinyl ether

HBVE: 4-Hydroxybutyl vinyl ether

HOVE: 8-Hydroxyoctyl vinyl ether

DEGVE: Diethylene glycol vinyl ether

HMcHVE: 4-(Hydroxymethyl)cyclohexylmethyl vinyl ether

EVE: Ethyl vinyl ether

cHVE: Cyclohexyl vinyl ether

tBuVE: t-Butyl vinyl ether

VAc: Vinyl acetate

VPS-0501: Azo group-containing polydimethylsiloxane represented by the following formula wherein z is from 7 to 9 and having a number average molecular weight of from 30,000 to 40,000 and having a molecular weight of a polysiloxane segment thereof of about 5,000 (manufactured by Wako Pure Chemical Industries, Ltd.)

VPS-1001: Azo group-containing polydimethylsiloxane represented by the following formula wherein z is from 7 to 9 and having a number average molecular weight of from 70,000 to 90,000 and having a molecular weight of a polysiloxane segment thereof of about 10,000 (manufactured by Wako Pure Chemical Industries, Ltd.)

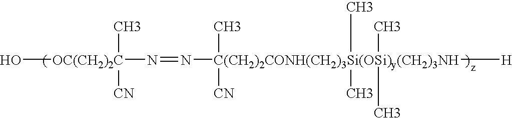

NE-30: Nonionic reactive emulsifier represented by the following formula wherein n is 9, m is 1, and u is 30 (manufactured by Asahi Denka Co., Ltd.)

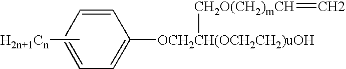

The synthesis of the foregoing fluorine-containing polymer which is used in the invention can be carried out by various polymerization methods, for example, solution polymerization, precipitation polymerization, suspension polymerization, precipitation polymerization, block polymerization, and emulsion polymerization. Furthermore, the synthesis can be carried out by a known operation such as a batchwise operation, a semi-continuous operation, and a continuous operation.

Examples of a method for initiating the polymerization include a method of using a radical initiator and a method of irradiating light or radiations. These polymerization methods and method for initiating the polymerization are described in, for example, Teiji Tsuruta, Kobunshi Gosei Hoho (Polymer Synthesis Methods, Revised Edition (published by Nikkan Kogyo Shimbun Ltd., 1971); and Takayuki Otsu and Masayoshi Kinoshita, Kobunshi Gosei no Jikkenho (Exerimental Methods of Polymer Synthesis), published by Kagaku-dojin Publishing Company, Inc., pages 124 to 125 (1972).

Among the foregoing polymerization methods, a solution polymerization method using a radical initiator is especially preferable. Examples of a solvent which is used in the solution polymerization method include various solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. Such an organic solvent may be used singly or in admixture of two or more kinds thereof, or may be used as a mixed solvent with water.

The polymerization temperature must be set up in relation to the molecular weight of a formed polymer, the kind of an initiator, and so on. Though the polymerization can be carried out at not higher than 0° C. or 100° C. or higher, it is preferred to carry out the polymerization at a temperature in the range of from 40 to 100° C.

Though the reaction pressure can be properly selected, it is desired that the reaction pressure is usually from about 0.01 to 10 MPa, preferably from about 0.05 to 5 MPa, and more preferably from about 0.1 to 2 MPa. The reaction time is from about 5 to 30 hours.

With respect to the obtained polymer, the reaction solution can be used for the application of the invention as it stands, or it can be used after purification by a reprecipitation or liquid separation operation.

The blending amount of the fluorine-containing polymer is preferably from 20 to 99.5% by weight, more preferably from 30 to 90% by weight, and most preferably from 40 to 80% by weight based on the whole of solids of the low refractive index layer.

<Fine Particle Having a Conductive Metal Oxide-Coated Layer [Constitutional Component (B) of Low Refractive Index Layer of the Invention]>

The fine particle which can be used as the constitutional component (B) of a low refractive index layer in the invention will be hereunder described. The low refractive index layer of the invention contains a fine particle having a conductive metal oxide-coated layer. In the invention, there are enumerated a core/shell type composite fine particle.in which a fine particle is used as a nucleus and a shell layer made of a conductive substance is provided on the outside thereof; and an internal void type hollow fine particle as prepared in a manner that by using a fine particle which is soluble in acids, alkalis or organic solvents as a nucleus, a shell layer made of a conductive substance is provided on the outside thereof to form a composite fine particle, followed by removing the nucleus particle by a treatment with an acid, an alkali or an organic solvent to form voids in the inside thereof In the particles of all of these embodiments, the conductive metal oxide is not particularly limited. Examples thereof include tin oxide (SnO₂), antimony tin oxide (ATO), indium tin oxide (ITO), antimony oxide (Sb₂O₅), aluminum zinc oxide (AZO), gallium zinc oxide, and mixtures thereof.

Examples of a core particle of the core/shell type composite particle include inorganic fine particles such as a silica fine particle (for example, a colloidal silica fine particle and a silicon oxide fine particle); polymer fine particles such as a fluorine resin fine particle, an acrylic resin particle, and a silicone resin particle; and fine particles such as an organic/inorganic composition particle. So far as the foregoing fine particle is a porous or hollow fine particle, it is able to lower the refractive index.

In the case of an internal void type hollow fine particle, a nucleus particle which is used in the manufacturing process is not limited with respect to the kind thereof so far as it can be dissolved or washed away through the shell layer by a treatment with an acid, an alkali or an organic solvent. Suitable examples of the nucleus particle include fine particles of a metal oxide of a metal selected from elements belonging to the groups 2A, 2B, 3A and 5B of the periodic table. Above all, ZnO, Y₂O₃ and Sb₂O₅ fine particles are preferable. Furthermore, in the case of an internal void type hollow fine particle, with respect to a combination of the nucleus particle and the shell substance, a method in which a surface of a fine particle of ZnO, Y₂O₃, Sb₂O₅, etc. is coated by a superfine particle of ATO, ITO, SnO₂, etc. or a thin film thereof and the internal fine particle is then eluted by an acid or alkali aqueous solution, thereby forming a hollow conductive inorganic fine particle can be employed.

Among the conductive metal oxide-coated particles of the invention, an antimony oxide-coated silica fine particle is especially preferable.

With respect to the antimony oxide-coated silica based fine particle, it is more preferable that a porous silica based fine particle or a silica based fine particle having voids in the inside thereof is coated with an antimony oxide coating layer. The foregoing porous silica based fine particle includes a composite oxide fine particle containing a porous silica fine particle and silica as the major components, and a low refractive index composite oxide fine particle in a nanometer size resulting from coating the surface of a porous inorganic oxide fine particle with silica or the like as described in JP-A-7-133105 can be used.

Furthermore, as the silica based fine particle having voids in the inside thereof, a low refractive index silica based fine particle in a nanometer size which is made of silica and an inorganic oxide other than silica and which has voids in the inside thereof as described in JP-A-2001-233611 can be used.

Such a porous silica based fine particle or silica based fine particle having voids in the inside thereof preferably has an average particle size in the range of from 4 to 270 nm, and preferably from 8 to 170 nm.

The foregoing porous silica based fine particle or silica based fine particle having voids in the inside thereof preferably has a refractive index in terms of silica of not more than 1.45, and more preferably not more than 1.40.

It is preferable that the foregoing silica based fine particle is coated by antimony oxide in an average thickness in the range of from 0.5 to 30 nm, and more preferably from 1 to 10 nm. In the case where the average thickness of the coating layer is from 0.5 to 30 nm, the silica based fine particle can be completely coated so that it is possible to make sufficient conductivity and minimization of a change in the refractive index compatible with each other.

The antimony oxide-coated silica based fine particle according to the invention preferably has an average particle size in the range of from 5 to 300 nm, and more preferably from 10 to 200 nm.

The antimony oxide-coated silica based fine particle preferably has a refractive index in the range of from 1.35 to 1.60, and more preferably from 1.35 to 1.50.

The antimony oxide-coated silica based fine particle preferably has a volume resistivity value in the range of from 10 to 5,000 Ω·cm, and more preferably from 10 to 2,000 Ω·cm. The antimony oxide-coated silica based fine particle of the invention can be used after subjecting to a surface treatment with a silane coupling agent in the usual way as the need arises.

The blending amount of the antimony oxide-coated silica based fine particle is preferably from 0.5 to 80% by weight, more preferably from 5 to 60% by weight, and most preferably from 10 to 50% by weight based on the whole of solids of the low refractive index layer.

As a synthesis method of the foregoing antimony oxide-coated silica fine particle, for example, a method as described in JP-A-2005-119909 can be employed.

<Crosslinking Compound [Constitutional Component (C) of Low Refractive Index Layer of the Invention]>

[Hardening Agent]

In the invention, it is preferable that the low refractive index layer is formed by using a hardenable composition containing a hydroxyl group-containing fluorine-containing polymer and a compound (hardening agent) capable of reacting with the hydroxyl group in the fluorine-containing polymer, namely a so-called hardenable resin composition. The hardening agent preferably contains two or more, and more preferably four or more sites capable of reacting with a hydroxyl group.

The structure of the hardening agent is not particularly limited so far as it contains the foregoing number of functional groups capable of reacting with a hydroxyl group. Examples thereof include polyisocyanates, partial condensates or polymers of an isocyanate compound, adducts with a polyhydric alcohol, a low molecular weight polyester film, etc., block polyisocyanate compounds having an isocyanate group blocked by a blocking agent such as phenol, aminoplasts, and polybasic acids or anhydrides thereof.

Above all, in the invention, aminoplasts capable of causing a crosslinking reaction with a hydroxyl group-containing under an acidic condition are preferable from the viewpoint of making stability at the time of storage and activity of the crosslinking reaction compatible with each other and the viewpoint of strength of the formed film. The aminoplasts are a compound containing an amino group capable of reacting with a hydroxyl group in a fluorine-containing polymer, namely, a hydroxyalkylamino group or an alkoxyalkylamino group, or a carbon atom adjacent to a nitrogen atom and substituted with an alkoxy group. Specific examples thereof include melamine based compounds, urea based compounds, and benzoguanamine based compounds.

The foregoing melamine based compounds are generally known as a compound having a skeleton in which a nitrogen atom is bound to a triazine ring, and specific examples thereof include melamine, alkylated melamines, methylolmelamine, and alkoxylated methylmelamines. Above all, methylolated melamine obtained by making melamine react with formaldehyde under a basic condition, alkoxylated methylmelamines, and derivatives thereof are preferable; and alkoxylated methylmelamines are especially preferable in view of storage stability. Furthermore, with respect to the methylolated melamine and alkoxylated methylmelamines, there are no particular limitations, and for example, a variety of resins obtainable by a method as described in Plastic Material Course [8]: Urea-melamine Resins (published by Nikkan Kogyo Shimbun Ltd.) can be used.

Furthermore, as the foregoing urea compounds, in addition to urea, polymethylolated ureas and alkoxylated methylureas as a derivative thereof, and compounds having a glycol uryl skeleton or 2-imidazolidinone skeleton as a cyclic urea structure are preferable. With respect to the amino compounds such as the foregoing urea derivatives, a variety of resins as described in the foregoing Urea-melamine Resins reference, etc. can also be used.

In the invention, as a compound which is suitably used as the crosslinking agent, melamine compounds or glycol uryl compounds are especially preferable in view of compatibility with the fluorine-containing polymer. Above all, it is preferable that the crosslinking agent is a compound containing a nitrogen atom in the molecule thereof and containing two or more carbon atoms adjacent to the nitrogen atom and substituted with an alkoxy group. Examples of especially preferred compounds include compounds having a structure represented by the following H-1 or H-2 and partial condensates thereof. In the following formulae, R represents an alkyl group having from 1 to 6 carbon atoms or a hydroxyl group.

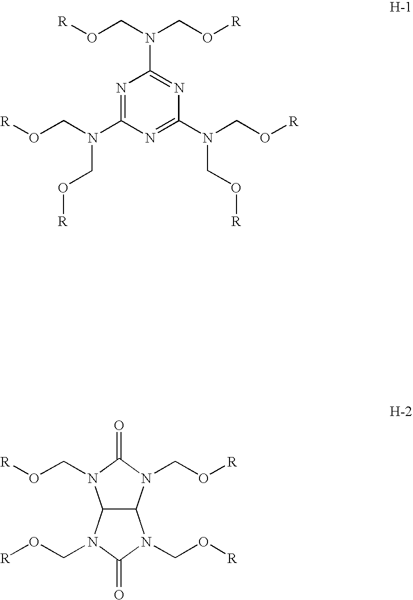

The amount of addition of the aminoplast to the fluorine-containing polymer is from 1 to 50 parts by weight, preferably from 3 to 40 parts by weight, and more preferably from 5 to 30 parts by weight based on 100 parts by weight of the polymer. When the amount of addition of the aminoplast is 1 part by weight or more, it is possible to sufficiently exhibit durability as a thin film which is a characteristic feature of the invention. When it is not more than 50 parts by weight, in utilizing for optical applications, it is possible to keep a low refractive index which is a characteristic feature of the low refractive index layer in the invention, and therefore, such is preferable. From the viewpoint of keeping a low refractive index even by adding the hardening agent, a hardening agent which even when added, is small with respect to an increase of the refractive index is preferable. According to this viewpoint, among the foregoing compounds, those having a skeleton represented by H-2 are more preferable. In the invention, a compound resulting from reaction of the constitutional components (A) and (C) of low refractive index layer in advance can also be used in the low refractive index layer. When the both are made to react with each other in advance, the cissing at the time of coating or the compatibility among the respective constitutional components can be increased, and therefore, such is preferable.

<Organosilane Compound [Constitutional Component (D) of Low Refractive Index Layer of the Invention]>

It is preferable from the standpoint of scar resistance that an organosilane compound or a hydrolyzate of the organosilane compound and/or a partial condensate thereof (the resulting reaction solution will be hereinafter sometimes referred to as “sol component”) is contained in the low refractive index layer of the invention.

Such a compound functions as a binder such that after coating, the foregoing hardenable composition is condensed in drying and heating steps to form a hardened material. Furthermore, in the case where a polyfunctional acrylate polymer is contained, a binder having a three-dimensional structure is formed upon irradiation with active rays.

The foregoing organosilane compound is preferably one represented by the following formula [A].
(R¹⁰)ₘ—Si(X)₄₋ₘ Formula [A]

In the foregoing formula [A], R¹⁰ represents a substituted or unsubstituted alkyl group or a substituted or unsubstituted aryl group. Examples of the alkyl group include methyl, ethyl, propyl, isopropyl, hexyl, decyl, and hexadecyl. The alkyl group preferably has from 1 to 30 carbon atoms, more preferably from 1 to 16 carbon atoms, and especially preferably from 1 to 6 carbon atoms. Examples of the aryl group include phenyl and naphthyl. Of these, a phenyl group is preferable.

X represents a hydroxyl group or a hydrolyzable group. Examples of the hydrolyzable group include an alkoxy group (preferably an alkoxy group having from 1 to 5 carbon atoms, for example, a methoxy group and an ethoxy group), a halogen atom (for example, Cl, Br, and I), and R²COO (wherein R² is preferably a hydrogen atom or an alkyl group having from 1 to 5 carbon atoms; and examples thereof include CH₃COO and C₂H₅COO). Of these, an alkoxy group is preferable; and a methoxy group and an ethoxy group are especially preferable.

m represents an integer of from 1 to 3, preferably 1 or 2, and especially preferably 1.

When plural R¹⁰s or Xs are present, the plural R¹⁰s or Xs may be the same or different.

The substituent which is contained in R¹⁰ is not particularly limited, and examples thereof include a halogen atom (for example, fluorine, chlorine, and bromine), a hydroxyl group, a mercapto group, a carboxyl group, an epoxy group, an alkyl group (for example, methyl, ethyl, isopropyl, propyl, and t-butyl), an aryl group (for example, phenyl and naphthyl), an aromatic heterocyclic group (for example, furyl, pyrazolyl, and pyridyl), an alkoxy group (for example, methoxy, ethoxy, isopropoxy, and hexyloxy), an aryloxy group (for example, phenylthio), an alkylthio group (for example, methylthio and ethylthio), an arylthio group (for example, phenylthio), an alkenyl group (for example, vinyl and 1-propenyl), an acyloxy group (for example, acetoxy, acryloyloxy, and methacryloyloxy), an alkoxycarbonyl group (for example, methoxycarbonyl and ethoxycarbonyl), an aryloxycarbonyl group (for example, phenoxycarbonyl), a carbamoyl group (for example, carbamoyl, N-methylcarbamoyl, N,N-dimethylcarbamoyl, and N-methyl-N-octylcarbamoyl), and an acylamino group (for example, acetylamino, benzoylamino, acrylamino, and methacrylamino). Such a substituent may be further substituted.

In the case where plural R¹⁰s are present, it is preferable that at least one of them is a substituted alkyl group or a substituted aryl group.

Among the organosilane compounds represented by the foregoing formula [A], a vinyl polymerizable substituent-containing organosilane compound represented by the following formula [B] is preferable.

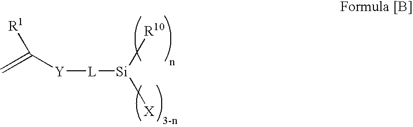

In the foregoing formula [B], R¹ represents a hydrogen atom, a methyl group, a methoxy group, an alkoxycarbonyl group, a cyano group, a fluorine atom, or a chlorine atom. Examples of the alkoxycarbonyl group include a methoxycarbonyl group and an ethoxycarbonyl group. Above all, a hydrogen atom, a methyl group, a methoxy group, a methoxycarbonyl group, a cyano group, a fluorine atom, and a chlorine atom are preferable; a hydrogen atom, a methyl group, a methoxycarbonyl group, a fluorine atom, and a chlorine atom are more preferable; and a hydrogen atom and a methyl group are especially preferable.

Y represents a single bond, *—COO—**, *—CONH—**, or *—O—**. Of these, a single bond, *—COO—**, and *—CONH—** are preferable; a single bond and *—COO—** are more preferable; and *—COO—** is especially preferable. Here, * represents the binding position to ═C(R¹); and ** represents the binding position to L.

L represents a divalent connecting chain. Specific examples thereof include a substituted or unsubstituted alkylene group, a substituted or unsubstituted arylene group, a substituted or unsubstituted alkylene group containing a connecting group (for example, ethers, esters, and amides) therein, and a substituted or unsubstituted arylene group containing a connecting group therein. Of these, a substituted or unsubstituted alkylene group, a substituted or unsubstituted arylene group, and an alkylene group containing a connecting group therein are preferable; an unsubstituted alkylene group, an unsubstituted arylene group, and an alkylene group containing an ether or ester connecting group therein are more preferable; and an unsubstituted alkylene group and an alkylene group containing an ether or ester connecting group therein are especially preferable. Examples of the substituent include a halogen, a hydroxyl group, a mercapto group, a carboxyl group, an epoxy group, an alkyl group, and an aryl group. Such a substituent may be further substituted.

n represents 0 or 1. When plural Xs are present, the plural Xs may be the same or different. n is preferably 0.

R¹⁰ is synonymous with R¹⁰ in the formula [A] and is preferably a substituted or unsubstituted alkyl group or an unsubstituted aryl group, and more preferably an unsubstituted alkyl group or an unsubstituted aryl group.

X is synonymous with X in the formula [A]. Above all, a halogen atom, a hydroxyl group, and an unsubstituted alkoxy group are preferable; a chlorine atom, a hydroxyl group, and an alkoxy group having from 1 to 6 carbon atoms are more preferable; a hydroxyl group and an alkoxy group having from 1 to 3 carbon atoms are further preferable; and a methoxy group is especially preferable.

The compound of the formula [A] or formula [B] may be used in combination of two or more kinds thereof. Specific examples of the compound represented by the formula [A] or formula [B] will be given below, but it should not be construed that the invention is limited thereto.

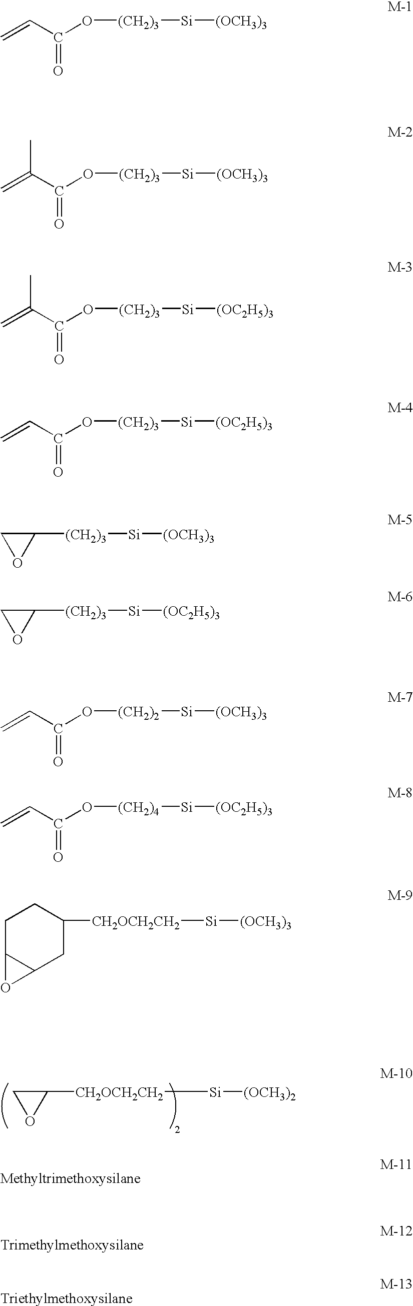

Above all, it is preferred to use M-1, M-2, M-5, M-11 or M-12.

When two kinds of the compounds are used together, it is preferred to use a combination of M-1 or M-2 as a compound containing a polymerizable group with M-11 or M-12 as a compound not containing a polymerizable group. It is also preferred to use an oligomer resulting from hydrolyzing the foregoing combination of a compound containing a polymerizable group with a compound not containing a polymerizable group and then condensing the hydrolyzate.

Of these compounds, M-1, M-2 and M-5 are especially preferable.

Then, in general, a hydrolyzate of the foregoing organosilane compound and/or a partial condensate thereof is produced by treating the foregoing organosilane compound in the presence of a catalyst. Examples of the catalyst include inorganic acids such as hydrochloric acid, sulfuric acid, and nitric acid; organic acids such as oxalic acid, acetic acid, formic acid, methanesulfonic acid, and toluenesulfonic acid; inorganic bases such as sodium hydroxide, potassium hydroxide, and ammonia; organic bases such as triethylamine and pyridine; metal alkoxides such as triisopropoxyaluminum and tetrabutoxyzirconium; and metal chelate compounds containing a metal (for example, Zr, Ti, and Al) as a central metal. In the invention, it is preferred to use a metal chelate compound or an acid catalyst such as inorganic acids and organic acids. Hydrochloric acid and sulfuric acid are preferable as the inorganic acid; and ones having an acid dissociation constant (pKa value (at 25° C.)) in water of not more than 4.5 are preferable as the organic acid. Hydrochloric acid, sulfuric acid, and an organic acid having an acid dissociation constant in water of not more than 3.0 are more preferable; hydrochloric acid, sulfuric acid, and an organic acid having an acid dissociation constant in water of not more than 2.5 are further preferable; and an organic acid having an acid dissociation constant in water of not more than 2.5 is especially preferable. Concretely, methanesulfonic acid, oxalic acid, phthalic acid, and malonic acid are preferable, with oxalic acid being especially preferable.

As the metal chelate compound, ones containing, as a central metal, a metal selected from Zr, Ti and Al, in which an alcohol represented by the formula, R³OH (wherein R³ represents an alkyl group having from 1 to 10 carbon atoms) and a compound represented by the formula, R⁴COCH₂COR⁵ (wherein R⁴ represents an alkyl group having from 1 to 10 carbon atoms; and R⁵ represents an alkyl group having from 1 to 10 carbon atoms or an alkoxy group having from 1 to 10 carbon atoms) function as ligands, can be suitably used without particular limitations. Two or more kinds of metal chelate compounds may be used together within this scope. The metal chelate compound which is used in the invention is preferably selected from the group of compounds represented by the formulae, Zr(OR³)ₚ₁(R⁴COCHCOR⁵)ₚ₂, Ti(OR³)_{q1}(R⁴COCHCOR⁵)_{q2} and Al(OR³)ᵣ₁(R⁴CO—CHCOR⁵)ᵣ₂ and acts to accelerate a condensation reaction of a hydrolyzate of the foregoing organosilane compound and/or a partial condensate thereof.

In the foregoing metal chelate compounds, R³ and R⁴ may be the same or different and each represents an alkyl group having from 1 to 10 carbon atoms. Specific examples of the alkyl group include an ethyl group, an n-propyl group, an isopropyl group, an n-butyl group, a sec-butyl group, a t-butyl group, an n-pentyl group, and a phenyl group. Furthermore, R⁵ represents an alkyl group having from 1 to 10 carbon atoms the same as in the foregoing or an alkoxy group having from 1 to 10 carbon atoms. Examples of the alkoxy group include a methoxy group, an ethoxy group, an n-propoxy group, an isopropoxy group, an n-butoxy group, a sec-butoxy group, and a t-butoxy group. Moreover, in the foregoing metal chelate compounds, p1, p2, q1, q2, r1 and r2 each represents an integer which is determined such that the relations: (p1+p2)=4, (q1+q2)=4 and (r1+r2)=3 are satisfied,

Specific examples of such a metal chelate compound include zirconium chelate compounds such as zirconium tri-n-butoxyethylacetoacetate, zirconium di-n-butoxybis(ethylacetoacetate), zirconium n-butoxytris(ethylacetoacetate), zirconium tetrakis(n-propylaetoacetate), zirconnium tetrakis(acetylacetoacetate), and zirconium tetrakis(ethylacetoacetate); titanium chelate compounds such as titanium diisopropoxybis(ethylacetoacetate), titanium diisopropoxy bis(acetylacetate), and titanium diisopropoxy bis(acetylcetone); and aluminum chelate compounds such as aluminum diisopropoxyethylacetoacetate, aluminum diisopropoxyacetylacetate, aluminum isopropoxybis(ethylacetoacetate), aluminum isopropoxybis(acetylacetonate), aluminum tris(ethylacetoacetate), aluminum tris(acetylacetonate), and aluminum monoacetylacetonato bis(ethylacetoacetate).

Of these metal chelate compounds, zirconium tri-n-butoxyethylacetoacetate, titanium diisopropoxybis(acetylacetonate), aluminum diisopropoxyethylacetoacetate, and aluminum tris(ethylacetoacetate) are preferable. Such a metal chelate compound can be used singly or in admixture of two or more kinds thereof. A partial hydrolyzate of such a metal chelate compound can also be used.

Furthermore, in the invention, it is preferable that a β-diketone compound and/or a β-ketoester compound is further added in the foregoing hardenable composition. This will be further described below.

The compound which is used in the invention is a β-diketone compound and/or a β-ketoester compound represented by the formula, R⁴COCH₂COR⁵ and acts as a stability improving agent of the hardenable composition which is used in the invention. Here, R⁴ represents an alkyl group having from 1 to 10 carbon atoms; and R⁵ represents an alkyl group having from 1 to 10 carbon atoms or an alkoxy group having from 1 to 10 carbon atoms. That is, it is thought that when this compound coordinates with the metal atom in the metal chelate compound (for example, zirconium, titanium and/or aluminum compounds), it inhibits an action of acceleration of a condensation reaction of a hydrolyzate of the organosilane compound and/or a partial condensate thereof by such a metal chelate compound, thereby acting to improve the storage stability of the resulting composition. R⁴ and R⁵ which constitute the β-diketone compound and/or β-ketoester compound are synonymous with R⁴ and R⁵ which constitute the foregoing metal chelate compound.

Specific examples of this β-diketone compound and/or β-ketoester compound include acetylacetone, methyl acetoacetate, ethyl acetoacetate, n-propyl acetoacetate, isopropyl acetoacetate, n-butyl acetoacetate, sec-butyl acetoacetate, t-butyl acetoacetate, 2,3-hexane-dione, 2,4-heptane-dione, 3,5-heptane-dione, 2,4-octane-dione, 2,4-nonane-dione, and t-methylhexane-dione. Of these, ethyl acetoacetate and acetylacetone are preferable; and acetylacetone is especially preferable. Such a β-diketone compound and/or β-ketoester compound can be used singly or in admixture of two or more kinds thereof. In the invention, the β-diketone compound and/or β-ketoester compound is preferably used in an amount of 2 moles or more, and more preferably from 3 to 20 moles per mole of the metal chelate compound. When the amount of the β-diketone compound and/or β-ketoester compound is less than 2 moles, the storage stability of the resulting composition may possibly be deteriorated, and therefore, such is not preferable.

The blending amount of the foregoing organosilane compound or its hydrolyzate and/or its partial condensate is preferably from 0.1 to 50% by weight, more preferably from 0.5 to 30% by weight, and most preferably from 1 to 20% by weight of the whole of solids of the low refractive index layer.

Though the foregoing organosilane compound may be added directly in the coating composition, it is preferable that the foregoing organosilane compound is previously treated in the presence of a catalyst to prepare a hydrolyzate of the foregoing organosilane compound and/or a partial condensate thereof and the foregoing coating composition is prepared by using the resulting reaction solution (sol solution). In the invention, it is preferable that a composition containing a hydrolyzate of the foregoing organosilane compound and/or a partial condensate and a metal chelate compound is first prepared and a solution resulting from adding a β-dietone compound and/or a β-ketoestr compound in this composition is then contained in the coating composition, followed by coating.

<Compound Containing Two or More (meth)acryloyl Groups in One Molecule hereof [Constitutional Component (E) of Low Refractive Index Layer of the Invention]>

The following compounds each containing two or more (meth)acryloyl groups in one molecule thereof can be used as the constitutional component (E) of the low refractive index layer of the invention.

Specific examples of the photopolymerizable polyfunctional monomer containing a photopolymerizable functional group which can be used include:

(meth)acrylic diesters of an alkylene glycol such as neopentyl glycol acrylate, 1,6-hexanediol (meth)acrylate, and propylene glycol di(meth)acrylate;

(meth)acrylic diesters of a polyoxyalkylene glycol such as triethylene glycol di(meth)acrylate, dipropylene glycol di(meth)arylate, polyethylene glycol di(meth)acrylate, and polypropylene glycol di(meth)acrylate;

(meth)acrylic diesters of a polyhydric alcohol such as pentaerythritol di(meth)acrylate; and

(meth)acrylic diesters of an ethylene oxide or propylene oxide adduct such as 2,2-bis{4-(acryloxy diethoxy)phenyl}propane and 2,2-bis {4-(acryloxy polypropoxy)phenyl}propane.

In addition, epoxy (meth)acrylates, urethane (meth)acrylates, and polyester (meth)acrylates are also preferably used as the photopolymerizable polyfunctional monomer.

Above all, esters of a polyhydric alcohol and (meth)acrylic acid are preferable; and polyfunctional monomers containing three or more (meth)acryloyl groups in one molecule thereof are more preferable. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaertythritol triacrylate, (di)pentaerythritol pentaacrylate, (di)pentaerythritol tera(meth)acrylate, (di)pentaerythritol hexa(meth)acrylate, tripentaerythritol triacrylate, and tripentaerythritol hexatriacrylate. In this specification, the terms “(meth)acrylate”, “(meth)acrylic acid” and “(meth)acryloyl” mean “acrylate or methacrylate”, “acrylic acid or methacrylic acid” and “acryloyl or methacryloyl”, respectively.

For the purpose of controlling the refractive index of each of the layers, monomers having a different refractive index can be used as the monomer binder. In particular, examples of a high refractive index monomer include bis(4-methacryloylthiophenyl) sulfide, vinylnaphthalene, vinylphenyl sulfide, and 4-methacryloxyphenyl-4′-methoxyphenyl thioether.

Dendrimers as described in, for example, JP-A-2005-76005 and JP-A-2005-36105 and norbornene ring-containing monomers as described in, for example, JP-2005-60425 can also be used.

<Compound Having a Polysiloxane Structure [Constitutional Component (F) of Low Refractive Index of the Invention]>

Next, a compound having a polysiloxane structure of the invention will be described.

In the invention, for the purposes of improving the scar resistance by imparting slipperiness and imparting antifouling properties, it is preferred to use a compound having a polysiloxane structure represented by the foregoing formula (1) and having a structure capable of reacting with a hydroxyl group to form a bond. Examples of the structure of the compound include a structure containing plural dimethylsilyloxy units as a repeating unit and containing a substituent in a terminal and/or a side chain of the chemical chain thereof. Furthermore, a structural unit other than dimethylsilyloxy may be contained in the chemical chain containing dimethylsilyloxy as a repeating unit.

Though the molecular weight of the compound having a polysiloxane structure is not particularly limited, it is preferably not more than 100,000, especially preferably not more than 50,000, and most preferably from 3,000 to 30,000.

From the viewpoint of preventing transfer from occurring, it is preferable that a hydroxyl group or a function group capable of reacting with a hydroxyl group to form binding is contained. It is preferable that this binding forming reaction rapidly proceeds under a heating condition and/or in the presence of a catalyst. Examples of such a substituent include an epoxy group and a carboxyl group. Preferred examples of the compound will be given below, but it should not be construed that the invention is limited thereto.

(Compound Containing a Hydroxyl Group)

X-22-160AS, KF-6001, KF-6002, KF-6003, X-22-170DX, X-22-176DX, X-22-176D, and X-22-176F (all of which are manufactured by Shin-Etsu Chemical Co., Ltd.); FM-4411, FM-4421, FM-4425, FM-0411, FM-0421, FM-0425, FM-DA11, FM-DA21, and FM-DA25 (all of which are manufactured by Chisso Corporaiton); and CMS-626 and CMS-222 (all of which are manufactured by Gelest, Inc.)

(Compound Containing a Functional Group Capable of Reacting with a Hydroxyl Group)

X-22-162C and KF-105 (all of which are manufactured by Shin-Etsu Chemical Co., Ltd.); and FM-5511, FM-5521, FM-5525, FM-6611, FM-6621, and FM-6625 (all of which are manufactured by Chisso Corporation)

The blending amount of the foregoing compound having a polysiloxane structure is preferably from 0 to 30% by weight, more preferably from 0.5 to 20% by weight, and most preferably from 1 to 10% by weight based on the whole of solids of the low refractive index layer.

In addition to the foregoing polysiloxane based compound, other polysiloxane based compound can be further used together. Preferred examples thereof include compounds containing plural dimethylsilyloxy units as a repeating unit and containing a substituent in a terminal and/or a side chain of the chemical chain thereof. Furthermore, a structural unit other than dimethylsilyloxy may be contained in the chemical chain containing dimethylsilyloxy as a repeating unit. The substituent may be the same or different, and it is preferable that plural substituents are contained. Preferred examples of the substituent include groups containing, for example, an acryloyl group, a methacryloyl group, a vinyl group, an aryl group, a cinnamoyl group, an oxetanyl group, a fluoroalkyl group, a polyoxyalkylene group, a carboxyl group, or an amino group. Though the molecular weight of this polysiloxane based compound is not particularly limited, it is preferably not more than 100,000, more preferably not more than 50,000, especially preferably from 3,000 to 30,000, and most preferably from 10,000 to 20,000. Though the silicon atom content of the silicone based compound is not particularly limited, it is preferably 18.0% by weight or more, especially preferably from 25.0 to 37.0% by weight, and most preferably from 30.0 to 37.0% by weight. Preferred examples of the silicone based compound include X-22-174DX, X-22-2426, X-22-164B, X-22-164C, and X-22-1821 (all of which are a trade name of Shin-Etsu Chemical Co., Ltd.); FM-0725, FM-7725, FM-6621, and FM-1121 (all of which are a trade name of Chisso Corporation); and DMS-U22, RMS-033, RMS-083, UMS-182, DMS-H21, DMS-H31, HMS-301, FMS121, FMS123, FMS131, FMS141, and FMS221 (all of which are a trade name of Gelest, Inc.).

<Fluorine-Containing Antifouling Agent Containing a Hydroxyl Group or a Functional Group Capable of Reacting with a Hydroxyl Group [Constitutional Component (G) of Low Refractive Index Layer of the Invention]>

In the low refractive index layer of the invention, for the purpose of imparting characteristics such as antifouling properties, water-proof properties, chemical resistance, and slipperiness, it is preferred to properly add a fluorine based antifouling agent or slipping agent or the like. From the viewpoints of inhibiting the transfer of a fluorine compound onto the back surface at the time of preservation of a coated material in a rolled state and improving the scar resistance of the coating film, it is preferred to use a fluorine-containing antifouling agent containing a hydroxyl group or a functional group capable of reacting with a hydroxyl group.

Examples of such a functional group include isocyanates, aminoplasts, and so on as described in the section of the hardening agent as well as an epoxy group and a carboxyl group. When two or more of such a functional group are contained in one molecule of the antifouling agent, the fixing properties to the low refractive index layer are high and the transfer onto the back surface in a rolled state is inhibited, and therefore, such is preferable.

Examples of a hydroxyl group-containing compound will be given below.
F(CF₂)ₙO(CF₂CF₂O)ₘCF₂CH₂OH Formula (G-1)

In the formula (G-1), m represents an integer of from 1 to 6; and n represents an integer of from 1 to 4.

Specific examples of a fluorine atom-containing alcohol compound represented by the foregoing formula (G-1) which can be used include 1H,1H-perfluoro-3,6-dioxaheptan-1-ol, 1H,1H-perfluoro-3,6-dioxaoctan-1-ol, 1H,1H-perfluoro-3,6-dioxadecan-1-ol, 1H,1H-perfluoro-3,6,9-trioxadecan-1-ol, 1H,1H-perfluoro-3,6,9-trioxaundecan-1-ol, 1H,1H-perfluoro-3,6,9-trioxatridecan-1-ol, 1H,1H-perfluoro-3,6,9,12-tetraoxatridecan-1-ol, 1H,1H-perfluoro-3,6,9,12-tetraoxatetradecan-1-ol, 1H,1H-perfluoro-3,6,9,12-tetraoxahexadecan-1-ol, 1H,1H-perfluoro-3,6,9,12,15-pentaoxahexadecan-1-ol, 1H,1H-perfluoro-3,6,9,12,15-pentaoxaheptadecan-1-ol, 1H,1H-perfluoro-3,6,9,12,15-pentaoxanonadecan-1-ol, 1H,1H-perfluoro-3,6,9,12,15,18-hexaoxaeicosan-1-ol, 1H,1H-perfluoro-3,6,9,12,15,18-hexaoxadocosan-1-ol, 1H,1H-perfluoro-3,6,9,12,15,18,21-heptaoxatricosan-1-ol, and 1H,1H-perfluoro-3,6,9,12,15,18,21-heptaoxapentacosan-1-ol. These compounds are commercially available; and specific examples thereof include 1H,1H-perfluoro-3,6-dioxaheptan-1-ol (a trade name: C5GOL, manufactured by Exfluor Research Corporation), 1H,1H-perfluoro-3,6,9-trioxadecan-1-ol (a trade name: C7GOL, manufactured by Exfluor Research Corporation), 1H,1H-perfluoro-3,6-dioxadecan-1-ol (a trade name: C8GOL, manufactured by Exfluor Research Corporation), 1H,1H-perfluoro-3,6,9-trioxatridecan-1-ol (a trade name: C10GOL, manufactured by Exfluor Research Corporation), and 1H,1H-perfluoro-3,6,9,12-tetraoxahexadecan-1-ol (a trade name: C12GOL, manufactured by Exfluor Research Corporation). In the invention, it is preferred to use 1H,1H-perfluoro-3,6,9-trioxatridecan-1-ol.

In the invention, as an embodiment of the preferred antifouling agent, there can be enumerated reaction products between a hydroxyl group-containing fluorine compound represented by the foregoing formula (G-1) and a compound containing plural functional groups capable of reacting with a hydroxyl group in the molecule thereof. Examples of the compound containing plural functional groups capable of reacting with a hydroxyl group in the molecule thereof include polyisocyanates, partial condensates or polymers of an isocyanate compound, and aminoplasts. Specific examples of these compounds are as follows.

Polyisocyanates

Commercially available products thereof include TAKENATE Series (for example, general type: D-101A, D-102, D-103, D-103H, D-103M2, and D-104; quick drying type: D-204, D-204EA, D-212, D-212L, D-212M6, D-215, D-217, D-218, D-219, D-51N, D-262, and D-268; and non-yellowing type: D-110N, D-120N, D-127N, D-140N, D-160N, N-165N, D-170N, D-170HN, D-172N, D-177N, and D-178N) (all of which are manufactured by Takeda Pharmaceutical Company Limited); and MT-OLESTER Series (for example, general type: P20, P49-75SS, P51-70, P53-70S, and P53-70SS; and quick drying type: P3300) (all of which are manufactured by Mitsui Takeda Chemicals, Inc.).

Aminoplasts

The compounds as described in the foregoing section of the hardening agent of the fluorine-containing polymer can be used. The compounds represented by H-1 or H-2 are especially preferable.

The foregoing reaction between a hydroxyl group-containing fluorine compound and a compound containing plural functional groups capable of reacting with a hydroxyl group in the molecule thereof can be carried out by, for example, mixing the both compounds in an organic solvent and undergoing the reaction at a temperature of from approximately room temperature to 200° C. for a period of time of from approximately 10 minutes to several hours.

Initiator:

The hardening of the interface between the low refractive index layer and the lower layer can be carried out by irradiation with ionizing radiations or heating in the presence of a photo radical initiator or a heat radical initiator.

In preparing the film of the invention, a photo initiator and a heat initiator can be used together.

<Photo Initiator>

Examples of the photo radical polymerization initiator include acetophenones, benzoins, benzophenones, phosphine oxides, ketals, anthraquinones, thioxanthones, azo compounds, peroxides (for example, ones described in JP-A-2001-139663), 2,3-dialkyldione compounds, disulfide compounds, fluoroamine compounds, aromatic sulfoniums, lophine dimers, onium salts, borate salts, active esters, active halogens, inorganic complexes, and coumarins.

Examples of the acetophenones include 2,2-dimethoxyacetophenone, 2,2-diethoxyacetophenone, p-dimethylacetophenone, 1-hydroxy- dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone, and 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether, and benzoin isopropyl ether. Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butyl peroxycarbonyl)benzophenone.

Examples of the borate salts include organic boric acid salt compounds as described in Japanese Patent No. 2764769, JP-A-2002-116539, and Kunz and Martin, Red Tech '98. Proceeding, April, pages 19 to 22 (1998), Chicago. For example, there are enumerated compounds as described in paragraphs [0022] to [0027] of the foregoing JP-A-2002-116539. Furthermore, specific examples of other organoboron compounds include organoboron transition metal-coordinated complexes as described in JP-A-6-348011, JP-A-7-128785, JP-A-7-140589, JP-A-7-306527, and JP-A-7-292014. Specific examples thereof also include ion complexes with a cationic dye.

Examples of the phosphine oxides include 2,4,6-trimethylbenzoyl diphenylphosphine oxide.

Examples of the active esters include 1,2-octanedione, 1-[4-(phenylthio)-2-(O-benzoyloxime)], sulfonic acid esters, and cyclic active ester compounds.

Concretely, Compounds 1 to 21 as described in the working examples of JP-A-2000-80068 are especially preferable.

Examples of the oniums include aromatic diazonium salts, aromatic iodonium salts, and aromatic sulfonium salts.

As the active halogens, there are concretely enumerated compounds as described in Wakabayashi, et al., Bull Chem. Soc. Japan, Vol. 42, 2924 (1969), U.S. Pat. No. 3,905,815, JP-A-5-27830, and M. P. Hutt, Journal of Heterocyclic Chemistry, Vol. 1 (No. 3), 1970, and especially oxazole compounds and s-triazine compounds having a trihalomethyl group substituted thereon. More suitably, there are enumerated s-triazine derivatives in which at least one mono-, di- or trihalogen-substituted methyl group is bound to an s-triazine ring. As specific examples, there are known s-triazine or oxathiazole compounds including 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-bromo-4-di(ethyl acetate)amino)phenyl)-4,6-bis(trichloromethyl)-s-triazine, and a 2-trihalomethyl-5-(p-methoxyphenyl)-1,3,4-oxadiazole. Concretely, compounds as described in JP-A-58-15503, pages 14 to 30 and JP-A-55-77742, pages 6 to 10; and Compound Nos. 1 to 8 as described in JP-B-60-27673, page 287, Compound Nos. 1 to 17 as described in JP-A-60-239736, pages 443 to 444, and Compound Nos. 1 to 19 of U.S. Pat. No. 4,701,399.

Examples of the inorganic complexes include bis-(η⁵-2,4-cyclopentadien-1-yl)-bis(2,6-difluoro-3-(1H-pyrrol-1-yl)phenyl)titanium.

Examples of the coumarins include 3-ketocoumarin.

Such an initiator may be used singly or in admixture.

A variety of examples are described in Saishin UV Koka Gijutsu (Latest UV Curing Technologies), published by Technical Information Institute Co., Ltd., page 159 (1991) and Kiyoshi Kato, Shigaisen Koka Shisutemu (Ultraviolet Ray Curing Systems), published by Sogo Gijutsu Center, pages 65 to 148 (1988) and are useful in the invention.

With respect to commercially available photo radical polymerization initiators, KAYACURE Series as manufactured by Nippon Kayaku Co., Ltd. (for example, DETX-S, BP-100, BDMK, CTX, BMS, 2-FAQ, ABQ, CPTX, EPD, ITX, QTX, BTC, and MCA), IRGACURE Series as manufactured by Ciba Speciality Chemicals (for example, 651, 184, 500, 819, 907, 369, 1173, 1870, 2959, 4265, and 4263), ESACURE Series as manufactured by Sartmer Company Inc. (for example, KIP100F, KB1, EB3, BP, X33, KT046, KT37, KIP150, and TZT), and combinations thereof are enumerated as preferred examples.

The photopolymerization initiator is preferably used in an amount in the range of from 0.1 to 15 parts by weight, and more preferably from 1 to 10 parts by weight based on 100 parts by weight of the polyfunctional monomer.

<Photosensitizer>

In addition to the photopolymerization initiator, a photosensitizer may be used. Specific examples of the photosensitizer include n-butylamine, triethylamine, tri-n-butyl phosphine, Michler's ketone, and thioxanthone.

In addition, at least one auxiliary agent such as azide compounds, thiourea compounds, and mercapto compounds may be combined and used.

With respect to commercially available photosensitizers, there are enumerated KAYACURE Series as manufactured by Nippon Kayaku Co., Ltd. (for example, DMBI and EPA).

<Heat Initiator>

Examples of a heat initiator which can be used include organic or inorganic peroxides, and organic azo or diazo compounds.

Concretely, examples of the organic peroxides include benzoyl peroxide, halogen benzoyl peroxides, lauroyl peroxide, acetyl peroxide, dibutyl peroxide, cumene hydroperoxide, and butyl hydroperoxide; examples of the inorganic peroxides include hydrogen peroxide, ammonium persulfate, and potassium persulfate; examples of the azo compounds include 2,2′-azobis(isobutyronitrile), 2,2′-azobis(propionitrile), and 1,1′-azobis(cyclohexanecarbonitrile); and examples of the diazo compounds include diazoaminobenzene and p-nitrobenzene diazonium.

<Hardening Catalyst>

In the film of the invention, the film is hardened by a crosslinking reaction of the hydroxyl group of the fluorine-containing polymer and the foregoing hardening agent while heating. In this system, since the hardening is accelerated by an acid, it is desired to add an acidic substance in the hardenable resin composition. However, when a usual acid is added, the crosslinking reaction also proceeds in the coating solution, resulting in causing a fault (for example, unevenness and cissing). Furthermore, in particular, when the conductive metal oxide-coated particle which is the component (B) of the invention and the acidic substance of the hardening catalyst are copresent, there may be a possibility that the surface of the particle causes change in quality due to the preservation in a coating solution state so that a lowering of the surface resistivity of the coating film becomes insufficient. Accordingly, in order to make the storage stability and the hardening activity compatible with each other in the heat hardening system, it is more preferred to add a compound capable of generating an acid by heating as a hardening catalyst.

It is preferable that the hardening catalyst is a salt made of an acid and an organic base. Examples of the acid include organic acids such as sulfonic acids, phosphonic acids, and carboxylic acids; and inorganic acids such as sulfuric acid and phosphoric acid. From the viewpoint of compatibility with the polymer, organic acids are more preferable; sulfonic acids and phosphonic acids are further preferable; and sulfonic acids are the most preferable. Preferred examples of the sulfonic acids include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH), and nonafluorobutane-1-sulfonic acid (NFBS). All of these compounds can be preferably used. (Each of the expressions in the parentheses is an abbreviation.) The hardening catalyst largely varies depending upon the basicity and boiling point of the organic base which is combined with the acid. The hardening catalyst which is preferably used in the invention will be described below from the respective viewpoints.

An organic base having a low basicity is high in acid generation efficiency at the time of heating and is preferable from the viewpoint of hardening activity. However, when the basicity is too low, the storage stability becomes insufficient. Accordingly, it is preferred to use an organic base having a proper basicity. When the basicity is expressed in terms of a pKa of a conjugated acid as an index, the pKa of the organic base which is used in the invention is required to be from 5.0 to 10.5, more preferably from 6.0 to 10.0, and further preferably from 6.5 to 10.0. With respect to the pKa value of the organic base, since values in aqueous solution are described in The Chemical Handbook Basic Edition (Revised Version, 5th Edition, edited by The Chemical Society of Japan and published by Maruzen Co., Ltd.), Vol. 2, II, pages 334 to 340, it is possible to select an organic base having a proper pKa among them. Furthermore, it is possible to preferably use a compound having a proper pKa in view of the structure even when it is not described in the subject reference. Compounds having a proper pKa as described in the subject reference will be given in the following Table 6, but it should not be construed that the invention is limited thereto.

TABLE 6

| | | pKa |
|---|---|---|
| b-1 | N,N-Dimethylaniline | 5.1 |
| b-2 | Benzimidazole | 5.5 |
| b-3 | Pyridine | 5.7 |
| b-4 | 3-Methylpyridine | 5.8 |
| b-5 | 2,9-Dimethyl-1,10-phenanthroline | 5.9 |
| b-6 | 4,7-Dimethyl-1,10-phenanthroline | 5.9 |
| b-7 | 2-Methylpyridine | 6.1 |
| b-8 | 4-Methylpyridine | 6.1 |
| b-9 | 3-(N,N-Dimethylamino)pyridine | 6.5 |
| b-10 | 2,6-Dimethylpyridine | 7.0 |
| b-11 | Imidazole | 7.0 |
| b-12 | 2-Methyl imidazole | 7.6 |
| b-13 | N-Ethylmorpholine | 7.7 |
| b-14 | N-Methylmorpholine | 7.8 |
| b-15 | Bis(2-methoxyethyl)amine | 8.9 |
| b-16 | 2,2′-Iminodiethanol | 9.1 |
| b-17 | N,N-Dimethyl-2-aminoethanol | 9.5 |
| b-18 | Trimethylamine | 9.9 |
| b-19 | Triethylamine | 10.7 |

An organic base having a low basicity is high in acid generation efficiency at the time of heating and is preferable from the viewpoint of hardening activity. Accordingly, it is preferred to use an organic base having a proper boiling point. The boiling point of the base is preferably not higher than 120° C., more preferably not higher than 80° C., and further preferably not higher than 70° C.

Examples of compounds which can be preferably used as the organic base in the invention will be given below, but it should not be construed that the invention is not limited thereto. Each of the expressions in the parentheses shows a boiling point.

b-3: pyridine (115° C.), b-14: 4-methylmorpholine (115° C.), b-20: diallylmethylamine (111° C.), b-19: triethylamine (88.8° C.), b-21: t-butylmethylamine (67 to 69° C.), b-22: dimethylisopropylamine (66° C.), b-23: diethylmethylamine (63 to 65° C.), b-24: dimethylethylamine (36 to 38° C.), b-18: trimethylamine (3 to 5° C.)

The boiling point of the organic base of the invention is 35° C. or higher and not higher than 85° C. The boiling point is more preferably 45° C. or higher and not higher than 80° C., and most preferably 55° C. or higher and not higher than 75° C.

When used as the acid catalyst of the invention, the foregoing salt made of an acid and an organic salt may be isolated and provided for use. Alternatively, a solution obtained by mixing an acid and an organic salt to form a salt in the solution may be used. Furthermore, only one kind of each of an acid and an organic base may be used, and plural kinds of each of an acid and an organic base may be mixed and used. When an acid and an organic base are mixed and used, it is preferred to mix the acid and the organic base such that an equivalent ratio is preferably from 1/0.9 to 1/1.5, more preferably from 1/0.95 to 1/1.3, and further preferably from 1/1.0 to 1/1.1.

A proportion of this acid catalyst to be used is preferably from 0.01 to 10 parts by weight, more preferably from 0.1 to 5 parts by weight, and further preferably from 0.2 to 3 parts by weight based on 100 parts by weight of the fluorine-containing polymer in the foregoing composition.

In the invention, in addition to the foregoing heat acid generator, a compound capable of generating an acid upon light irradiation, namely a photosensitive acid generator may be further added. The photosensitive acid generator is a substance which imparts photosensitivity to a film of the subject hardenable resin composition and is able to undergo photo hardening of the subject film upon irradiation with radiations such as light. As the photosensitive acid generator, (1) a variety of onium salts such as iodonium salts, sulfonium salts, phosphonium salts, diazonium salts, ammonium salts, iminium salts, arsonium salts, selenonium salts, and pyridinium salts; (2) sulfone compounds such as β-ketoesters, β-sulfonylsulfone, and α-diazo compounds thereof; (3) sulfonic acid esters such as alkylsulfonic acid esters, haloalkylsulfonic acid esters, arylsulfonic acid esters, and iminosulfonates; (4) sulfonimide compounds; (5) diazomethane compounds; and others can be enumerated and properly used.

<Low Refractive Index Particle>

It is desired that the inorganic particle which is contained in the low refractive index layer has a low refractive index. Examples thereof include fine particles of magnesium fluoride and silica. In view of refractive index, dispersion stability and costs, a silica fine particle is especially preferable.

The average particle size of the silica fine particle is preferably 30% or more and not more than 150%, more preferably 35% or more and not more than 80%, and further preferably 40% or more and not more than 60% of the thickness of the low refractive index layer. That is, when the thickness of the low refractive index layer is 100 nm, the particle size of the silica fine particle is preferably 30 nm or more and not more than 150 nm, more preferably 35 nm or more and not more than 80 nm, and further preferably 40 nm or more and not more than 60 nm.

When the particle size of the silica fine particle is too small, an effect for improving the scar resistance becomes low, whereas when it is too large, fine irregularities are formed on the surface of the low refractive index layer and the appearance such as deep black and integrated reflectance are deteriorated. The silica fine particle may be either crystalline or amorphous; it may be a monodispersed particle; and so far as a prescribed particle size is met, it may be a coagulated particle. Though the shape of the silica fine particle is most preferably spherical, even when it is amorphous, there is no problem.

Furthermore, it is preferred to use at least one silica fine particle having an average particle size of less than 25% of the thickness of the low refractive index layer (referred to as “small particle-sized silica fine particle”) together with the silica fine particle having the foregoing particle size (referred to as “large particle-sized silica fine particle”).

Since the small particle-sized silica fine particle can exist in a gap between the large particle-sized silica fine particles, it can contribute as a holding agent of the large particle-sized silica fine particle.

When the thickness ofthe low refractive index layer is 100 nm, the average particle size of the small particle-sized silica fine particle is preferably 1 nm or more and not more than 20 nm, more preferably 5 nm or more and not more than 15 nm, and especially preferably 10 nm or more and not more than 15 nm. The use of such a silica fine particle is preferable from the standpoints of raw material costs and an effect of the holding agent.

The coating amount of the low refractive index particle is preferably from 1 mg/m² to 100 mg/m², more preferably from 5 mg/m² to 80 mg/m², and further preferably from 10 mg/m² to 60 mg/m². When the coating amount of the low refractive index particle is too low, an effect for improving the scar resistance becomes low, whereas when it is too high, fine irregularities are formed on the surface of the low refractive index layer and the appearance such as deep black and integrated reflectance are deteriorated.

<Hollow Silica Particle>

For the purpose of more lowering the refractive index, it is preferred to use a hollow silica fine particle.

The hollow silica fine particle preferably has a refractive index of from 1.15 to 1.40, more preferably from 1.17 to 1.35, and most preferably from 1.17 to 1.30. The refractive index as referred to herein expresses a refractive index as the whole of the particle but does not express a refractive index of only silica as an outer shell which forms the hollow silica fine particle. At this time, when a radius of a void within the particle is defined as “a” and a radius of the outer shell of the particle is defined as “b”, a porosity x which is expressed by the following numerical expression (VIII):
x=(4πa3/3)/(4πb3/3)×100 Expression (VIII)
is preferably from 10 to 60%, more preferably from 20 to 60%, and most preferably from 30 to 60%. When it is intended to make the hollow silica fine so as to have a lower refractive index and a larger porosity, the thickness of only the outer shell becomes thin so that the strength as the particle is weakened. Accordingly, a particle having a low refractive index of less than 1.15 is not preferable from the viewpoint of scar resistance.

A method for producing hollow silica is described in, for example, JP-A-2001-233611 and JP-A-2002-79616. A particle having a void inside the shell, in which pores of the shell are plugged, is especially preferable. Incidentally, the refractive index of such a hollow silica particle can be calculated by a method as described in JP-A-2002-79616.

The coating amount of the hollow silica is preferably from 1 mg/m² to 100 mg/m², more preferably from 5 mg/m² to 80 mg/m², and further preferably from 10 mg/m² to 60 mg/m². When the coating amount of the hollow silica is too low, an effect for realizing a low refractive index and an effect for improving the scar resistance become low, whereas when it is too high, fine irregularities are formed on the surface of the low refractive index layer and the appearance such as deep black and integrated reflectance are deteriorated.

The average particle size of the hollow silica is preferably 30% or more and not more than 150%, more preferably 35% or more and not more than 80%, and further preferably 40% or more and not more than 60% of the thickness of the low refractive index layer. That is, when the thickness of the low refractive index layer is 100 nm, the particle size of the hollow silica is preferably 30 nm or more and not more than 150 nm, more preferably 35 nm or more and not more than 80 nm, and further preferably 40 nm or more and not more than 65 nm.

When the particle size of the silica fine particle is too small, a proportion of voids is reduced so that a lowering of the refractive index cannot be expected, whereas when it is too large, fine irregularities are formed on the surface of the low refractive index layer and the appearance such as deep black and integrated reflectance are deteriorated. The silica fine particle may be either crystalline or amorphous and may be a monodispersed particle. Though the shape of the silica fine particle is most preferably spherical, even when it is amorphous, there is no problem.

Furthermore, with respect to the hollow silica, two or more kinds of hollow silica having a different average particle size can be used together. Here, the average particle size of the hollow silica can be determined from an electron microscopic photograph.

In the invention, the hollow silica preferably has a specific surface area of from 20 to 300 m²/g, more preferably from 30 to 120 m²/g, and most preferably 40 to 90 m²/g. The surface area can be determined by a BET method using nitrogen.

In the invention, it is possible to use a void-free silica particle together with the hollow silica. The void-free silica preferably has a particle size of 30 nm or more and not more than 150 nm, more preferably 35 nm or more and not more than 100 nm, and most preferably 40 nm or more and not more than 80 nm.

1-(11) Surface Treating Agent:

For the purpose of designing to achieve dispersion stabilization or enhancing compatibility or binding properties with the binder component in the dispersion or coating solution, the inorganic particle which is used in the invention may be subjected to a physical surface treatment such as a plasma discharge treatment and a corona discharge treatment or a chemical surface treatment with a surfactant, a coupling agent, or the like.

The surface treatment can be carried out by using a surface treating agent made of an inorganic compound or an organic compound. Examples of the inorganic compound which is used for the surface treatment include cobalt-containing inorganic compounds (for example, CoO₂, Co₂O₃, and Co₃O₄), aluminum-containing inorganic compounds (for example, Al₂O₃ and Al(OH)₃), zirconium-containing inorganic compounds (for example, ZrO₂ and Zr(OH)₄), silicon-containing inorganic compounds (for example, SiO₂), and iron-containing inorganic compounds (for example, Fe₂O₃).

Of these, cobalt-containing inorganic compounds, aluminum-containing inorganic compounds, and zirconium-containing inorganic compounds are especially preferable; and cobalt-containing inorganic compounds, Al(OH)₃ and Zr(OH)₄ are the most preferable.

Examples of the organic compound which is used for the surface treatment include polyols, alkanolamines, stearic acid, silane coupling agents, and titanate coupling agents. Of these, silane coupling agents are the most preferable. It is especially preferable that the surface treatment is carried out by using at least one member of silane coupling agents (for example, organosilane compounds) and partial hydrolyzates or condensates thereof.

Examples of the titanate coupling agent include metal alkoxides such as tetramethoxytitanium, tetraethoxytitanium, and tetraisopropoxytitanium; and PLENACT Series (for example, KR-TTS, KR-46B, KR-55, and KR-41B, all of which are manufactured by Ajinomoto Co., Ind.).

As the organic compound which is used for the surface treatment, polyols and alkanolamines and besides, anionic group-containing organic compounds are preferable; and organic compounds containing a carboxyl group, a sulfonic acid group or a phosphoric acid group are especially preferable. Stearic acid, lauric acid, oleic acid, linoleic acid, linolenic acid, and so on can be preferably used.

It is preferable that the organic compound which is used for the surface treatment further contains a crosslinking or polymerizable functional group. Examples of the crosslinking or polymerizable functional group include ethylenically unsaturated groups capable of undergoing an addition reaction or polymerization reaction by a radical species (for example, a (meth)acryl group, an allyl group, a stearyl group, and a vinyloxy group), cationically polymerizable groups (for example, an epoxy group, an oxatanyl group, and a vinyloxy group), and polycondensation reactive groups (for example, a hydrolyzable silyl group and an N-methylol group). Of these, ethylenically unsaturated group-containing groups are preferable.

Two or more kinds of such a surface treatment can be employed. A combination of an aluminum-containing inorganic compound and a zirconium-containing inorganic compound is especially preferable.

When the inorganic particle is silica, it is especially preferred to use a coupling agent. Alkoxy metal compounds (for example, titanium coupling agents and silane coupling agents) are preferably used as the coupling agent. Above all, a silane coupling treatment is especially effective.

The foregoing coupling agent is used for undergoing a surface treatment in advance prior to the preparation of a coating solution as a surface treating agent of an inorganic filler of a low refractive index layer. It is preferred to contain the coupling agent in the subject layer by further addition as an additive at the time of preparation of the coating solution for the layer.

For the purpose of reducing a load of the surface treatment, it is preferable that the silica fine particle is dispersed in advance in a medium prior to the surface treatment.

Specific examples of the surface treating agent and the catalyst for the surface treatment which can be preferably used in the invention include organosilane compounds and catalysts as described in, for example, WO 2004/017105.

1-(12) Dispersant:

A variety of dispersants can be used for dispersing the particle which is used in the invention.

It is preferable that the dispersant further contains a crosslinking or polymerizable functional group. Examples of the crosslinking or polymerizable functional group include ethylenically unsaturated groups capable of undergoing an addition reaction or polymerization reaction by a radical species (for example, a (meth)acryl group, an allyl group, a stearyl group, and a vinyloxy group), cationically polymerizable groups (for example, an epoxy group, an oxatanyl group, and a vinyloxy group), and polycondensation reactive groups (for example, a hydrolyzable silyl group and an N-methylol group). Of these, ethylenically unsaturated group-containing groups are preferable.

For dispersing the inorganic particle, in particular dispersing an inorganic particle composed of, as the major component, TiO₂, it is preferred to use a dispersant containing an anionic group. It is more preferable that the dispersant contains an anionic group and a crosslinking or polymerizable functional group. It is especially preferable that the subject crosslinking or polymerizable functional group is contained in a side chain of the dispersant.

For the purpose of imparting characteristics such as dust removal properties and antistatic properties, dust removing agents or antistatic agents such as known cationic surfactants and polyoxyalkylene based compounds can also be properly added. With respect to such a dust removing agent or antistatic agent, its structural unit may be contained as a part of the function in the foregoing silicone based compound or fluorine based compound. When such a dust removing agent or antistatic agent is added as an additive, it is preferably added in an amount ranging from 0.01 to 20% by weight, more preferably from 0.05 to 10% by weight, and especially preferably from 0.1 to 5% by weight of the whole of solids of the low refractive index layer. Preferred examples of the dust removing agent or antistatic agent include MEGAFAC F-150 (a trade name of Dainippon Ink and Chemicals, Incorporated) and SH-3748 (a trade name of Dow Corning Toray Co., Ltd.). However, it should not be construed that the invention is limited thereto.

Constructions, constitutional layers and so on other than those described previously which are used in the invention will be hereunder described in detail.

3. Layer Configuration of Film:

With respect to the film of the invention, known layer configurations can be employed. Representative examples thereof will be given below.

(a) Support/hard coat layer

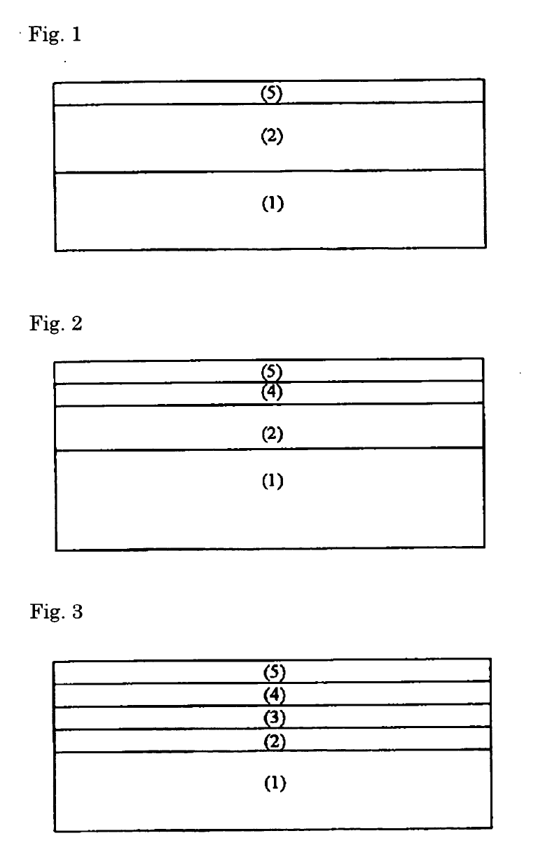

(b) Support/hard coat layer/low refractive index layer (see FIG. 1)

(c) Support/hard coat layer/high refractive index layer/low refractive index layer (see FIG. 2)

(d) Support/hard coat layer/middle refractive index layer/high refractive index layer/low refractive index layer (see FIG. 3)

As in (b) (FIG. 1), by stacking a low refractive index layer (5) on a hard coat layer (2) having been coated on a support (1), it is possible to suitably use the stack as the antireflection film. By forming the low refractive index layer (5) in a thickness of approximately ¼ of the wavelength of light on the hard coat layer (2), it is possible to reduce the surface reflection due to a principle of thin film interference.

Furthermore, as in (c) (FIG. 2), by stacking a high refractive index layer (4) and a low refractive index layer (5) on a hard coat layer (2) having been coated on a support (1), it is also possible to suitably use the stack as the antireflection film. In addition, as in (d) (FIG. 3), by placing a layer configuration of a support (1), a hard coat layer (2), a middle refractive index layer (3), a high refractive index layer (4), and a low refractive index layer (5) in this order, it is possible to keep a reflectance at not higher than 1%.

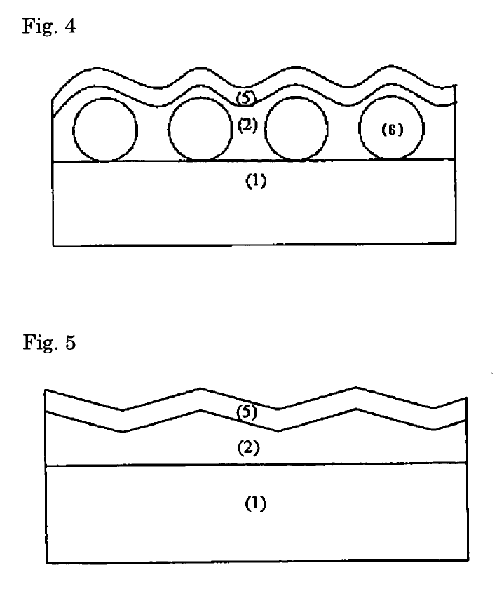

In the configurations (a) to (d), the hard coat layer (2) can be made of an antiglare layer having antiglare properties. The antiglare properties may be provided by dispersing a mat particle (6) as illustrated in FIG. 4, or may be provided by shaping the surface by a method such as embossing as illustrated in FIG. 5. An antiglare layer which is formed by dispersing the mat particle (6) is made of a binder and a translucent particle as dispersed in the binder. The antiglare layer having antiglare properties preferably has both antiglare properties and hard coat properties and may be configured by plural layers of, for example, from two layers to four layers.

Furthermore, examples of a layer which may be provided between a support and a layer in the side of the surface or on the outermost surface include a layer for preventing interference unevenness (spectral unevenness), an antistatic layer (in the case where requirements such as reduction of the surface resistivity value from the display side are presented or in the case where staining on the surface or the like becomes problematic), other hard coat layer (in the case where the hardness is insufficient only by the hard coat layer or antiglare layer made of a single layer), a gas barrier layer, a water absorbing layer (moisture-proof layer), an adhesiveness improving layer, and an antifouling layer (anti-contamination layer).

It is preferable that the refractive indexes of the respective layers which constitute the antiglare antireflection film having an antireflection layer in the invention meet the following relationship.
(Refractive index of hard coat layer)>(Refractive index of transparent support)>(Refractive index of low refractive index layer)
2. Constructions of the Antireflection Film of the Invention:

First of all, various compounds which can be used in the film of the invention will be described below.

2-(1) Binder:

The film of the invention can be formed by a crosslinking reaction or polymerization reaction of an ionizing radiation hardenable compound. That is, a binder layer can be formed by coating a coating composition containing an ionizing radiation hardenable polyfunctional monomer or polyfunctional oligomer on a transparent support and subjecting the polyfunctional monomer or polyfunctional oligomer to a crosslinking reaction or polymerization reaction.

As a functional group of the ionizing radiation hardenable polyfunctional monomer or polyfunctional oligomer, photopolymerizable functional groups, electron beam polymerizable functional groups, and radiation polymerizable functional groups are preferable, with the photopolymerizable functional being especially preferable.

Examples of the photopolymerizable functional group include unsaturated polymerizable functional groups such as a (meth)acryloyl group, a vinyl group, a styryl group, and an allyl group, with the (meth)acryloyl group being preferable. In particular, it is preferred to use a compound containing two or more (meth)acryloyl groups in one molecule thereof. As such a compound, the compounds as described in the foregoing [Constitutional component (E) of low refractive index layer of the invention] can be enumerated.

The polyfunctional monomer may be used in combination of two or more kinds thereof.

The polymerization of such an ethylenically unsaturated group-containing monomer can be carried out upon irradiation with ionizing radiations or heating in the presence of a photo radical initiator or a heat radical initiator.

For the polymerization reaction of the photopolymerizable polyfunctional monomer, it is preferred to use a photopolymerization initiator. As the photopolymerization initiator, photo radical polymerization initiators and photo cationic polymerization initiators are preferable, with the photo radical polymerization initiators being especially preferable.

2-(2) Polymer Binder:

In the invention, a polymer or a crosslinked polymer can be used as the binder. It is preferable that the crosslinked polymer contains an anionic group. The crosslinked anionic group-containing polymer has a structure in which the principal chain of an anionic group-containing polymer is crosslinked.

Examples of the principal chain of the polymer include polyolefins (saturated hydrocarbons), polyethers, polyurethanes, polyesters, polyamines, polyamides, and melamine resins. Above all, a polyolefin principal chain, a polyether principal chain and a polyurea principal chain are preferable; a polyolefin principal chain and a polyether principal chain are more preferable; and a polyolefin principal chain is the most preferable.

The polyolefin principal chain is composed of a saturated hydrocarbon. The polyolefin principal chain is obtained by, for example, an addition polymerization reaction of an unsaturated polymerizable group. In the polyether principal chain, a repeating unit thereof is bound via an ether bond (—O—). The polyether principal chain is obtained by, for example, a ring opening polymerization reaction of an epoxy group. In the polyurea principal chain, a repeating unit thereof is bound via a urea bond (—NH—CO—NH—). The polyurea principal chain is obtained by, for example, a condensation polymerization reaction between an isocyanate group and an amino group. In the polyurethane principal chain, a repeating unit thereof is bound via a urethane bond (—NH—CO—O—). The polyurethane principal chain is obtained by, for example, a condensation polymerization reaction between an isocyanate group and a hydroxyl group (including an N-methylol group). In the polyester principal chain, a repeating unit thereof is bound via an ester bond (—CO—O—). The polyester principal chain is obtained by, for example, a condensation polymerization reaction between a carboxyl group (including an acid halide group) and a hydroxyl group (including an N-methylol group). In the polyamine principal chain, a repeating unit thereof is bound via an imino bond (—NH—). The polyamine principal chain is obtained by, for example, a ring opening polymerization reaction of an ethyleneimine group. In the polyamide principal chain, a repeating unit thereof is bound via an amide bond (—NH—CO—). The polyamide principal chain is obtained by, for example, a reaction between an isocyanate group and a carboxyl group (including an acid halide group). The melamine resin principal chain is obtained by, for example, a condensation polymerization reaction between a triazine group (for example, melamine) and an aldehyde (for example, formaldehyde). Incidentally, in the melamine resin, the principal chain itself has a crosslinking structure.

The anionic group is bound directly to the polymer principal chain or bound to the principal chain via a connecting group. It is preferable that the anionic group is bound as a side chain to the principal chain via a connecting group.

Examples of the anionic group include a carboxylic acid group (carboxyl), a sulfonic acid group (sulfo), and a phosphoric acid group (phosphono), with the sulfonic acid group and the phosphoric acid group being preferable.

The anionic group may be in a salt state. A cation which forms a salt together with the anionic group is preferably an alkali metal ion. Furthermore, a proton of the anionic group may be dissociated.

It is preferable that the connecting group which binds the anionic group to the polymer principal chain is a divalent group selected from —CO—, —O—, an alkylene group, an arylene group, and combinations thereof.

The crosslinking structure undergoes chemical binding (preferably covalent binding) of two or more principal chains and preferably undergoes covalent binding of three or more principal chains. It is preferable that the crosslinking structure is composed of divalent or polyvalent groups selected from —CO—, —O—, —S—, a nitrogen atom, a phosphorus atom, an aliphatic residue, an aromatic residue, and combinations thereof.

It is preferable that the crosslinked anionic group-containing polymer is a copolymer containing an anionic group-containing repeating unit and a repeating unit having a crosslinking structure. A proportion of the anionic group-containing repeating unit in the copolymer is preferably from 2 to 96% by weight, more preferably from 4 to 94% by weight, and most preferably from 6 to 92% by weight. The repeating unit may contain two or more anionic groups. A proportion of the repeating unit having a crosslinking structure in the copolymer is preferably from 4 to 98% by weight, more preferably from 6 to 96% by weight, and most preferably from 8 to 94% by weight.

The repeating unit of the crosslinked anionic group-containing polymer may have both an anionic group and a crosslinking structure. Furthermore, other repeating unit (repeating unit having neither an anionic group nor a crosslinking structure) may be contained.

As other repeating unit, a repeating unit containing an amino group or a quaternary ammonium group and a repeating unit containing a benzene ring are preferable. The amino group or quaternary ammonium group has a function to hold a dispersed state of an inorganic particle similar to the anionic group. Incidentally, even when the amino group, the quaternary ammonium group or the benzene ring is contained in the anionic group-containing repeating unit or the repeating unit having a crosslinking structure, the same effect is obtainable.

In the repeating unit containing an amino group or a quaternary ammonium group, the amino group or the quaternary ammonium group is bound directly to the polymer principal chain or bound to the principal chain via a connecting group. It is preferable that the amino group or the quaternary ammonium group is bound as a side chain to the principal chain via a connecting group. The amino group or the quaternary ammonium group is preferably a secondary amino group, a tertiary amino group, or a quaternary ammonium group, and more preferably a tertiary amino group or a quaternary ammonium group. In the secondary amino group, tertiary amino group or quaternary ammonium group, a group which is bound to the nitrogen atom is preferably an alkyl group, more preferably an alkyl group having from 1 to 12 carbon atoms, and most preferably an alkyl group having from 1 to 6 carbon atoms. It is preferable that a counter ion of the quaternary ammonium group is a halide ion. It is preferable that the connecting group which binds the secondary amino group, tertiary amino group or quaternary ammonium group to the polymer principal chain is a divalent group selected from —CO—, —NH—, —O—, an alkylene group, an arylene group, and combinations thereof. In the case where the crosslinked anionic group-containing polymer contains a repeating unit containing an amino group or a quaternary ammonium group, a proportion of the repeating unit is preferably from 0.06 to 32% by weight, more preferably from 0.08 to 30% by weight, and most preferably from 0.1 to 28% by weight.

2-(3) Organosilane Compound:

In the invention, the organosilane compound as described in the foregoing [Constitutional component (D) of low refractive index layer of the invention] can be used. These compounds may be effective for improving the dispersibility of the inorganic particles and the adhesiveness at an interface of each layer.

2-(4) Initiator:

The polymerization of a variety of ethylenically unsaturated group-containing monomers can be carried out by irradiation with ionizing radiations or heating in the presence of a photo radical initiator or a heat radical initiator. Concrete examples of the initiator and an amount of the initiator to be used are described at above descriptions with regard to the low refractive index layer.

2-(5) Translucent Particle:

In order to impart antiglare properties (surface scattering properties) or internal scattering properties to the film of the invention, in particular the antiglare layer or the hard coat layer, a variety of translucent particles can be used.

The translucent particle may be either an organic particle or an inorganic particle. When there is no scattering in the particle size, scattering in the scattering characteristic becomes small so that it is easy to design a haze value. Plastic beads are suitable as the translucent particle. In particular, ones having a high transparency and having the foregoing numerical value in a difference of the refractive index from the binder are preferable.

Examples of the organic particle include a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), and a benzoguanamine-melamine formaldehyde particle (refractive index: 1.68).

Examples of the inorganic particle include a silica particle (refractive index: 1.44), an alumina particle (refractive index: 1.63), a zirconia particle, a titania particle, and hollow or porous inorganic particles.

Above all, a crosslinked polystyrene particle, a crosslinked poly((meth)acrylate) particle, and a crosslinked poly(acryl-styrene) particle are preferably used. By adjusting the refractive index of the binder adaptive to the refractive index of each of the translucent particles as selected among these particles, it is possible to attain an internal haze, a surface haze and a center line mean roughness of the invention.

In addition, it is preferred to use a combination of a binder composed of, as the major component, a trifunctional or polyfunctional (meth)acrylate monomer (refractive index after hardening: 1.50 to 1.53) with a translucent particle made of a crosslinked poly(meth)acrylate polymer having an acryl content of from 50 to 100% by weight. A combination of a binder with a translucent particle made of a crosslinked poly(styrene-acryl) copolymer (refractive index: 1.48 to 1.54) is especially preferable.

In the invention, the refractive index of a combination of the binder (translucent resin) with the translucent particle is preferably from 1.45 to 1.70, and more preferably from 1.48 to 1.65. In order to make the refractive index fall within the foregoing range, the kinds and amounts of the binder and the translucent particle may be properly selected. How to select the kinds and amounts can be experimentally known in advance with ease.

Furthermore, in the invention, a difference in refractive index between the binder and the translucent particle [(refractive index of translucent particle)−(refractive index of binder)] is preferably from 0.001 to 0.030, more preferably from 0.001 to 0.020, and further preferably from 0.001 to 0.015 in terms of an absolute value. When this difference exceeds 0.030, there are caused problems such as blurring of film letters, lowering of dark room contrast, and cloudiness of surface.

Here, the refractive index of the binder can be quantitatively determined and evaluated by, for example, direct measurement by an Abbe's refractometer or measurement of a spectral reflection spectrum or spectral ellipsometry. The refractive index of the foregoing translucent particle is measured by dispersing an equivalent amount of the translucent particle in a solvent having a varied refractive index by varying a mixing ratio of two kinds of solvents having a different refractive index to measure a turbidity and measuring a refractive index of the solvent at which the turbidity becomes minimum by an Abbe's refractometer.

In the case of the foregoing translucent particle, since the translucent particle is liable to sediment even in the binder, an inorganic filler such as silica may be added for the purpose of preventing the sedimentation. Incidentally, though what the amount of addition of the inorganic filler is increased is effective for preventing the sedimentation of the translucent particle, it adversely affects the transparency of the film. Accordingly, it is preferable that an inorganic filler having a particle size of not more than 0.5 μm is contained in an amount of less than about 0.1% by weight in the binder to such extent that the transparency of the film is not hindered.

The translucent particle preferably has an average particle size of from 0.5 to 10 μm, and more preferably from 2.0 to 6.0 μm.

Furthermore, two or more kinds of transparent particles having a different particle size may be used together. It is possible to impart antiglare properties by a translucent particle having a larger particle size and to reduce a rough feeling of the surface by a translucent particle having a smaller particle size, respectively.

The foregoing translucent particle is blended such that it is preferably contained in an amount of from 3 to 30% by weight, and more preferably from 5 to 20% by weight based on the whole of solids of the layer to which the translucent particle is added. When the blending amount of the translucent particle is less than 3% by weight, the addition effect is insufficient, whereas when it exceeds 30% by weight, there are caused problems such as blurring of an image, cloudiness of surface, and glare.

Furthermore, the translucent particle preferably has a density of from 10 to 1,000 mg/m², and more preferably from 100 to 700 mg/m².

<Preparation and Classification Methods of Translucent Particle>

Examples of a method for producing the translucent particle according to the invention include a suspension polymerization method, an emulsion polymerization method, a soap-free emulsion polymerization method, a dispersion polymerization method, and a seed polymerization method. The translucent particle may be produced by any of these methods. Such a production method can be carried out by referring to methods as described in, for example, Kobunshi Gosei no Jikkenho (Exerimental Methods of Polymer Synthesis) (written by Takayuki Otsu and Masayoshi Kinoshita and published by Kagaku-dojin Publishing Company, Inc.), pages 130 and 146 to 147, Gosei Kobunshi (Synthetic Polymers), Vol. 1, pages 246 to 290, ibid., Vol. 3, pages 1 to 108, Japanese Patent Nos. 2543503, 3508304, 2746275, 3521560 and 3580320, JP-A-10-1561, JP-A-7-2908, JP-A-5-297506, and JP-A-2002-145919.

With respect to the particle size distribution of the translucent particle, a monodispersed particle is preferable in view of control of a haze value and diffusibility and uniformity of coating surface properties. For example, when a particle having a particle size of 20% or more larger than the average particle size is defined as a coarse particle, a proportion of this coarse particle is preferably not more than 1%, more preferably not more than 0.1%, and further preferably not more than 0.01%. In order to obtain a particle having such particle size distribution, it is an effective measure to perform classification after the preparation or synthesis reaction. By increasing the number of classification or strengthening its degree, it is possible to obtain a particle having desired particle size distribution.

For the classification, it is preferred to employ a method such as an air classification method, a centrifugal classification method, a sedimentation classification method, a filtration classification method, and an electrostatic classification method.

2-(6) Inorganic Particle:

In the invention, for the purpose of improving physical characteristics such as hardness and optical characteristics such as reflectance and scattering properties, a variety of inorganic particles can be used.

Examples of the inorganic particle include oxides of at least one metal selected among silicon, zirconium, titanium, aluminum, indium, zinc, tin, and antimony. Specific examples thereof include ZrO₂, TiO₂, Al₂O₃, In_{2O}₃, ZnO, SnO₂, Sb₂O₃, and ITO. Besides, BaSO₄, CaCO₃, talc, and kaolin.

With respect to the particle size of the inorganic particle which is used in the invention, it is preferable that the inorganic particle is finely divided in a dispersion medium as far as possible. The particle size of the inorganic particle is from 1 to 200 nm, preferably from 5 to 150 nm, more preferably from 10 to 100 nm, and especially preferably from 10 to 80 nm in terms of a weight average molecular weight. By finely dividing the inorganic particle to not more than 100 nm, it is possible to form a film whose transparency is not hindered. The particle size of the inorganic particle can be measured by a light scattering method or from an electron microscopic photograph.

The inorganic particle preferably has a specific surface area of from 10 to 400 m²/g, more preferably from 20 to 200 m²/g, and most preferably 30 to 150 m²/g.

It is preferable that the inorganic particle which is used in the invention is added in a coating solution for a layer to be used as a dispersion in a dispersion medium.

It is preferred to use a liquid having a boiling point of from 60 to 170° C. as the dispersion medium of the inorganic particle. Examples of the dispersion medium include water, alcohols (for example, methanol, ethanol, isopropanol, butanol, and benzyl alcohol), ketones (for example, acetone, methyl ethyl ketone, methyl isobutyl ketone, and cyclohexanone), esters (for example, methyl acetate, ethyl acetate, propyl acetate, butyl acetate, methyl formate, ethyl formate, propyl formate, and butyl formate), aliphatic hydrocarbons (for example, hexane and cyclohexane), halogenated hydrocarbons (for example, methylene chloride, chloroform, and carbon tetrachloride), aromatic hydrocarbons (for example, benzene, toluene, and xylene), amides (for example, dimethylformamide, dimethylacetamide, and n-methylpyrrolidone), ethers (for example, diethyl ether, dioxane, and tetrahydrofuran), and ether alcohols (for example, 1-methoxy-2-propanol). Of these, toluene, xylene, methyl ethyl ketone, methyl isobutyl ketone, cyclohexanone, and butanol are especially preferable.

The most preferred dispersion medium is methyl ethyl ketone, methyl isobutyl ketone, or cyclohexanone.

The inorganic particle is dispersed by using a dispersion machine. Examples of the dispersion machine include a sand grinder mill (for example, a pin-provided bead mill), a high-speed impeller mill, a pebble mill, a roller mill, an attritor, and a colloid mill. Of these, a sand grinder mill and a high-speed impeller mill are especially preferable. Furthermore, a preliminary dispersion treatment may be carried out. Examples of a dispersion machine which is used for the preliminary dispersion treatment include a ball mill, a three-roll mill, a kneader, and an extruder.

<High Refractive Index Particle>

For the purpose of realizing a high refractive index of a layer which constitutes the invention, a hardened material of a composition in which an inorganic particle having a high refractive index is dispersed in a monomer, an initiator and an organic substituted silicon compound.

In this case, ZrO₂ and TiO₂ are especially preferably used as the inorganic particle from the viewpoint of refractive index. ZrO₂ is the most preferable for the purpose of realizing a high refractive index of the hard coat layer; and a fine particle of TiO₂ is the most preferable as a particle for a high refractive index layer or a middle refractive index layer.

<Low Refractive Index Particle>

In order to lower a refractive index of the layer, inorganic particles having a low refractive index can be used. Examples thereof include fine particles of magnesium fluoride and silica. In view of refractive index, dispersion stability and costs, a silica fine particle is especially preferable. For the purpose of more lowering the refractive index, it is more preferred to use a porous or hollow silica fine particle.

2-(7) Conductive Particle:

In order to impart conductivity to the constitutional layers other than the low refractive index layer in the film of the invention, a variety of conductive particles can be used.

It is preferable that the conductive particle is formed of a metal oxide or nitride. Examples of the metal oxide or nitride include tin oxide, indium oxide, zinc oxide, and titanium nitride. Of these, tin oxide and indium oxide are especially preferable. The conductive inorganic particle contains, as the major component, such a metal oxide or nitride and can further contain other element. The “major component” as referred to herein means a component having the highest content (% by weight) among the components which constitute the particle. Examples of other element include Ti, Zr, Sn, Sb, Cu, Fe, Mn, Pb, Cd, As, Cr, Hg, Zn, Al, Mg, Si, P, S, B, Nb, In, V, and halogen atoms. For the purpose of enhancing the conductivity of tin oxide and indium oxide, it is preferred to use Sb, P, B, Nb, In, V, or a halogen atom. Tin oxide containing Sb (ATO) and indium oxide containing Sn (ITO) are especially preferable. A proportion of Sb in ATO is preferably from 3 to 20% by weight; and a proportion of Sn in ITO is preferably from 5 to 20% by weight.

A primary particle of the conductive inorganic particle which is used for an antistatic layer preferably has an average particle size of from 1 to 150 nm, more preferably from 5 to 100 nm, and most preferably from 5 to 70 nm. The conductive inorganic particle in the antistatic layer to be formed has an average particle size of from 1 to 200 nm, preferably from 5 to 150 nm, more preferably from 10 to 100 nm, and most preferably from 10 to 80 nm. The average particle size of the conductive inorganic particle is an average particle size expecting the weight of the particle as a weight and can be measured by a light scattering method or from an electron microscopic photograph.

The conductive inorganic particle preferably has a specific surface area of from 10 to 400 m²/g, more preferably from 20 to 200 m²/g, and most preferably from 30 to 150 m²/g.

The conductive inorganic particle may be subjected to a surface treatment. The surface treatment is carried out by using an inorganic compound or an organic compound. Examples of the inorganic compound which is used for the surface treatment include alumina and silica. A silica treatment is especially preferable. Examples of the organic compound which is used for the surface treatment include polyols, alkanolamines, stearic acid, silane coupling agents, and titanate coupling agents. Of these, silane coupling agents are the most preferable. The surface treatment may be carried out by combining two or more kinds of surface treatments.

It is preferable that the shape of the conductive inorganic particle is a rice grain form, a spherical form, a cubic form, a spindle-like shape, or an amorphous form.

Two or more kinds of conductive particles may be used together within a specific layer or as a film.

A proportion of the conductive inorganic particle in the antistatic layer is preferably from 20 to 90% by weight, more preferably from 25 to 85% by weight, and further preferably from 30 to 80% by weight.

The conductive inorganic particle can be used in a state of dispersion for the formation of an antistatic layer.

2-(8) Surface Treating Agent:

For the purpose of designing to achieve dispersion stabilization or enhancing compatibility or binding properties with the binder component in the dispersion or coating solution, the inorganic particle which is used in the invention may be subjected to a physical surface treatment such as a plasma discharge treatment and a corona discharge treatment or a chemical surface treatment with a surfactant, a coupling agent, or the like. The surface treatment can be carried out by using the same method as that explained at the above descriptions for the low refractive index layer.

2-(9) Surfactant:

In particular, in order to ensure uniformity in surface properties such as coating unevenness, drying unevenness, and point defect, it is preferred that any one or both of a fluorine based surfactant and a silicone based surfactant is contained in a coating composition. In particular, a fluorine based surfactant can be preferably used because it reveals an effect for improving a fault of surface properties such as coating unevenness, drying unevenness, and point defect in a smaller amount of addition. It is possible to increase the productivity by bringing high-speed coating adaptability while increasing the uniformity in surface properties.

Preferred examples of the fluorine based surfactant include fluoro aliphatic group-containing copolymers (sometimes abbreviated as “fluorine based polymer”). As the fluorine based polymer, an acrylic resin or a methacrylic resin which is characterized by containing a repeating unit corresponding to the following monomer (i) or containing a repeating unit corresponding to the following monomer (ii), or a copolymer thereof with a copolymerizable vinyl based monomer is useful.
(i) Fluoro aliphatic group-containing monomer represented by the following formula (a):

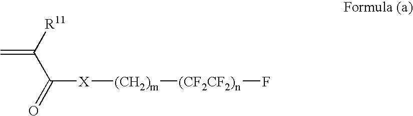

In the formula (a), R¹¹ represents a hydrogen atom or a methyl group; X represents an oxygen atom, a sulfur atom, or —N(R¹²)—; m represents an integer of 1 or more and not more than 6; and n represents an integer of from 2 to 4. R¹² represents a hydrogen atom or an alkyl group having from 1 to 4 carbon atoms, specifically a methyl group, an ethyl group, a propyl group or a butyl group, with a hydrogen atom and a methyl group being preferable. X is preferably an oxygen atom.
(ii) Monomer represented by the following formula (b), which is copolymerizable with the monomer of the foregoing (i):

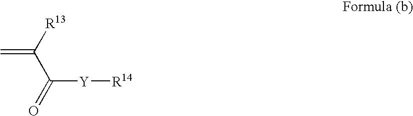

In the formula (b), R¹³ represents a hydrogen atom or a methyl group; Y represents an oxygen atom or a sulfur atom, or —N(R¹⁵)—; and R¹⁵ represents a hydrogen atom or an alkyl group having from 1 to 4 carbon atoms, specifically a methyl group, an ethyl group, a propyl group or a butyl group, with a hydrogen atom and a methyl group being preferable. Y is preferably an oxygen atom, —N(H)—, or —N(CH₃)—.

R¹⁴ represents an optionally substituted linear, branched or cyclic alkyl group having 4 or more and not more than 20 carbon atoms. Examples of a substituent of the alkyl group represented by R¹⁴ include a hydroxyl group, an alkylcarbonyl group, an arylcarbonyl group, a carboxyl group, an alkyl ether group, an aryl ether group, a halogen atom (for example, a fluorine atom, a chlorine atom, and a bromine atom), a nitro group, a cyano group, and an amino group. However, it should not be construed that the invention is limited thereto. As the linear, branched or cyclic alkyl group having 4 or more and not more than 20 carbon atoms, there are suitably used a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadeyl group, and an eicosanyl group, each of which may be linear or branched; monocyclic cycloalkyl groups such as a cyclohexyl group and a cycloheptyl group; and polycyclic cycloalkyl groups such as a bicycloheptyl group, a bicyclodecyl group, a tricycloundecyl group, a tetracyclododecyl group, an adamantyl group, a norbornyl group, and a tetracyclodecyl group.

The amount of the fluoro aliphatic group-containing monomer represented by the formula (a) which is used in the fluorine based polymer to be used in the invention is in the range of 10% by mole or more, preferably from 15 to 70% by mole, and more preferably from 20 to 60% by mole based on each of the monomers of the fluorine based polymer.

The fluorine based polymer which is used in the invention preferably has a weight average molecular weight of from 3,000 to 100,000, and more preferably from 5,000 to 80,000.

In addition, the amount of addition of the fluorine based polymer which is used in the invention is preferably in the range of from 0.001 to 5% by weight, more preferably in the range of from 0.005 to 3% by weight, and further preferably in the range of from 0.01 to 1% by weight based on the coating solution.

Thickener:

In the film of the invention, a thickener may be used for the purpose of adjusting the viscosity of the coating composition.

The “thickener” as referred to herein means a substance capable of increasing the viscosity of the solution by the addition thereof. A degree of the increase of the viscosity of the coating composition by the addition of the thickener is preferably from 0.05 to 50 cP, more preferably from 0.10 to 20 cP, and most preferably from 0.10 to 10 cP.

Examples of such a thickener will be given below, but it should not be construed that the invention is limited thereto.

Poly-ε-caprolactone

Poly-ε-caprolactone diol

Poly-ε-caprolactone triol

Polyvinyl acetate

Poly(ethylene adipate)

Poly(1,4-butylene adipate)

Poly(1,4-butylene glutarate)

Poly(1,4-butylene succinate)

Poly(1,4-butylene terephthalate)

Poly(ethylene terephthalate)

Poly(2-methyl-1,3-propylene adipate)

Poly(2-methyl-1,3-propylene glutarate)

Poly(neopentyl glycol adipate)

Poly(neopentyl glycol sebacate)

Poly(1,3-propylene adipate)

Poly(1,3-propylene glutarate)

Polyvinyl butyral

Polyvinyl formal

Polyvinyl acetal

Polyvinyl propanal

Polyvinyl hexanal

Polyvinyl pyrrolidone

Polyacrylic esters

Polymethacrylic esters

Cellulose acetate

Cellulose propionate

Cellulose acetate butyrate

Besides, there can also be used known viscosity adjusters and thixotropic agents such as smectite, fluorotetrasilicomica, bentonite, silica, montmorillonite, and poly(sodium acrylate) as described in JP-A-8-325491; and ethyl cellulose, polyacrylic acid, and organic clays as described in JP-A-10-219136.

2-(10) Coating Solvent:

As a solvent which is used in a coating composition for forming each of the layers of the invention, a variety of solvents which are selected from the viewpoints that each component can be dissolved or dispersed therein; that uniform surface properties are liable to be obtained in a coating step and a drying step; that liquid preservability can be ensured; and that they have a proper saturated vapor pressure can be used.

A mixture of two or more kinds of solvents can be used. In particular, it is preferable from the viewpoint of a drying load that a solvent having a boiling point of not higher than 100° C. at room temperature under atmospheric pressure is used as the major component, whereas a small amount of a solvent having a boiling point of 100° C. or higher is contained for the purpose of adjusting the drying speed.

Examples of the solvent having a boiling point of not higher than 100° C. include hydrocarbons such as hexane (boiling point: 68.7° C.), heptane (boiling point: 98.4° C.), cyclohexane (boiling point: 80.7° C.), and benzene (boiling point: 80.1° C.); halogenated hydrocarbons such as dichloromethane (boiling point: 39.8° C.), chloroform (boiling point: 61.2° C.), carbon tetrachloride (boiling point: 76.8° C.), 1,2-dichloroethane (boiling point: 83.5° C.), and trichloroethylene (boiling point: 87.2° C.); ethers such as diethyl ether (boiling point: 34.6° C.), diisopropyl ether (boiling point: 68.5° C.), dipropyl ether (boiling point: 90.5° C.), and tetrahydrofuran (boiling point: 66° C.); esters such as ethyl formate (boiling point: 54.2° C.), methyl acetate (boiling point: 57.8° C.), ethyl acetate (boiling point: 77.1° C.), and isopropyl acetate (boiling point: 89° C.); ketones such as acetone (boiling point: 56.1° C.) and 2-butanone (the same as methyl ethyl ketone, boiling point: 79.6° C.); alcohols such as methanol (boiling point: 64.5° C.), ethanol (boiling point: 78.3° C.), 2-propnaol (boiling point: 82.4° C.), and 1-propanol (boiling point: 97.2° C.); cyano compounds such as acetonitrile (boiling point: 81.6° C.) and propionitrile (boiling point: 97.4° C.); and carbon disulfide (boiling point: 46.2° C.). Of these, ketones and esters are preferable; and ketones are especially preferable. Among the ketones, 2-butanol is especially preferable.

Examples of the solvent having a boiling point of 100° C. or higher include octane (boiling point: 125.7° C.), toluene (boiling point: 110.6° C.), xylene (boiling point: 138° C.), tetrachloroethylene (boiling point: 121.2° C.), chlorobenzene (boiling point: 131.7° C.), dioxane (boiling point: 101.3° C.), dibutyl ether (boiling point: 142.4° C.), isobutyl acetate (boiling point: 118° C.), cyclohexanone (boiling point: 155.7° C.), 2-methyl-4-pentanone (the same as MIBK, boiling point: 115.9° C.), 1-butanol (boiling point: 117.7° C.), N,N-dimethylformamide (boiling point: 153° C.), N,N-dimethylacetamide (boiling point: 166° C.), and dimethyl sulfoxide (boiling point: 189° C.). Of these, cyclohexanone and 2-methyl-4-pentanone are preferable.

2-(11) Others:

In addition to the foregoing components, a resin, a coupling agent, a coloration preventing agent, a coloring agent (for example, pigments and dyes), a defoaming agent, a leveling agent, a flame retarder, an ultraviolet ray absorber, an infrared ray absorber, an adhesion imparting agent, a polymerization inhibitor, an antioxidant, a surface modifier, and so on can also be added in the film of the invention.

2-(12) Support:

A support of the film of the invention is not particularly limited, and examples thereof include a transparent resin film, a transparent resin plate, a transparent resin sheet, and a transparent glass. Examples of the transparent resin film include a cellulose acylate film (for example, a cellulose triacetate film (refractive index: 1.48), a cellulose diacetate film, a cellulose acetate butyrate film, and a cellulose acetate propionate film), a polyethylene terephthalate film, a polyethersulfone film, a polyacrylic resin film, a polyurethane based film, a polyester film, a polycarbonate film, a polysulfone film, a polyether film, a polymethylpentene film, a polyether ketone film, a (meth)acrylonitrile film, and a cycloolefin polymer film.

<Cellulose Acylate Film>

Above all, a cellulose acylate film which is high in transparency, low in optical birefringence and easy for manufacturing and which is generally used as a protective film of polarizing plate is preferable, and a cellulose triacetate film is especially preferable. Furthermore, the thickness of the transparent support is usually from about 25 μm to 1,000 μm.

In the invention, it is preferred to use cellulose acetate having a degree of acetylation of from 59.0 to 61.5% for the cellulose acylate film.

The “degree of acetylation” as referred to herein means an amount of bound acetic acid per cellulose unit weight. The degree of acetylation complies with the measurement and calculation in ASTM D-817-91 (test methods of testing cellulose acetate and so on).

The cellulose acylate preferably has a viscosity average degree of polymerization (DP) of 250 or more, and more preferably 290 or more.

Furthermore, it is preferable that the cellulose acylate which is used in the invention has a value of Mw/Mn (wherein Mw represents a weight average molecular weight, and Mn represents a number average molecular weight), as measured by gel permeation chromatography, close to 1.0, in another word, the molecular weight distribution is narrow. Concretely, the Mw/Mn value is preferably from 1.0 to 1.7, more preferably from 1.3 to 1.65, and most preferably from 1.4 to 1.6.

In general, it is not the case that the hydroxyl groups at the 2-, 3- and 6-positions of the cellulose acylate are equally distributed at every ⅓ of the entire degree of substitution, but the degree of substitution of the hydroxyl group at the 6-position tends to become small. In the invention, it is preferable that the degree of substitution of the hydroxyl group at the 6-position of the cellulose acylate is larger than that at the 2- or 3-position.

The hydroxyl group at the position is preferably substituted with an acyl group in a proportion of 32% or more, more preferably 33% or more, and especially preferably 34% or more of the entire degree of substitution. In addition, it is preferable that the degree of substitution of the acyl group at the 6-position of the cellulose acylate is 0.88 or more. The hydroxyl group at the 6-position may be substituted with an acyl group having 3 or more carbon atoms other than the acetyl group (for example, a propionyl group, a butyroyl group, a valeroyl group, a benzoyl group, and an acryloyl group). The measurement of the degree of substitution at each position can be determined by NMR.

In the invention, cellulose acetate as obtained by methods as described in JP-A-11-5851, paragraphs [0043] to [0044], [Examples] [Synthesis Example 1], paragraphs [0048] to [0049], [Synthesis Example 2] and paragraphs [0051] to [0052], [Synthesis Example 3] can be used as the cellulose acylate.

<Polyethylene Terephthalate Film>

In the invention, a polyethylene terephthalate film is preferably used, too because not only it is excellent in all of transparency, mechanical strength, flatness, chemical resistance and humidity resistance, but also it is cheap.

For the purpose of more improving the adhesive strength of the transparent plastic film and the hard coat layer to be provided thereon, it is more preferable that the transparent plastic film is subjected to an easy adhesion treatment.

As a commercially available optical easy-adhesion layer-provided PET film, there are enumerated COSMOSHINE A4100 and A4300, as manufactured by Toyobo Co., Ltd.

<Cycloolefin Polymer Film>

In the invention, a cycloolefin polymer film is also preferably used because it is excellent in transparency, flatness, chemical resistance and humidity resistance. Above all, a polymer film having a norbornene structure is preferable. Specific examples of the film include commercially available products such as ZEONOR Series and ZEONEX Series (trade names of Zeon Corporation), ARTON Series (a trade name of JSR Corporation), OPTOREZ Series (a trade name of Hitachi Chemical Co., Ltd.), and APEL Series (a trade name of Mitsui Chemicals, Inc.).

3. Layers Constituting the Film:

The film of the invention is obtained by mixing and coating the foregoing respective compounds. Next, the layers which constitute the film of the invention will be described.

3-(1) Antiglare Layer:

An antiglare layer is formed for the purpose of imparting antiglare properties due to surface scattering as defined in the invention, and preferably hard coat properties for improving the scar resistance of the film to the film.

As a method of forming the antiglare layer, there are known a method of forming an antiglare layer by laminating a mat-like shaping film having fine irregularities on the surface thereof as described in JP-A-6-16851; a method of forming an antiglare layer by hardening and shrinking an ionizing radiation hardenable resin due to a difference of an ionizing radiation dose as described in JP-A-2000-206317; a method of forming an antiglare layer by solidifying a translucent fine particle and a translucent resin while gelling by utilizing a reduction of the weight ratio of a good solvent against the translucent resin upon drying, thereby forming irregularities on the film surface as described in JP-A-2000-338310; and a method of forming an antiglare layer by imparting surface irregularities by a pressure from the outside as described in JP-A-2000-275404. These known methods can be utilized.

In the antiglare layer which can be used in the invention, it is preferable that a binder capable of imparting hard coat properties, a translucent particle for imparting antiglare properties and a solvent are contained as essential components and that surface irregularities are formed by projections of the translucent particle itself or projections formed by an agglomerate of plural particles.

The antiglare layer formed by dispersing a mat particle is made of a binder and a translucent particle as dispersed in the binder. It is preferable that the antiglare layer having antiglare properties has both antiglare properties and hard coat properties.

Specific examples of the mat particle which is suitably used include particles of an inorganic compound such as a silica particle and a TiO₂ particle; and resin particles such as an acrylic resin particle, a crosslinked acrylic resin particle, a polystyrene particle, a crosslinked styrene resin particle, a melamine resin particle, and a benzoguanamine resin particle. Of these, a crosslinked styrene resin particle, a crosslinked acrylic resin particle, and a silica particle are preferable.

The shape of the mat particle which can be employed may be either spherical or amorphous.

The particle size distribution of the mat particle is measured by a Coulter counter method, and the measured distribution is reduced into particle number distribution.

By adjusting a refractive index of the translucent resin in conformity with the refractive index of each translucent particle selected among these particles, it is possible to attain the internal haze and surface haze of the invention. Concretely, a combination of a translucent resin composed of, as the major component, a trifunctional or polyfunctional (meth)acrylate monomer (refractive index after hardening: 1.55 to 1.70) which is preferably used in the antiglare layer of the invention as described later and a translucent particle made of a crosslinked poly(meth)acrylate polymer having a styrene content of from 50 to 100% by weight and/or a benzoquanamine particle is preferable; and a combination of the foregoing translucent resin and a translucent particle made of a crosslinked poly(styrene-acrylate) copolymer having a styrene content of from 50 to 100% by weight (refractive index: 1.54 to 1.59) is especially preferable.

It is preferable that the translucent particle is blended such that it is contained in an amount of from 3 to 30% by weight in the whole of solids of the antiglare layer in the formed antiglare layer. The amount of the translucent particle is more preferably from 5 to 20% by weight.

Furthermore, the translucent particle preferably has a density of from 10 to 1,000 mg/m², and more preferably from 100 to 700 mg/m².

Furthermore, an absolute value of a difference between the refractive index of the translucent resin and the refractive index of the translucent particle is preferably not more than 0.04. The absolute value of a difference between the refractive index of the translucent resin and the refractive index of the translucent particle is more preferably from 0.001 to 0.030, further preferably from 0.001 to 0.020, and especially preferably from 0.001 to 0.015.

Here, the refractive index of the foregoing translucent resin can be quantitatively determined and evaluated by, for example, direct measurement by an Abbe's refractometer or measurement of a spectral reflection spectrum or spectral ellipsometry. The refractive index ofthe foregoing translucent particle is measured by dispersing an equivalent amount of the translucent particle in a solvent having a varied refractive index by varying a mixing ratio of two kinds of solvents having a different refractive index to measure a turbidity and measuring a refractive index of the solvent at which the turbidity becomes minimum by an Abbe's refractometer.

Furthermore, two or more kinds of mat particles having a different particle size may be used together. It is possible to impart antiglare properties by a mat particle having a larger particle size and to impart other optical characteristics by a mat particle having a smaller particle size, respectively. For example, in the case where an antiglare antireflection film is stuck onto a high definition display with 133 ppi or more, a fault on display image quality which is called “glare” may possibly be caused. The “glare” is derived from the matter that pixels are enlarged or shrunk by irregularities present on the surface of the antiglare antireflection film so that uniformity of luminance is lost. It is possible to largely improve the glare by using a mat particle having a smaller particle size than the mat particle capable of imparting the antiglare properties and having a different refractive index from the binder together.

The thickness of the antiglare layer is preferably from 1 to 10 μm, and more preferably from 1.2 to 8 μm. When the antiglare layer is too thin, hard properties are insufficient, whereas when it is too thick, curl or brittleness is deteriorated so that processing adaptability may possibly be lowered. Thus, it is preferable that the thickness of the antiglare layer falls within the foregoing range.

On the other hand, the center line mean roughness (Ra) of the antiglare layer is preferably in the range of from 0.10 to 0.40 μm. Furthermore, a value of transmitted image sharpness is preferably from 5 to 60%.

The strength of the antiglare layer is preferably H or more, more preferably 2H or more, and most preferably 3H or more by a pencil hardness test.

3-(2) Hard Coat Layer:

For the purpose of imparting a physical strength to the film, in addition to the antiglare layer, a hard coat layer can be provided in the film of the invention.

Preferably, a low refractive index layer is provided thereon; and more preferably, a middle refractive index layer and a high refractive index layer are provided between the hard coat layer and the low refractive index layer, thereby constituting an antireflection film.

The hard coat layer may be constituted by stacking of two or more layers.

In the invention, according to an optical design for obtaining an anti-reflection film, the hard coat layer preferably has a refractive index in the range of from 1.48 to 2.00, more preferably from 1.52 to 1.90, and further preferably from 1.55 to 1.80. In the invention, since at least one low refractive index layer is present on the hard coat layer, when the refractive index is excessively low as compared with this range, the antireflection properties are lowered, whereas when it is excessively high, a color taste of the reflected light tends to become strong.

From the viewpoint of imparting sufficient durability and impact resistance to the film, the thickness of the hard coat layer is usually from about 0.5 μm to 50 μm, preferably from 1 μm to 20 μm, more preferably from 2 μm to 10 μm, and most preferably from 3 μm to 7 μm.

Furthermore, the strength of the hard coat layer is preferably H or more, more preferably 2H or more, and most preferably 3H or more by a pencil hardness test.

In addition, it is preferable that an abrasion amount of a specimen before and after the test is small as far as possible in a taber test according to JIS K5400.

It is preferable that the hard coat layer is formed by a crosslinking reaction or polymerization reaction of an ionizing radiation hardenable compound. For example, it is possible to form the hard coat layer by coating a coating composition containing an ionizing radiation hardenable polyfunctional monomer or polyfunctional oligomer on a transparent support and subjecting the polyfunctional monomer or polyfunctional oligomer to a crosslinking reaction or polymerization reaction.

As a functional group of the ionizing radiation hardenable polyfunctional monomer or polyfunctional oligomer, a photopolymerizable functional group, an electron beam polymerizable functional group, and a radiation polymerizable functional group are preferable, with a photopolymerizable functional group being especially preferable.

Examples of the photopolymerizable functional group include unsaturated polymerizable functional groups such as a (meth)acryloyl group, a vinyl group, a styryl group, and an allyl group, with a (meth)acryloyl group being preferable.

For the purpose of imparting internal scattering properties, a mat particle having an average particle size of from 1.0 to 10.0 μm, and preferably from 1.5 to 7.0 μm, for example, a particle of an inorganic compound or a resin particle may be contained in the hard coat layer.

For the purpose of controlling the refractive index of the hard coat layer, a high refractive index monomer or an inorganic particle or the both can be added in a binder of the hard coat layer. The inorganic particle has an effect for suppressing hardening and shrinkage due to the crosslinking reaction in addition to the effect for controlling the refractive index. In the invention, it is called a binder including a polymer as formed by polymerization of the foregoing polyfunctional monomer and/or high refractive index monomer, etc. and an inorganic particle as dispersed therein after the formation of the hard coat layer.

For the purpose of holding the image sharpness, it is preferred to adjust the transmitted image sharpness in addition to the adjustment of the irregular shape of the surface. A clear antireflection film preferably has a transmitted image sharpness of 60% or more. The transmitted image sharpness is in general an index to show a blurring state of an image which is transmitted through the film and projected. The larger this value, the better the sharpness of the image as seen through the film is. The transmitted image sharpness is preferably 70% or more, and more preferably 80% or more.

3-(3) High Refractive Index Layer and Middle Refractive Index Layer:

In the film of the invention, the antireflection properties can be enhanced by providing a high refractive index layer and a middle refractive index layer.

In this specification, the high refractive index layer and the middle refractive index layer will be sometimes named generically as a high refractive index layer. Incidentally, in the invention, the terms “high”, “middle” and “low” of the high refractive index layer, middle refractive index layer and low refractive index layer express a relative large and small relation mutually among the layers. Furthermore, so far as the relation with the transparent support is concerned, it is preferable that the refractive index is satisfied with the relationships of
[(transparent support)>(low refractive index layer)] and [(high refractive index layer)>(transparent support)].

Furthermore, in this specification, the high refractive index layer, the middle refractive index layer and the low refractive index layer will be sometimes named generically as an antireflection layer.

For the purpose of constructing a low refractive index layer on a high refractive index layer to prepare an antireflection film, the high refractive index layer preferably has a refractive index of from 1.55 to 2.40, more preferably from 1.60 to 2.20, further preferably from 1.65 to 2.10, and most preferably from 1.80 to 2.00.

In the case where a middle refractive index layer, a high refractive index layer and a low refractive index layer are coated and provided in this order on a support to prepare an antireflection film, the high refractive index layer preferably has a refractive index of from 1.65 to 2.40, and more preferably from 1.70 to 2.20. The refractive index of the middle refractive index layer is adjusted so as to have a value between a refractive index of the low refractive index layer and a refractive index of the high refractive index layer. The refractive index of the middle refractive index layer is preferably from 1.55 to 1.80.

An inorganic particle composed of, as the major component, TiO₂ which is used in the high refractive index layer and the middle refractive index layer is used in a state of dispersion for the formation of the high refractive index layer and the middle refractive index layer.

In dispersing the inorganic particle, the inorganic particle is dispersed in a dispersion medium in the presence of a dispersant.

It is preferable that the high refractive index layer and the middle refractive index layer which are used in the invention are preferably formed by further adding a binder precursor necessary for the formation of a matrix (for example, an ionizing radiation hardenable polyfunctional monomer or polyfunctional oligomer as described later), a photopolymerization initiator, and the like in a dispersion having an inorganic particle dispersed in a dispersion medium, thereby preparing a coating composition for forming a high refractive index layer and a coating composition for forming a middle refractive index layer, coating the coating composition for forming a high refractive index layer and the coating composition for forming a middle refractive index layer on a transparent support, and then hardening them by a crosslinking reaction or polymerization reaction of an ionizing radiation hardenable compound (for example, a polyfunctional monomer and a polyfunctional oligomer).

In addition, it is preferable that the binder of the high refractive index layer and the binder of the middle refractive index are subjected to a crosslinking reaction or polymerization reaction with the dispersant at the same time of or after coating the layers.

In the thus prepared binder of the high refractive index layer and binder of the middle refractive index, for example, the foregoing preferred dispersant and ionizing radiation hardenable polyfunctional monomer or polyfunctional oligomer undergo a crosslinking reaction or polymerization reaction, whereby an anionic group of the dispersant is taken into each of the binders. In addition, in each of the binder of the high refractive index layer and the binder of the middle refractive index, the anionic group has a function to hold a dispersed state of the inorganic particle, and the crosslinking or polymerization structure imparts a film forming ability to the binder, thereby improving the physical strength, chemical resistance and weather resistance of the high refractive index layer and the middle refractive index layer each containing an inorganic particle.

The binder of the high refractive index layer is added in an amount of from 5 to 80% by weight based on the solids content of the coating composition of the subject layer.

The content of the inorganic particle in the high refractive index layer is preferably from 10 to 90% by weight, more preferably from 15 to 80% by weight, and especially preferably from 15 to 75% by weight based on the weight of the high refractive index layer. Two or more kinds of inorganic particles may be used together within the high refractive index layer.

In the case where the low refractive index layer is present on the high refractive index layer, it is preferable that the refractive index of the high refractive index layer is higher than the refractive index of the transparent support.

In the high refractive index layer, a binder which is obtainable by a crosslinking or polymerization reaction, such as aromatic ring-containing ionizing radiation hardenable compounds, ionizing radiation hardenable compounds containing a halogen atom other than fluorine (for example, Br, I and Cl), and ionizing radiation hardenable compounds containing an atom such as S, N and P can also be preferably used.

The thickness of the high refractive index layer can be adequately designed depending upon the application. In the case where the high refractive index layer is used as an optical interference layer as described later, its thickness is preferably from 30 to 200 nm, more preferably from 50 to 170 nm, and especially preferably from 60 to 150 nm.

In the case where the high refractive index layer does not contain a particle capable of imparting an antiglare function, it is preferable that a haze of the high refractive index layer is low as far as possible. The haze is preferably not more than 5%, more preferably not more than 3%, and especially preferably not more than 1%.

It is preferable that the high refractive index layer is constructed on the foregoing transparent support directly or via other layer.

3-(4) Antistatic Layer and Conductive Layer:

In the invention, it is preferred from the standpoint of destaticization on the film surface to provide an antistatic layer, in addition to the low refractive index layer. Examples of a method of forming an antistatic layer include conventionally known methods such as a method of coating a conductive coating solution containing a conductive fine particle and a reactive hardenable resin and a method of forming a conductive thin film by vapor deposition or sputtering of a metal or metal oxide capable of forming a transparent film or the like. The conductive layer can be formed on the support directly or via a primer layer capable of strengthening adhesion to the support. Furthermore, the antistatic layer can be used as a part of the antireflection film. In this case, in the case where the antistatic layer is used in a layer close to the outermost layer, even when the film is thin, it is possible to sufficiently obtain antistatic properties.

The antistatic layer preferably has a thickness of from 0.01 to 10 μm, more preferably from 0.03 to 7 μm, and further preferably from 0.05 to 5 μm. The antistatic layer preferably has a surface resistivity of from 10⁵ to 10¹² Ω/sq, more preferably from 10⁵ to 10⁹ Ω/sq, and most preferably from 10⁵ to 10⁸ Ω/sq. The surface resistivity can be measured by a four probe method.

It is preferable that the antistatic layer is substantially transparent. Concretely, the antistatic layer preferably a haze of not more than 10%, more preferably not more than 5%, further preferably not more than 3%, and most preferably not more than 1%. The antistatic layer preferably has a transmittance against light having a wavelength of 550 nm of 50% or more, more preferably 60% or more, further preferably 65% or more, and most preferably 70% or more.

The antistatic layer of the invention is excellent in strength. Concretely, the antistatic layer preferably has a strength of H or more, more preferably 2H or more, further preferably 3H or more, and most preferably 4H or more in terms of a pencil hardness with a load of 1 kg.

3-(5) Antifouling Layer:

It is possible to provide an antifouling layer on the outermost surface of the invention. The antifouling layer decreases surface energy of the antireflection layer, thereby making hydrophilic or oleophilic stains hardly attach.

The antifouling layer can be formed by using a fluorine-containing polymer or an antifouling agent.

The antifouling layer preferably has a thickness of from 2 to 100 nm, and more preferably from 5 to 30 nm.

3-(6) Layer for Preventing Interference Unevenness (Spectral Unevenness):

In the case where there is a substantial difference in refractive index between the transparent support and the hard coat layer or between the transparent support and the antiglare layer (the difference in refractive index is 0.3 or more), reflected light is generated on the interface between the transparent support and the hard coat layer or between the transparent support and the antiglare layer. This reflected light may possibly interfere with reflected light on the surface of the antireflection layer, thereby generating interference unevenness as caused due to delicate unevenness in thickness of the hard coat layer (or the antiglare layer). In order to prevent such interference unevenness, for example, a layer for preventing interference unevenness, which has a middle refractive index np and whose thickness dp is satisfied with the following expression, can also be provided between the transparent support and the hard coat layer (or the antiglare layer).
dₚ=(2N−1)×λ/(4nₚ)

In the foregoing expression, λ represents a wavelength of visible light and is any value in the range of from 450 to 650 nm; and N represents a natural number.

Furthermore, when the antireflection film is stuck onto an image display, etc. there may be the case where a pressure sensitive adhesive layer (or an adhesive layer) is stacked in the side of the transparent support on which the antireflection layer is not stacked. In such an embodiment, when there is a substantial difference in refractive index (0.3 or more) between the transparent support and the pressure sensitive adhesive layer (or the adhesive layer), there may be the case where reflected light is generated between the transparent support and the pressure sensitive adhesive layer (or the adhesive layer), and this reflected light interferes with reflected light on the surface of the antireflection layer or the like, thereby generating interference unevenness as caused due to unevenness in thickness of the support or the hard coat layer likewise the foregoing case. For the purpose of preventing such interference unevenness, a layer for preventing interference unevenness similar to the foregoing layer for preventing interference unevenness can be provided in the side of the transparent support on which the antireflection layer is not stacked.

Incidentally, such a layer for preventing interference unevenness is described in detail in JP-A-2004-345333, and the layer for preventing interference unevenness as presented in JP-A-2004-345333 can also be employed in the invention.

3-(7) Easy Adhesion Layer:

An easy adhesion layer can be coated and provided in the film of the invention. The “easy adhesive layer” as referred to herein means, for example, a layer capable of imparting a function to make the protective film for polarizing plate and its adjacent layer, or the hard coat layer and the support easy adhere to each other.

Examples of the easy adhesion treatment include a treatment for providing an easy adhesion layer on a transparent plastic film by an easy adhesive made of a polyester, an acrylic ester, a polyurethane, a polyethyleneimine, a silane coupling agent, or the like.

Examples of the easy adhesion layer which is preferably used in this technology include a layer containing a polymer compound containing a —COOM group (wherein M represents a hydrogen atom or a cation). A more preferred embodiment is concerned with one in which a layer containing a —COOM group-containing polymer compound is provided in the side of the film substrate and a layer containing, as the major component, a hydrophilic polymer compound is provided adjacent thereto in the side of a polarizing film. Examples of the —COOM group-containing polymer compound as referred to herein include a —COOM group-containing styrene-maleic acid copolymer and a —COOM group-containing vinyl acetate-maleic acid copolymer or vinyl acetate-maleic acid-maleic anhydride copolymer. It is especially preferred to use a —COOM group-containing vinyl acetate-maleic acid copolymer. Such a polymer compound is used singly or in admixture of two or more kinds thereof, and its weight average molecular weight is preferably from about 500 to 500,000. As an especially preferred example of the —COOM group-containing polymer compound, those as described in JP-A-6-094915 and JP-A-7-333436 are suitably used.

Furthermore, preferred examples of the hydrophilic polymer compound include hydrophilic cellulose derivatives (for example, methyl cellulose, carboxymethyl cellulose, and hydroxycellulose), polyvinyl alcohol derivatives (for example, polyvinyl alcohol, a vinyl acetate-vinyl alcohol copolymer, polyvinyl acetal, polyvinyl formal, and polyvinyl benzal), natural polymer compounds (for example, gelatin, casein, and gum arabi), hydrophilic polyester derivatives (for example, partially sulfonated polyethylene terephthalate), and hydrophilic polyvinyl derivatives (for example, poly-N-vinylpyrrolidone, polyacrylamide, polyvinyl indazole, and polyvinyl pyrazole). Such a hydrophilic polymer compound is used singly or in admixture of two or more kinds thereof.

The easy adhesion layer preferably has a thickness in the range of from 0.05 to 1.0 μm. When the thickness of the easy adhesion layer is less than 0.05 μm, sufficient adhesion is hardly obtained, whereas when it exceeds 1.0 μm, an adhesion effect is saturated.

3-(8) Anticurl Layer:

It is possible to subject the film of this technology to anticurl processing. The “anticurl processing” as referred to herein is to impart a function to roll up the surface to which the anticurl processing has been applied inwardly. By applying this processing, in applying some surface processing onto one surface of a transparent resin film, thereby applying surface processing with different degree and type to the both surfaces, it works to prevent a phenomenon in which the subject surface is curled inwardly from occurring.

There are enumerated an embodiment in which an anticurl layer is provided in a side of a substrate opposite to the side in which the antiglare layer or antireflection layer is provided; an embodiment in which an easy adhesion layer is coated and provided on one surface of a transparent resin film; and an embodiment in which anticurl processing is applied onto the opposite surface.

Specific examples of the anticurl processing include coating with a solvent and coating and providing a transparent resin layer made of a solvent and cellulose triacetate, cellulose diacetate, cellulose acetate propionate, or the like. Concretely, a method using a solvent as referred to herein is carried out by coating a composition containing a solvent capable of dissolving or swelling therein a cellulose acylate film which is used as a protective film for polarizing plate. Accordingly, as a coating solution of the layer having a function to prevent curl from occurring, one containing a ketone based or ester based organic solvent is preferable. Preferred examples of the ketone based organic solvent include acetone, methyl ethyl ketone, methyl isobutyl ketone, cyclohexanone, ethyl lactate, acetylacetone, diacetone alcohol, isophorone, ethyl n-butyl ketone, diisopropyl ketone, diethyl ketone, di-n-propyl ketone, methyl cyclohexanone, methyl n-butyl ketone, methyl n-propyl ketone, methyl n-hexyl ketone, and methyl n-heptyl ketone; and preferred examples of the ester based organic solvent include methyl acetate, ethyl acetate, butyl acetate, methyl lactate, and ethyl lactate. However, there may be the case where, in addition to a mixture of a solvent capable of dissolving a cellulose acylate film therein and/or a solvent capable of swelling a cellulose acylate film therein, a solvent which does not dissolve a cellulose acylate film therein is contained as the solvent to be used. The anticurl processing is carried out by using a composition obtained by mixing these solvents in a proper proportion depending upon the curl degree of the transparent resin film and the kind of the resin in a coating amount. Besides, the anticurl function is also revealed by applying transparent hard processing or antistatic processing.

3-(9) Water Absorbing Layer:

A water absorbing agent can be used in the film of the invention. The water absorbing agent can be selected among compounds having a water absorbing function while centering an alkaline earth metal. Examples thereof include BaO, SrO, CaO, and MgO. In addition, the water absorbing agent can also be selected among metal elements such as Ti, Mg, Ba, and Ca. A particle size of such an absorbing agent particle is preferably not more than 100 nm, and more preferably not more than 50 nm.

The layer containing such a water absorbing agent may be prepared by employing a vacuum vapor deposition method likewise the foregoing barrier layer, or a nano particle may be prepared by a variety of methods. The thickness of the layer is preferably from 1 to 100 nm, and more preferably from 1 to 10 nm. The water absorbing agent-containing layer may be added between a support and a stack (a stack of a barrier layer and an organic layer), in the uppermost layer of a stack, between stacks, or an organic layer or a barrier layer in a stack. In the case of adding in a barrier layer, it is preferred to employ a co-vapor deposition method.

3-(10) Primer Layer or Inorganic Thin Film Layer:

In the film of the invention, it is possible to enhance gas barrier properties by placing a known primer layer or inorganic thin film layer between the support and the stack.

For the primer layer, for example, an acrylic resin, an epoxy resin, a urethane resin, and a silicone resin can be used. However, in the invention, an organic/inorganic hybrid layer is preferable as this primer layer. Furthermore, an inorganic vapor deposition layer or a minute inorganic coating thin film by a sol-gel method is preferable as the inorganic thin film layer. The inorganic vapor deposition layer can be formed by a vacuum vapor deposition method, a sputtering method, or the like.

4. Production Method:

The film of the invention can be formed in the following method, but it should not be construed that the invention is limited thereto.

4-(1) Preparation of Coating Solution

<Preparation>

First of all, a coating solution containing components for forming each layer is prepared. On that occasion, by minimizing the amount of volatilization of a solvent, it is possible to suppress an increase of the water content in the coating solution. The water content in the coating solution is preferably not more than 5%, and more preferably not more than 2%. Suppression of the amount of volatilization of the solvent is achieved by, for example, improving tightness at the time of stirring after charging the respective raw materials in a tank and minimizing an air contact area of the coating solution at the time of liquid transfer works. Furthermore, a measure for lowering the water content in the coating solution during coating or before or after coating may be provided.

<Physical Properties of Coating Solution>

In the coating system of the invention, since an upper limit rate at which coating is possible is largely influenced by physical properties of the solution, it is necessary to control physical properties of the solution at a moment of coating, in particular viscosity and surface tension.

The viscosity is preferably not more than 2.0 [mPa·sec], more preferably not more than 1.5 [mPa·sec], and most preferably not more than 1.0 [mPa·sec]. Since the viscosity varies with a shear rate depending upon the coating solution, the foregoing value shows a viscosity at the shear rate at the moment of coating. By adding a thixotropic agent in the coating solution, the viscosity becomes low at the time of coating at which high shear is applied, whereas the viscosity becomes high at the time of drying at which shear is not substantially applied to the coating solution so that unevenness is hardly generated at the time of drying. Thus, such is preferable.

Furthermore, in addition to the physical properties of the solution, the amount of the coating solution to be coated on the support also influences the upper limit rate at which coating is possible. The amount of the coating solution to be coated on the support is preferably from 2.0 to 5.0 [mL/m²]. By increasing the amount of the coating solution to be coated on the support, the upper limit rate at which coating is possible increases, and therefore, such is preferable. However, when the amount of the coating solution to be coated on the support is excessively increased, a load to be applied for drying becomes large. Thus, it is preferred to determine an optimum amount of the coating solution to be coated on the support by solution formulation and process condition.

The surface tension is preferably in the range of from 15 to 36 [mN/m]. It is preferred to lower the surface tension by adding a leveling agent or other means because unevenness at the time of drying is controlled. On the other hand, when the surface tension decreases too much, the upper limit rate at which coating is possible is lowered. Thus, the surface tension is more preferably in the range of from 17 [mN/m] to 32 [mN/m], and further preferably in the range of from 19 [mN/m] to 26 [mN/m].

<Filtration>

It is preferable that the coating solution which is used for coating is filtered prior to coating. With respect to a filter for the filtration, it is preferred to use a filter having a pore size as small as possible within the range in which the components in the coating solution are not removed. For the filtration, a filter having an absolute filtration accuracy of from 0.1 to 10 μm is used, and a filter having an absolute filtration accuracy of from 0.1 to 5 μm is preferably used. The filter preferably has a thickness of from 0.1 to 10 mm, and more preferably from 0.2 to 2 mm. In that case, the filtration is preferably carried out under a filtration pressure of not more than 1.5 MPa, more preferably not more than 1.0 MPa, and further preferably not more than 0.2 MPa.

A filtration filter member is not particularly limited so far as it does not influence the coating solution. Concretely, there is enumerated a filtration member for a wet dispersion of an inorganic compound the same as described previously.

Furthermore, it is also preferable that the filtered coating solution is ultrasonically dispersed just before coating, thereby assisting defoaming and dispersing and holding of the dispersion.

4-(2) Treatment Before Coating:

It is preferable that the support which is used in the invention is subjected to a surface treatment before coating. Specific examples thereof include a corona discharge treatment, a glow discharge treatment, a flame treatment, an acid treatment, an alkaline treatment, and an ultraviolet ray irradiation treatment. Furthermore, it is also preferably utilized to provide an undercoat layer as described in JP-A-7-333433.

In addition, examples of a dust removal method which is employed in a dust removal process as a process prior to coating include dry dust removal methods such as a method of pressing a non-woven fabric, a blade, etc, onto the film surface as described in JP-A-59-150571; a method of blowing air with high cleanliness at a high speed to separate deposits from the film surface and sucking the separated deposits by an adjacent suction opening as described in JP-A-10-309553; and a method of blowing ultrasonically vibrating compressed air to separate deposits and sucking the deposits (for example, NEW ULTRASONIC CLEANER, manufactured by Shinko Co., Ltd.) as described in JP-A-7-333613.

Furthermore, there are also employable wet dust removal methods such as a method of introducing a film into a cleaning tank and separating deposits by an ultrasonic vibrator; a method of feeding a cleaning solution into a film, blowing high-speed air and performing suction as described in JP-B-49-13020; and a method of continuously rubbing a web by a liquid-wetted roll and then spraying a liquid onto the rubbed surface to achieve cleaning as described in JP-A-2001-38306. Of these dust removal methods, a method by ultrasonic dust removal and a method by wet dust removal are especially preferable in view of the dust removal effect.

Furthermore, destaticization of static electricity on the film support prior to the dust removal process is especially preferable in view of increasing an efficiency of dust removal and suppressing attachment of dusts. For achieving such a destaticization method, it is possible to use an ionizer of a corona discharge system, an ionizer of an irradiation system with light such as UV and soft X-rays, etc. The film support before and after dust removal and coating desirably has a charging voltage of not more than 1,000 V, preferably not more than 300 V, and especially preferably not more than 100 V.

From the viewpoint of holding the flatness of the film, it is preferable that the temperature of the cellulose acylate film is controlled at not higher than Tg, specifically not higher than 150° C. in these treatments.

In the case where the cellulose acylate film is made to adhere to a polarizing film as in the case of using the film of the invention as a protective film for polarizing plate, it is especially preferable from the viewpoint of adhesion to the polarizing film that an acid treatment or an alkaline treatment, namely a saponification treatment with respect to the cellulose acylate is carried out.

From the viewpoint of adhesion or the like, the cellulose acylate film preferably has surface energy of 55 mN/m or more, and more preferably 60 mN/m or more and not more than 75 mN/m. The surface energy can be adjusted by the foregoing surface treatment.

4-(3) Coating:

The respective layers of the film of the invention can be formed by the following coating methods, but it should not be construed that the invention is limited to these methods.

There are employed known methods such as a dip coating method, an air knife coating method, a curtain coating method, a roll coating method, a wire bar coating method, a gravure coating method, and an extrusion coating method (die coating method) (see U.S. Pat. No. 2,681,294), and a microgravure coating method. Of these, a microgravure coating method and a die coating method are preferable.

The “microgravure coating method” as referred to herein, which is employed in the invention, is a coating method which is characterized by disposing a gravure roll having a diameter of from about 10 to 100 mm, and preferably from about 20 to 50 mm and engraved with a gravure pattern over the entire periphery thereof beneath the support and simultaneously revolving the gravure roll in an inverse direction to the conveyance direction of the support and scraping away the excessive coating solution from the surface of the subject gravure roll by a doctor blade and transferring a fixed amount of the coating solution onto a lower surface of the support in a position at which the upper surface of the support is in a free state, thereby achieving coating. The transparent support in a roll state is continuously wound out, and at least one layer of a hard coat layer and a fluorine-coating olefin based polymer-containing low refractive index layer can be coated in one side of the wound-out support by the microgravure coating method.

With respect to the coating condition by the microgravure method, the number of lines of the gravure pattern as engraved on the gravure roll is preferably from 50 to 800 lines per inch, and more preferably from 100 to 300 lines per inch; a depth of the gravure pattern is preferably from 1 to 600 μm, and more preferably from 5 to 200 μm; the revolution number of the gravure roll is preferably from 3 to 800 rpm, and more preferably from 5 to 200 rpm; and a conveyance speed of the support is preferably from 0.5 to 100 m/min, and more preferably from 1 to 50 m/min.

In order to feed the film of the invention with high productivity, an extrusion coating method (die coating method) is preferably employed. In particular, a die coater which can be preferably employed in a region with a small wet coating amount (not more than 20 cc/m²) such as the hard coat layer and the antireflection layer will be described below.

4-(4) <Drying>

It is preferable that after coating on the support directly or via other layer, the film of the invention is conveyed into a zone heated for drying the solvent by means of a web.

As a method of drying the solvent, a variety of knowledge can be utilized. Specific examples of the knowledge include methods as described in JP-A-2001-286817, JP-A-2001-314798, JP-A-2003-126768, JP-A-2003-315505, and JP-A-2004-34002.

The temperature of the drying zone is preferably from 25° C. to 140° C.; and it is preferable that the temperature of the first half of the drying zone is relatively low, whereas the temperature of the second half of the drying zone is relatively high. However, it is preferable that the temperature is not higher than the temperature at which volatilization of the components other than the solvent to be contained in the coating composition of each layer starts. For example, among commercially available photo radical generators which are used together with an ultraviolet ray hardenable resin, there are ones in which a several tens % portion thereof is volatilized within several minutes in warm air of 120° C. Furthermore, among monofunctional or bifunctional acrylate monomers, there are ones in which volatilization proceeds in warm air of 100° C. In such case, it is preferable that the temperature of the drying zone is not higher than the temperature at which volatilization of the components other than the solvent to be contained in the coating composition of each layer starts.

Furthermore, it is preferable that with respect to the dry air after coating the coating composition of each layer on the support, when the solids content of the coating composition is from 1 to 50%, for the purpose of preventing drying unevenness from occurring, it is preferable that the air velocity on the surface of the coating film is in the range of from 0.1 to 2 m/sec.

Moreover, after coating the coating composition of each layer on the support, when a difference in temperature between a conveyance roll coming into contact with an opposite surface of the support to a coating surface is made to fall within the range of from 0° C. to 20° C. in the drying zone, drying unevenness due to heat transmission unevenness on the conveyance roll can be prevented from occurring, and therefore, such is preferable.

4-(5) Hardening:

After drying the solvent, the film of the invention is passed through a zone capable of hardening each coating film by ionizing radiations and/or heat by the web, whereby the coating film can be hardened.

It is preferable that the film of the invention is heated at a temperature of 70° C. or higher and not higher than 130° C. for a period of time of from 5 minutes to 20 minutes, followed by hardening by active energy rays represented by ultraviolet rays.

The heat hardening temperature is preferably 70° C. or higher and not higher than 120° C., and most preferably 80° C. or higher and not higher than 115° C.

In the invention, the species of the ionizing radiations is not particularly limited and can be properly selected among ultraviolet rays, electron beams, near ultraviolet rays, visible light, near infrared rays, infrared rays, and X-rays depending upon the kind of the hardenable composition from which a film is formed. Above all, ultraviolet rays and electron beams are preferable; and ultraviolet rays are especially preferable from the standpoints that handling is simple and easy and that high energy is easily obtained.

As a light source of ultraviolet rays for photopolymerizing an ultraviolet ray reactive compound, any light source can be used so far as it is able to emit ultraviolet rays. For example, a low pressure mercury vapor lamp, a middle pressure mercury vapor lamp, a high pressure mercury vapor lamp, an extra-high pressure mercury vapor lamp, a carbon arc lamp, a metal halide lamp, a xenon lamp, and so on can be used. Furthermore, an ArF excimer laser, a KrF excimer laser, an excimer lamp, a synchrotron radiation, and so on can be used, too. Above all, an extra-high pressure mercury vapor lamp, a high pressure mercury vapor lamp, a low pressure mercury vapor lamp, a carbon arc lamp, a xenon arc lamp, and a metal halide lamp can be preferably used.

Further, electron beams can be similarly used. As the electron beams, there can be enumerated electron beams having energy of from 50 to 1,000 keV, and preferably from 100 to 300 keV, which are emitted from a variety of electron beam accelerators such as a Cockcroft-Walton type electron beam accelerator, a van de Graaff type electron beam accelerator, a resonant transformation type electron beam accelerator, an insulating core transformer type electron beam accelerator, a linear type electron beam accelerator, a dynamitron type electron beam accelerator, and a high frequency type electron beam accelerator.

The irradiation condition varies depending upon the respective lamp. An irradiation dose is preferably 10 mJ/cm² or more, more preferably from 50 mJ/cm² to 10,000 mJ/cm², and especially preferably from 50 mJ/cm² to 2,000 mJ/cm². On that occasion, the irradiation dose distribution in a width direction of the web including the both ends is preferably from 50 to 100%, and more preferably from 80 to 100% on the basis of a maximum irradiation dose in the center.

In the invention, it is preferred to harden at least one layer stacked on the support by a step for irradiating ionizing radiations in an atmosphere having an oxygen concentration of not more than 10% by volume in a state of irradiating ionizing radiation and heating at a film surface temperature of 60° C. or higher for a period of time of 0.5 seconds or more after starting the irradiation with ionizing radiations.

It is also preferable that heating is carried out in an atmosphere having an oxygen concentration of not more than 3% by volume simultaneously with or subsequently to the irradiation with ionizing radiations.

In particular, it is preferable that the low refractive index layer which is the outermost layer and has a thin thickness is hardened by this method. The hardening reaction is accelerated by heat, whereby a film having excellent physical strength and chemical resistance can be formed.

The time for irradiating ionizing radiations is preferably 0.7 seconds or more and not more than 60 seconds, and more preferably 0.7 seconds or more and not more than 10 seconds.

It is preferable that a film is formed in an atmosphere having an oxygen concentration of not more than 6% by volume by a crosslinking reaction or polymerization reaction of the ionizing radiation hardenable compound. The oxygen concentration of the atmosphere is more preferably not more than 4% by volume, especially preferably not more than 2% by volume, and most preferably not more than 1% by volume. In order to reduce the oxygen concentration to more than the necessity, a large amount of an inert gas such as nitrogen is required, and therefore, such is not preferable from the viewpoint of production costs.

As a measure for controlling the oxygen concentration to not more than 10% by volume, it is preferred to substitute the air (nitrogen concentration: about 79% by volume, oxygen concentration: about 21% by volume) with other gas. It is especially preferred to substitute (purge) the air with nitrogen.

By feeding an inert gas into an ionizing radiation irradiation chamber and setting up a condition so as to slightly blow out the inert gas into a web inlet side of the irradiation chamber, not only it is possible to exclude entrained air following the conveyance and to effectively decrease an oxygen concentration of a reaction chamber, but also it is possible to effectively decrease a substantial oxygen concentration on the polar surface having large hardening hindrance due to oxygen. The direction of the inert gas flow in the web inlet side of the irradiation chamber can be controlled by adjusting a balance between air supply and exhaustion of the irradiation chamber.

With respect to a method for excluding the entrained air, it is preferably employed to blow the inert gas directly on the web surface.

Furthermore, by providing a front chamber before the foregoing reaction chamber to exclude oxygen on the web surface in advance, it is possible to make the hardening proceed more efficiently. Moreover, for the purpose of efficiently using the inert gas, a gap between the side face constructing the web inlet side of the ionizing radiation reaction chamber or front chamber and the web surface is preferably from 0.2 to 15 mm, more preferably from 0.2 to 10 mm, and most preferably from 0.2 to 5 mm. However, in order to continuously produce a web, it is necessary to join and connect the web. For joining, there is widely used a method of sticking it with a joining tape, etc. For that reason, when the gap between the inlet face of the ionizing radiation reaction chamber or front chamber and the web is excessively narrow, there is caused a problem such that a joining member such as a joining tape is stuck. For that reason, in order to make the gap narrow, it is preferable that at least a part of the inlet face of the ionizing radiation reaction chamber or front chamber is made movable such that when a joining part enters, the gap is widened in a proportion corresponding to the joining thickness. In order to realize this, there are employable a method in which the inlet face of the ionizing radiation reaction chamber or front chamber is made movable back and forth in the direction of movement and when the joining part passes therethrough, moves back and forth, thereby widening the gap; and a method in which the inlet face of the ionizing radiation reaction chamber or front chamber is made movable in a direction vertical to the web surface and when the joining part passes therethrough, moves up and down, thereby widening the gap.

In hardening, it is preferable that the film surface is heated at 60° C. or higher and not higher than 170° C. When the heating temperature is lower than 60° C., an effect by heating is low, whereas when it exceeds 170° C., there is caused a problem such as deformation of the substrate. The heating temperature is more preferably from 60° C. to 100° C. The temperature of the “film surface” as referred to herein means a temperature of the film surface of a layer to be hardened. Furthermore, the time required for reaching the foregoing temperature is 0.1 seconds or more and not more than 300 seconds, and more preferably not more than 10 seconds after starting the UV irradiation. When the time for keeping the temperature of the film surface within the foregoing temperature range is too short, the reaction of the hardenable composition capable of forming a film cannot be accelerated. On the other hand, when it is too long, an optical performance of the film is lowered, and there is caused a problem in the production such that equipment becomes large.

Though the heating method is not particularly limited, and preferred examples thereof include a method of heating a roll and bringing it into contact with the film; a method of blowing heated nitrogen; and irradiation with far infrared rays or infrared rays. A method of performing heating while making a medium such as warm water, vapors and oils flow into a rotating metal roll as described in Japanese Patent No. 2523574 can be utilized, too. As a measure for heating, a dielectric heating roll or the like may be used.

The irradiation with ultraviolet rays may be carried out every time of providing one layer for the respective constitutional plural layers or after stacking. Alternatively, the irradiation may be carried out by combining them. It is preferable from the standpoint of productivity that ultraviolet rays are irradiated after stacking multiple layers.

In the invention, it is possible to harden at least one layer as stacked on the support by irradiation with ionizing radiations plural times. In this case, it is preferable that the irradiation with ionizing radiations is carried out at least two times in continuous reactions chambers where the oxygen concentration does not exceed 3% by volume. By carrying out the irradiation with ionizing radiations plural times in reaction chambers having the same low oxygen concentration, it is possible to effectively ensure the reaction time necessary for hardening.

In particular, in the case of increasing the production speed for high productivity, in order to ensure energy of ionizing radiations necessary for the hardening reaction, it is necessary to carry out the irradiation with ionizing radiations plural times.

Furthermore, in the case where a hardening rate [100−(residual functional group content)] is a value less than 100%, in providing a layer thereon and hardening by ionizing radiations and/or heat, when the hardening rate of a lower layer is higher than that before providing an upper layer, the adhesiveness between the lower layer and the upper layer is improved, and therefore, such is preferable.

4-(6) Handling:

For the purpose of continuously producing the film of the invention, a step for continuously delivering a support film in a rolled state; a step for coating and drying a coating solution; a step for hardening a coating film; and a step for winding up the support film having a hardened layer are carried out.

A film support is continuously delivered from the film support in a rolled state into a clean chamber; static electricity as charged on the film support is destaticized by a destaticization unit within the clean chamber; and a foreign substance as attached on the film support is subsequently removed by a dust removing unit. Subsequently, the coating solution is coated on the film support in a coating part as placed within the clean chamber, and the coated film support is sent into a drying chamber and dried.

The film support having a dried coating layer is delivered from the drying chamber into a hardening chamber, and a monomer as contained in the coating layer is polymerized and hardened. In addition, the film support having a hardened layer is sent into a hardening part, thereby completing hardening; and the film support having a completely hardened layer is wound up and becomes in a rolled state.

The foregoing steps may be carried out every time of forming each layer. By providing a plural number of coating part/drying chamber/hardening part, it is also possible to carry out the formation of each layer.

In order to prepare the film of the invention, it is preferable that at the same time of the foregoing microfiltration operation of the coating solution, the coating step in the coating part and the drying step to be carried out in the drying chamber are carried out in an air atmosphere with high cleanliness and that prior to carrying out coating, contaminants and dusts on the film are thoroughly removed. The air cleanliness in the coating step and the drying step is desirably class 10 (the number of particles of 0.5 μm or larger is not more than 353/m³) or more, and more desirably class 1 (the number of particles of 0.5 μm or larger is not more than 35.5/m³) or more on the basis of the air cleanliness according to the Federal Standard No. 209E. Furthermore, it is also preferable that the air cleanliness is high, too in other steps than the coating and drying step such as delivery and winding up.

4-(7) Saponification Treatment:

In preparing a polarizing plate by using the film of the invention as one of two surface protective films of polarizing film, it is preferred to improve the adhesion on the adhesive surface by hydrophilizing the surface in a side at which the polarizing film is stuck. Specific ekamples of the saponification treatment which can be applied include a method of dipping in an alkaline solution; a method of coating an alkaline solution; a method of achieving saponification by protecting the surface which is not desired to be saponified by a laminate film; a method of achieving a saponification treatment prior to coating of a layer which is weak against alkalis and then coating a necessary layer; and a method of coating the layer of the invention on a previously saponified film.

4-(8) Preparation of Polarizing Film:

The film of the invention can be used as a polarizing film by using it as a polarizing film and a protective film as disposed in one side or both sides thereof.

The film of the invention may be used as one protective film, while using a usual cellulose acetate film as the other protective film. However, it is preferred to use a cellulose acetate film which is produced by the foregoing solution film formation method and stretched in a width direction in a rolled film state in a stretching ratio of from 10 to 100%.

In addition, in the polarizing plate of the invention, it is preferable that one surface thereof is made of an antireflection film, whereas the other protective film is an optical compensating film made of a liquid crystalline compound.

Examples of the polarizing film include an iodine based polarizing film, a dye based polarizing film using a dichroic dye, and a polyene based polarizing film. The iodine based polarizing film and the dye based polarizing film are in general produced by using a polyvinyl alcohol based film.

A slow axis of the transparent support of the antireflection film or the cellulose acetate film and a transmission axis of the polarizing film are disposed substantially parallel to each other.

For the productivity of the polarizing plate, moisture permeability of the protective film is important. The polarizing film and the protective film are stuck to each other by an aqueous adhesive, and a solvent of this adhesive is diffused into the protective film, thereby achieving drying. When the moisture permeability of the protective film is high, the drying becomes fast, and the productivity is improved. However, when the moisture permeability is excessively high, the moisture enters the polarizing film by the use circumstance (under high humidity) of a liquid crystal display device, whereby a polarizing ability is lowered.

The moisture permeability of the protective film is determined by thickness, free volume, hydrophilicity or hydrophobicity, and so on of the transparent support or polymer film (and polymerizable liquid crystal compound).

In the case where the film of the invention is used as a protective film for polarizing plate, the moisture permeability is preferably from 100 to 1,000 g/m²·24 hrs, and more preferably from 300 to 700 g/m²·24 hrs.

In the case of film formation, the thickness of the transparent support can be adjusted by a lip flow rate and a line speed, or stretching or compression. Since the moisture permeability varies depending upon the major raw material to be used, it is possible to set up the moisture permeability in a preferred range by adjusting the thickness.

In the case of film formation, the free volume of the transparent support can be adjusted by drying temperature and time.

In this case, since the moisture permeability also varies depending upon the major raw material to be used, it is possible to set up the moisture permeability in a preferred range by adjusting the free volume.

The hydrophilicity or hydrophobicity of the transparent support can be adjusted by an additive. By adding a hydrophilic additive in the foregoing free volume, the moisture permeability becomes high, whereas by adding a hydrophobic additive, the moisture permeability can be made low.

By independently controlling the foregoing moisture permeability, it is possible to produce a polarizing plate having an optical compensating ability cheaply with high productivity.

As the polarizing film, known polarizing films and polarizing films which are cut out from a longitudinal polarizing film whose absorption axis is neither parallel nor vertical to the longitudinal direction may be used. The longitudinal polarizing film whose absorption axis is neither parallel nor vertical to the longitudinal direction is prepared by the following method.

That is, this polarizing film is a polarizing film as prepared by stretching a continuously fed polymer film by imparting a tension while holding the both ends thereof by holding units. The polarizing film can be produced in a stretching method in which the film is stretched in a ratio of from 1.1 to 20.0 times in at least a film width direction; a difference in movement speed in a longitudinal direction between the holding units in the both film ends is within 3%; and the direction of movement of the film is bent in a state of holding the both film ends such that an angle between the direction of movement of the film in an outlet of the step for holding the both film ends and the substantial stretching direction of the film is inclined at from 20° to 70°. In particular, a polarizing film in which the subject angle is inclined at 45° is preferably used from the viewpoint of productivity.

The stretching method of the polymer film is described in detail in JP-A-2002-86554, paragraphs [0020] to [0030].

It is also preferable that of two protective films of a polarizer, a film other than the antireflection film is an optical compensating film having an optical compensating layer containing an optically anisotropic layer. The optical compensating film (retardation film) is able to improve a viewing angle characteristic of a liquid crystal display screen.

Known optical compensating films can be used as the optical compensating film. An optical compensating film as described in JP-A-2001-100042 is preferable from the standpoint of widening a viewing angle.

5. Use Embodiment of the Invention:

The film of the invention is used for image display devices such as a liquid crystal display device (LCD), a plasma display panel (PDP), an electroluminescence display device (ELD), and a cathode ray tube display device (CRT). An optical filter according to the invention can be used on a known display such as a plasma display panel (PDP) and a.

5-(1) Liquid Crystal Display Device:

The film of the invention can be advantageously used for image display devices such as a liquid crystal display device. It is preferred to use the film of the invention in the outermost layer of a display.

The liquid crystal display device has a liquid crystal cell and two polarizing plates as disposed in the both sides thereof, and the liquid crystal cell supports a liquid crystal between two electrode substrates. In addition, one optically anisotropic layer may be disposed between the liquid crystal cell and one of the polarizing plates, or two optically anisotropic layers may be disposed between the liquid crystal cell and each of the both polarizing plates.

It is preferable that the liquid crystal cell is of a TN mode, a VA mode, an OCB mode, an IPS mode, or an ECB mode.

<TN Mode>

In a liquid crystal cell of a TN mode, a rod-like liquid crystalline molecule is substantially horizontally aligned and further aligned in a twisted state at from 60° to 120° at the time of applying no voltage.

The liquid crystal cell of a TN mode is most frequently utilized as a color TFT liquid crystal display device and described in many references.

<VA Mode>

In a liquid crystal cell of a VA mode, a rod-like liquid crystalline molecule is substantially vertically aligned at the time of applying no voltage.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625), (2) a liquid crystal cell of a multi-domained VA mode (MVA mode) for enlarging a viewing angle (as described in SID 97, Digest of Tech. Papers, 28 (1997), page 845), (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Preprints of Forum on Liquid Crystal, pages 58 to 59 (1998), and (4) a liquid crystal cell of a SURVIVAL mode (as announced in LCD International 98).

<OCB Mode>

A liquid crystal cell of an OCB mode is a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystalline molecule is symmetrically aligned in the upper and lower parts of a liquid crystal cell, the liquid crystal cell of a bend alignment mode has a self optical compensating ability. For that reason, this liquid crystal mode is named as an OCB (optically compensatory bend) liquid crystal mode. A liquid crystal display device of a bend alignment mode involves an advantage such that the response speed is fast.

<IPS Mode>

A liquid crystal cell of an IPS mode is of a system of switching by applying a lateral electric field to a nematic liquid crystal and is described in detail in Proc. IDRC (Asia Display '95), pages 577 to 580 and pages 707 to 710.

<ECB Mode>

In a liquid crystal cell of an ECB mode, a rod-like liquid crystalline molecule is substantially horizontally aligned at the time of applying no voltage. The ECB mode is one of liquid crystal display modes having the simplest structure and is described in detail in, for example, JP-A-5-203946.

5-(2) Displays Other than Liquid Crystal Display Device:

<PDP>

A plasma display panel (PDP) is in general constituted of a gas, a glass substrate, an electrode, an electrode lead material, a thick film printing material, and a fluorescent material. The glass substrate is constituted of two sheets of a front glass substrate and a rear glass substrate. In each of the two glass substrates, an electrode and an insulating layer are formed. In the rear glass substrate, a fluorescent material layer is further formed. The two glass substrates are assembled, and a gas is sealed therebetween.

The plasma display panel (PDP) is already marketed. The plasma display panel is described in JP-A-5-205643 and JP-A-9-306366.

There may be the case where a front plate is disposed in front of the plasma display panel. It is preferable that the front plate has a sufficient strength for protecting the plasma display panel. The front plate can be used at an interval from the plasma display panel or can be used by sticking directly on the plasma display panel main body.

In image display devices such as a plasma display panel, an optical filter can be stuck directly on the display surface. Furthermore, in the case where a front plate is provided in front of the display, it is also possible to stick an optical filter in the front side (external side) or rear side (display side) of the front plate.

<Touch panel>

The film of the invention can be applied to touch panels as described in JP-A-5-127822 and JP-A-2002-48913, and so on.

<Organic EL Element>

The film of the invention can be used as a substrate (substrate film) or a protective film of an organic EL element and so on.

In the case where the film of the invention is used in an organic EL element or the like, the contents as described in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617, and JP-A-2002-056976 can be applied. Furthermore, it is preferred to use the contents as described in JP-A-2001-148291, JP-A-2001-221916, and JP-A-2001-231443 in combination.

### EXAMPLES

The invention will be described below in detail with reference to the Examples, but it should not be construed that the invention is limited thereto. In the following Examples and Synthesis Examples, the term “%” is % by weight unless otherwise indicated.

### Example 1

<Preparation of Antireflection Film>

[Synthesis of Fluorine-Containing Polymer]

### Synthesis Example 1

### Synthesis of Fluorine-Containing Polymer P1

In a stainless steel-made stirrer-equipped autoclave having an internal volume of 100 mL, 40 mL of ethyl acetate, 14.7 g of hydroxyethyl vinyl ether (HEVE) and 0.55 g of dilauroyl peroxide were charged, and the inside of the system was deaerated and purged with a nitrogen gas. In addition, 25 g of hexafluoropropylene (HFP) was introduced into the autoclave, and the temperature was raised to 65° C. At a point of time when the temperature in the autoclave reached 65° C., the pressure was 5.4 kg/cm². The reaction was continued for 8 hours while keeping the temperature in the autoclave at 65° C., and at a point of time when the pressure reached 3.2 kg/cm², the heating was stopped, followed by allowing it to stand for cooling.

At a point of time when the internal temperature dropped to room temperature, the unreacted monomers were expelled, and the autoclave was opened, and the reaction solution was taken out. The obtained reaction solution was thrown into a large excess of hexane, the solvent was removed by decantation, and a precipitated polymer was taken out. In addition, this polymer was dissolved in a small amount of ethyl acetate and reprecipitated twice from hexane, thereby completely removing the residual monomers. After drying, 28 g of a copolymer P1 having a molar ratio of HFP to HEVE of 1/1 was obtained. The obtained polymer had a number average molecular weight of 15,000.

### Synthesis Examples 2 to 5

Fluorine-containing polymers P31, P45, P47 and P53 were synthesized in substantially the same manner as in the synthesis of P1 of the foregoing Synthesis Example 1. A number average molecular weight of each of the obtained fluorine-containing polymers was shown in the foregoing Tables 2 to 5.

### Synthesis Example 6

### Synthesis of p-Toluenesulfonic Acid Salt

3.0 g of diethylmethylamine was dissolved in 30 cm³ of 2-butanone, to which was then gradually added 5.7 g of p-toluenesulfonic acid monohydrate while stirring. The stirring was continued for an additional one hour, and the solvent was then distilled off in vacuo. The obtained solid was recrystallized from acetone to obtain a diethylmethylamine salt of p-toluenesulfonic acid.

(Preparation of Sol Solution (a))

In a reactor equipped with a stirrer and a reflux condenser, 120 parts of methyl ethyl ketone, 100 parts of acryloyloxypropyl trimethoxysilane (KBM-5103, manufactured by Shin-Etsu Chemical Co., Ltd.) and 3 parts of diisopropoxyaluminum ethyl acetoacetate were added and mixed. After adding 30 parts of ion exchanged water, the mixture was allowed to react at 60° C. for 4 hours, followed by cooling to room temperature. The reaction product had a weight average molecular weight of 1,600, and among components including oligomer or polymer components, components having a molecular weight of from 1,000 to 20,000 accounted for 100%. Furthermore, the gas chromatographic analysis revealed that the starting acryloyloxypropyl trimethoxysilane did not remain at all. The reaction solution was adjusted with methyl ethyl ketone so as to have a solids content of 29%, thereby preparing a sol solution (a).

(Preparation of Antimony Oxide-Coated Silica Based Fine Particle (P-1))

1. Preparation of Silica Based Fine Particle (A-1):

A mixture of 100 g of a silica sol having an average particle size of 5 nm and an SiO₂ concentration of 20% by weight and 1,900 g of pure water was heated at 80° C. This reaction mother liquor had a pH of 10.5, and 9,000 g of a sodium silicate aqueous solution of 1.17% by weight as SiO₂ and 9,000 g of a sodium aluminate aqueous solution of 0.83% by weight as Al₂O₃ were simultaneously added to the mother liquor. Meanwhile, the temperature of the reaction solution was kept at 80° C. The pH of the reaction solution rose to 12.5 immediately after the addition. Thereafter, the pH did not substantially change. After completion of the addition, the reaction solution was cooled to room temperature and washed by an ultrafiltration membrane, thereby preparing a primary particle dispersion of SiO₂.Al₂O₃ having a solid concentration of 20% by weight.

To 500 g of this primary particle dispersion, 1,700 g of pure water was added, followed by heating at 98° C. While keeping this temperature, 53,200 g of ammonium sulfate having a concentration of 0.5% by weight was added, and 3,000 g of a sodium silicate aqueous solution of 1.17% by weight as SiO₂ and 9,000 g of a sodium aluminate aqueous solution of 0.5% by weight as Al₂O₃ were subsequently added, thereby obtaining a dispersion of composite oxide fine particle (1).

Subsequently, 1,125 g of pure water was added to 500 g of the dispersion of composite oxide fine particle (1) having a solid concentration of 13% by weight after washing by an ultrafiltration membrane, to which was further added dropwise concentrated hydrochloric acid (concentration: 35.5% by weight) to adjust the pH at 1.0, thereby undergoing a dealumination treatment. Subsequently, the dissolved aluminum salt was separated by an ultrafiltration membrane while adding 10 L of a hydrochloric acid aqueous solution having a pH of 3 and 5 L of pure water, thereby preparing a dispersion of silica based fine particle (A-1) having a solid concentration of 20% by weight.

This silica based fine particle (A-1) had an average particle size of 58 nm, an MOₓ/SiO₂ molar ratio of 0.0097 and a refractive index of 1.30.

2. Preparation of Antimonic Acid:

111 g of antimony trioxide (KN, manufactured by Sumitomo Metal Mining Co., Ltd., purity: 98.5% by weight) was suspended in a solution of 57 g of caustic potash (manufactured by Asahi Glass Co., Ltd., purity: 85% by weight) dissolved in 1,800 g of pure water. This suspension was heated at 95° C., to which was then added an aqueous solution of 32.8 g of aqueous hydrogen peroxide (a special grade as manufactured by Hayashi Pure Chemical Ind., Ltd., purity: 35% by weight) diluted with 110.7 g of pure water over 9 hours (0.1 moles/hr), thereby dissolving the antimony trioxide, followed by ripening for 11 hours. After cooling, 1,000 g of the resulting solution was taken, diluted with 6,000 g of pure water and then subjected to a deionization treatment through a cation exchange resin (PK-216, manufactured by Mitsubishi Chemical Corporation). At this time, the pH was 2.1, and the conductivity was 2.4 mS/cm.

3. Preparation of antimony Oxide-Coated Silica Based Fine Particle (P-1):

40 g of antimonic acid having a solid concentration of 1% by weight was added to 400 g of a dispersion resulting from diluting the thus prepared dispersion of silica based fine particle (A-1) so as to have a solid concentration of 1% by weight, and the mixture was stirred at 70° C. for 10 hours and then concentrated by an ultrafiltration membrane, thereby preparing a dispersion of antimony oxide-coated silica based fine particle (P-1) having a solid concentration of 20% by weight. 300 g of pure water and 400 g of methanol were added to 100 g of this dispersion of antimony oxide-coated silica based fine particle (P-1), with which was then mixed 3.57 g of ethyl orthosilicate (SiO₂ concentration: 28% by weight). The mixture was stirred under heating at 50° C. for 15 hours, thereby preparing a dispersion of antimony oxide-coated silica based fine particle (P-1) having a silica coating layer formed thereon. This dispersion was subjected to solvent displacement by methanol by using an ultrafiltration membrane and also concentrated so as to have a solid concentration of 20% by weight. The concentrate was subjected to solvent displacement by isopropyl alcohol by a rotary evaporator, thereby preparing an isopropyl alcohol dispersion of silica based fine particle (P-1) having a concentration of 20% by weight.

Subsequently, 0.73 g of a methacrylic silane coupling agent (KBM-503, manufactured by Shin-Etsu Chemical Co., Ltd.) was added to 100 g of this isopropyl alcohol dispersion of antimony oxide-coated silica based fine particle (P-1) having a silica coating layer formed thereon, and the mixture was stirred under heating at 50° C. for 15 hours to form a silica coating layer, thereby preparing a dispersion of surface-treated antimony oxide-coated silica based fine particle (P-1).

(Preparation of Antimony Oxide-Coated Silica Based Fine Particle (P-2))

A dispersion of surface-treated antimony oxide-coated silica based fine particle (P-2) was prepared in the same manner as in the foregoing preparation of antimony oxide-coated silica based fine particle (P-1), except for changing the amount of antimonic acid having a solid concentration of 1% by weight to 100 g.

[Preparation of Antireflection Film]

[Preparation of Coating Solutions for Low Refractive Index Layer (LL-1 to LL-37)]

The respective components as shown in Table 7 were mixed and dissolved in MEK to prepare coating solutions for low refractive index layer each having a solids content of 8%. The numerical values in the parenthesis in Table 7 express a part by weight of the solid of each of the components.

TABLE 7

| Coating | Fluorine-containing | | Silica | | Hardening | |
|---|---|---|---|---|---|---|
| solution | polymer | | fine particle | | agent | |
| No. | No. | (Use amount) | Kind | (Use amount) | Kind | (Use amount) |
| LL-1 | P1 | (90) | — | — | CYMEL 303 | (10) |
| LL-2 | P1 | (60) | MEK-ST-L | (30) | CYMEL 303 | (10) |
| LL-3 | P1 | (60) | P-1 | (30) | CYMEL 303 | (10) |
| LL-4 | P1 | (46.5) | P-1 | (30) | CYMEL 303 | (10) |
| LL-5 | P1 | (46.5) | P-1 | (30) | CYMEL 303 | (10) |
| LL-6 | P1 | (60) | P-2 | (30) | CYMEL 303 | (10) |
| LL-7 | P1 | (60) | P-2 | (30) | CYMEL 303 | (10) |
| LL-8 | P1 | (46.5) | P-2 | (30) | CYMEL 303 | (10) |
| LL-9 | P31 | (76.5) | — | — | CYMEL 303 | (10) |
| LL-10 | P31 | (46.5) | MEK-ST-L | (30) | CYMEL 303 | (10) |
| LL-11 | P31 | (56.5) | P-1 | (20) | CYMEL 303 | (10) |
| LL-12 | P31 | (46.5) | P-1 | (30) | CYMEL 303 | (10) |
| LL-13 | P31 | (46.6) | P-1 | (30) | CYMEL 303 | (10) |
| LL-14 | P31 | (56.5) | P-2 | (20) | CYMEL 303 | (10) |
| LL-15 | P31 | (46.5) | P-2 | (30) | CYMEL 303 | (10) |
| LL-16 | P31 | (44) | P-2 | (20) | CYMEL 303 | (12.5) |
| LL-17 | P45 | (74) | — | — | CYMEL 303 | (12.5) |
| LL-18 | P45 | (49) | MEK-ST-L | (25) | CYMEL 303 | (12.5) |
| LL-19 | P45 | (49) | P-1 | (25) | CYMEL 303 | (12.5) |
| LL-20 | P45 | (49) | P-1 | (25) | CYMEL 303 | (12.5) |
| LL-21 | P45 | (49) | P-1 | (25) | H-a/H-b | (12.5) |
| LL-22 | P45 | (49) | P-1 | (25) | CYMEL 303 | (12.5) |
| LL-23 | P45 | (49) | P-2 | (25) | CYMEL 303 | (12.5) |
| LL-24 | P47 | (78) | — | — | CYMEL 303 | (8.5) |
| LL-25 | P47 | (43) | P-1 | (35) | CYMEL 303 | (8.5) |
| LL-26 | P47 | (43) | P-1 | (35) | TAKANATE | (8.5) |
| | | | | | D110 | |
| LL-27 | P47 | (46.5) | P-1 | (35) | CYMEL 303 | (8.5) |
| LL-28 | P47 | (46.5) | P-1 | (35) | CYMEL 303 | (8.5) |
| LL-29 | P47 | (46.5) | P-1 | (35) | CYMEL 303 | (8.5) |
| LL-30 | P47 | (46.5) | P-1 | (35) | CYMEL 303 | (8.5) |
| LL-31 | P47 | (46.5) | P-2 | (35) | CYMEL 303 | (8.5) |
| LL-32 | P47 | (46.5) | P-2 | (35) | CYMEL 303 | (8.5) |
| LL-33 | P53 | (46.5) | P-1 | (30) | CYMEL 303 | (10) |
| LL-34 | P53 | (46.5) | P-1 | (30) | H-a/H-b | (10) |
| LL-35 | P53 | (46.5) | P-1 | (30) | CYMEL 303 | (10) |
| LL-36 | P53 | (46.5) | P-2 | (30) | CYMEL 303 | (10) |
| LL-37 | P53 | (46.5) | P-2 | (30) | CYMEL 303 | (10) |

| | Hardening | | Polyfunctional acrylate | | | | |
|---|---|---|---|---|---|---|---|
| Coating | catalyst | | or sol | | Polysiloxane | | |
| solution No. | Kind | (Use amount) | Kind | (Use amount) | Kind | (Use amount) | Remark |
| LL-1 | PTS | (1.0) | — | — | — | — | Comparison |
| LL-2 | PTS | (1.0) | — | — | — | — | Comparison |
| LL-3 | PTS | (1.0) | — | — | — | — | Invention |
| LL-4 | PTS | (1.0) | Sol solution | (13.5) | — | — | Invention |
| | | | (a) | | | | |
| LL-5 | PTS | (1.0) | Sol solution | (13.5) | FM-4425 | (3.0) | Invention |
| | | | (a) | | | | |
| LL-6 | PTS | (1.0) | — | — | — | — | Invention |
| LL-7 | PTS | (1.0) | — | — | FM-4425 | (3.0) | Invention |
| LL-8 | PTS | (1.0) | Sol solution | (13.5) | FM-4425 | (3.0) | Invention |
| | | | (a) | | | | |
| LL-9 | PTS | (1.0) | Sol solution | (13.5) | — | — | Comparison |
| | | | (a) | | | | |
| LL-10 | PTS | (1.0) | Sol solution | (13.5) | — | — | Comparison |
| | | | (a) | | | | |
| LL-11 | PTS | (1.0) | Sol solution | (13.5) | — | — | Invention |
| | | | (a) | | | | |
| LL-12 | PTS | (1.0) | Sol solution | (13.5) | FM-4425 | (3.0) | Invention |
| | | | (a) | | | | |
| LL-13 | PTS | (1.0) | Sol solution | (13.5) | FM-4425 | (3.0) | Invention |
| | | | (a)/ | | | | |
| | | | DPHA(*1) | | | | |
| LL-14 | PTS | (1.0) | Sol solution | (13.5) | FM-4425 | (3.0) | Invention |
| | | | (a) | | | | |
| LL-15 | PTS | (1.0) | Sol solution | (13.5) | — | — | Invention |
| | | | (a) | | | | |
| LL-16 | PTS | (1.0) | Sol solution | (13.5) | — | — | Invention |
| | | | (a) | | | | |
| LL-17 | PTS | (1.0) | Sol solution | (13.5) | — | — | Comparison |
| | | | (a) | | | | |
| LL-18 | PTS | (1.0) | Sol solution | (13.5) | FM-4425 | (3.0) | Comparison |
| | | | (a) | | | | |
| LL-19 | PTS | (1.0) | Sol solution | (13.5) | — | — | Invention |
| | | | (a) | | | | |
| LL-20 | PTS | (1.0) | Sol solution | (13.5) | FM-4425 | (3.0) | Invention |
| | | | (a) | | | | |
| LL-21 | PTS | (1.0) | Sol solution | (13.5) | FM-4425 | (3.0) | Invention |
| | | | (a) | | | | |
| LL-22 | PTS | (1.0) | Sol solution | (13.5) | X-22-160AS | (3.0) | Invention |
| | | | (a) | | | | |
| LL-23 | PTS | (1.0) | Sol solution | (13.5) | FM-4425 | (3.0) | Invention |
| | | | (a) | | | | |
| LL-24 | PTS | (1.0) | Sol solution | (13.5) | FM-4425 | (2.0) | Comparison |
| | | | (a) | | | | |
| LL-25 | PTS | (1.0) | Sol solution | (13.5) | FM-4425 | (2.0) | Invention |
| | | | (a) | | | | |
| LL-26 | — | — | Sol solution | (13.5) | FM-4425 | (2.0) | Invention |
| | | | (a) | | | | |
| LL-27 | PTS | (1.0) | Sol solution | (10) | — | — | Invention |
| | | | (a) | | | | |
| LL-28 | PTS | (1.0) | Sol solution | (10) | — | — | Invention |
| | | | (a)/ | | | | |
| | | | DPHA(*1) | | | | |
| LL-29 | PTS | (1.0) | Sol solution | (10) | FM-4425 | (2.0) | Invention |
| | | | (a) | | | | |
| LL-30 | PTS | (1.0) | Sol solution | (10) | — | — | Invention |
| | | | (a) | | | | |
| LL-31 | PTS | (1.0) | Sol solution | (10) | — | — | Invention |
| | | | (a) | | | | |
| LL-32 | PTS | (1.0) | Sol solution | (10) | X-22-160AS | (3.0) | Invention |
| | | | (a)/ | | | | |
| | | | DPHA(*1) | | | | |
| LL-33 | PTS | (1.0) | Sol solution | (13.5) | FM-4425 | (3.0) | Invention |
| | | | (a) | | | | |
| LL-34 | PTS | (1.0) | Sol solution | (13.5) | — | — | Invention |
| | | | (a) | | | | |
| LL-35 | PTS | (1.0) | Sol solution | (13.5) | X-22-160AS | (3.0) | Invention |
| | | | (a) | | | | |
| LL-36 | PTS | (1.0) | Sol solution | (13.5) | FM-4425 | (3.0) | Invention |
| | | | (a) | | | | |
| LL-37 | PTS | (1.0) | Sol solution | (13.5) | — | — | Invention |
| | | | (a)/ | | | | |
| | | | DPHA(*1) | | | | |

(*1)Mixture of sol solution (a) and DPHA (1/1) (weight ratio)

Furthermore, the material names and product names in the table are as follows.

MEK-ST-L: Colloidal silica manufactured by Nissan Chemical Industries, Ltd., average particle size: 10 to 15 nm

CYMEL 303: Methyloled melamine, manufactured by Nihon Cytec Industries Inc.

TAKENATE D110: Isocyanate based hardening agent, manufactured by Takeda Pharmaceutical Industries Limited

DPHA: UV hardenable resin, manufactured by Nippon Kayaku Co., Ltd.

PTS: p-Toluenesulfonic acid monohydrate

H-a and H-b are compounds having the following structures. 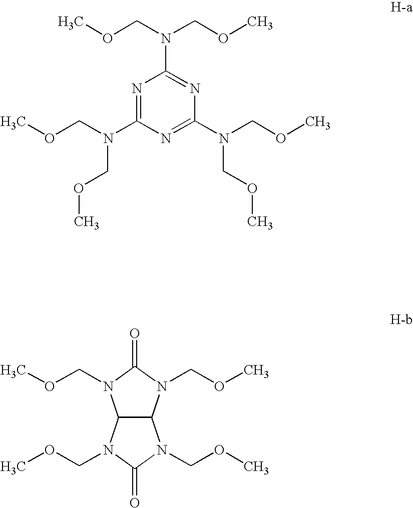
[Preparation of Coating Solution for Antiglare Layer (HCL-1)
PET-30: 50.0 g
IRGACURE 184: 2.0 g
SX-350 (30%): 1.5 g
Crosslinked acryl-styrene particle (30%): 13.9 g
KBM-5103: 10.0 g
Toluene: 38.5 g

The foregoing mixed solution was filtered through a polypropylene-made filter having a pore size of 30 μm, thereby preparing a coating solution for hard coat layer (HCL-1).

The compounds as used herein are as follows.

PET-30: Mixture of pentaerythritol acrylate and pentaerythritol tetraacrylate (manufactured by Nippon Kayaku Co., Ltd.)

IRGACURE 184: Polymerization initiator (manufactured by Ciba Speciality Chemicals)

SX-350: Crosslinked polystyrene particle having an average particle size of 3.5 μm (refractive index: 1.60, manufactured by Soken Chemical & Engineering Co., Ltd.; 30% toluene dispersion, as used after dispersing by a Polytron dispersing machine at 10,000 rpm for 20 minutes)

Crosslinked acryl-styrene particle: Average particle size: 3.5 μm (refractive index: 1.55, manufactured by Soken Chemical & Engineering Co., Ltd.; 30% toluene dispersion, as used after dispersing by a Polytron dispersing machine at 10,000 rpm for 20 minutes)

KBM-5103: Acryloyloxypropyltrimethoxysilane (manufactured by Shin-Etsu Chemical Co., Ltd.)

[Preparation of Antireflection Film Sample 101]

An 80 μm-thick triacetyl cellulose film “TAC-TD80U” (manufactured by Fuji Photo Film Co., Ltd.) was wound out in a rolled state; the foregoing coating solution for hard coat layer (HCL-1) was coated directly thereon by using a microgravure roll with a gravure pattern having 180 lines per inch and a depth of 40 μm and having a diameter of 50 mm and a doctor blade under a condition at a resolution number of gravure roll of 30 rpm and a conveyance rate of 30 m/min; after drying at 60° C. for 150 seconds, the coating layer was hardened upon irradiation with ultraviolet rays having a radiation illuminance of 400 mW/cm² and an irradiation dose of 100 mJ/cm² by using an air-cooled metal halide lamp (manufactured by Eyegraphics Co., Ltd.) of 160 W/cm under purging with nitrogen in an oxygen concentration of 0.1% by volume, thereby forming a layer having a thickness of 6 μm, followed by winding up. The thus prepared and obtained antiglare layer (HC-1) had a surface roughness of Ra=0.18 μm and Rz=1.40 μm, a surface haze of 12% and an internal haze of 29%.

On the thus obtained antiglare layer, the foregoing coating solution for low refractive index layer (LL-1) was coated such that the low refractive index layer had a thickness of 95 nm, thereby preparing an antireflection film sample 101. With respect to the coating solution, the respective components were mixed for 2 hours and then applied; with respect to the drying condition, the low refractive index layer was dried at 100° C. for 8 minutes; and with respect to the ultraviolet ray hardening condition, ultraviolet rays were irradiated at a radiation illuminance of 120 mW/cm² and an irradiation dose of 240 mJ/cm² by using an air-cooled metal halide lamp (manufactured by Eyegraphics Co., Ltd.) of 240 W/cm under purging with nitrogen in an atmosphere having an oxygen concentration of not more than 0.01% by volume.

[Preparation of Antireflection Films 102 to 137]

Antireflection films 102 to 137 were prepared in the same manner as in the antireflection film 101, except that in the preparation of the antireflection film 101, the coating solution for low refractive index layer (LL-1) was replaced by each of the coating solutions (LL-2) to (LL-37).

[Saponification Treatment of Antireflection Film]

Each of the obtained antireflection films was treated and dried under the following saponification standard condition.

Alkaline bath: Sodium hydroxide aqueous solution of 1.5 moles/dm³ at 55° C. for 120 seconds

First water washing bath: Tap water for 60 seconds

Neutralization bath: Sulfuric acid of 0.05 moles/dm³ at 30° C. for 20 seconds

Second water washing bath: Tap water for 60 seconds

Drying: 120° C., 60 seconds

[Evaluation of Antireflection Film]

Each of the thus obtained saponified antireflection films was evaluated in the following manners.

(Evaluation 1) Measurement of Average Reflectance:

An average reflectance at from 450 to 650 nm was employed by the method as described in this specification. With respect to the sample as processed into a polarizing plate, the sample in a polarizing plate state was used as it was; and in the case of a film itself or a display device in a state of not using a polarizing plate, the back surface of the antireflection film was subjected to a roughing treatment and then to a light absorption treatment with a black ink (transmittance at 380 to 780 nm: less than 10%), followed by providing for the measurement on a black table.

(Evaluation 2) Evaluation of Scar Resistance by Steel Wool (SW Resistance):

By using a rubbing tester, a rubbing test was carried out under the following condition.
Evaluation circumstance condition: 25° C., 60% RH
Rubbing material: A steel wool (manufactured by Nippon Steel Wool Co., Ltd., Grade No. 0000) was wound around a rubbing tip part (1 cm×1 cm) of the tester coming into contact with a sample and fixed by a band such that it did not move. Then, a reciprocal rubbing motion was given under the following condition.
Movement distance (one way): 13 cm
Rubbing rate: 13 cm/sec
Load: 500 g/cm²
Contact area of tip part: 1 cm×1 cm
Number of rubbing: 10 reciprocations

The test was carried out by the foregoing method, an oily black ink was applied in the rear side of the rubbed sample, and a scar in the rubbed portion was visually observed by reflected light and evaluated according to the following criteria. A load was set up at 500 g/cm².

A: Even by very careful observation, a scar is not observed at all.

AB: By very careful observation, a weak scar is slightly observed.

B: A weak scar is observed.

BC: A scar is observed to a medium extent.

C: A scar is observed at the first glance.

(Evaluation 3) Evaluation of Scar Resistance by Eraser Rubbing (Eraser Rubbing Resistance):

By using a rubbing tester, a rubbing test was carried out under the following condition.
Evaluation circumstance condition: 25° C., 60% RH
Rubbing material: plastic eraser (MONO, manufactured by Tombow Pencil Co., Ltd.). The plastic eraser was fixed in a rubbing tip part (1 cm×1 cm) of the tester coming into contact with a sample.
Movement distance (one way): 4 cm
Rubbing rate: 2 cm/sec
Load: 500 g/cm²
Contact area of tip part: 1 cm×1 cm
Number of rubbing: 100 reciprocations

An oily black ink was applied in the rear side of the rubbed sample, and a scar in the rubbed portion was visually observed by reflected light and evaluated according to the following criteria.

A: Even by very careful observation, a scar is not observed at all.

AB: By very careful observation, a weak scar is slightly observed.

B: A weak scar is observed.

BC: A scar is observed to a medium extent.

C: A scar is observed at the first glance.

CC: The entire surface of the film is scared.

(Evaluation 4) Marker Ink Wiping Properties:

A film was fixed on a glass surface by an adhesive; a circle of a diameter of 5 mm was written in three times by a pen tip (fine) of a black marking pen “McKee Ultra-fine (a trade name of Zebra Co., Ltd.)” under a condition at 25° C. and 60 RH %; and after 5 seconds, wiping was carried out 20 reciprocations by a bundle of ten-ply folded BEMCOT (a trade name of Asahi Kasei Corporation) under a load to an extent that the BEMCOT bundle was indented. By repeating the foregoing writing and wiping under the foregoing condition until the marker ink mark does not disappear by wiping, it is possible to evaluate antifouling properties in terms of the number of wiping at which wiping is possible. The number of wiping at which wiping is possible was evaluated with an upper limit thereof being 50 times. The number of wiping until the marker ink mark does not disappear is preferably 5 or more, more preferably 10 or more, and most preferably 50 or more.

(Evaluation 5) Evaluation of Surface Resistivity:

A surface resistivity of the surface of the antireflection film in the side having a low refractive index layer (outermost layer) was measured at 25° C. under a relative humidity condition of 60% RH by using a megger/micro ammeter “TR8601” (manufactured by Advantest Corporation).

The evaluation results are shown in Table 8. Incidentally, for example, the term “10E+14” as referred to in the table expresses “1.10×10¹⁴”.

TABLE 8

| | Coating | | | | | | |
|---|---|---|---|---|---|---|---|
| | solution for | | | | | | |
| | low refractive | | | | Marker ink | Surface | |
| | index layer | Reflectance | | Eraser rubbing | wiping | resistivity | |
| Sample No. | No. | (%) | SW resistance | resistance | properties | (Ω/cm²) | Remark |
| 101 | LL-1 | 1.90 | C | C | 2 | 1.10E+14 | Comparison |
| 102 | LL-2 | 1.92 | AB | A | 5 | 1.10E+14 | Comparison |
| 103 | LL-3 | 1.30 | AB | AB | 7 | 3.90E+09 | Invention |
| 104 | LL-4 | 1.31 | A | A | 8 | 3.80E+09 | Invention |
| 105 | LL-5 | 1.31 | A | A | 5 | 3.50E+09 | Invention |
| 106 | LL-6 | 1.83 | AB | AB | 7 | 3.90E+09 | Invention |
| 107 | LL-7 | 1.84 | AB | AB | 7 | 3.50E+09 | Invention |
| 108 | LL-8 | 1.84 | A | A | 7 | 3.50E+09 | Invention |
| 109 | LL-9 | 1.91 | B | BC | 2 | 1.10E+14 | Comparison |
| 110 | LL-10 | 1.92 | A | A | 7 | 1.10E+14 | Comparison |
| 111 | LL-11 | 1.28 | A | A | 15 | 3.80E+09 | Invention |
| 112 | LL-12 | 1.27 | A | A | 17 | 3.50E+09 | Invention |
| 113 | LL-13 | 1.29 | A | A | 16 | 3.50E+09 | Invention |
| 114 | LL-14 | 1.81 | A | A | 15 | 3.50E+09 | Invention |
| 115 | LL-15 | 1.82 | A | A | 14 | 3.90E+09 | Invention |
| 116 | LL-16 | 1.81 | A | A | 14 | 3.90E+09 | Invention |
| 117 | LL-17 | 1.92 | B | BC | 2 | 1.10E+14 | Comparison |
| 118 | LL-18 | 1.93 | A | A | 7 | 1.10E+14 | Comparison |
| 119 | LL-19 | 1.29 | A | A | 11 | 3.80E+09 | Invention |
| 120 | LL-20 | 1.29 | A | A | 14 | 3.50E+09 | Invention |
| 121 | LL-21 | 1.30 | A | A | 14 | 3.50E+09 | Invention |
| 122 | LL-22 | 1.30 | A | A | 14 | 3.80E+09 | Invention |
| 123 | LL-23 | 1.83 | A | A | 13 | 3.50E+09 | Invention |
| 124 | LL-24 | 1.93 | B | BC | 6 | 1.10E+14 | Comparison |
| 125 | LL-25 | 1.31 | A | A | 16 | 3.50E+09 | Invention |
| 126 | LL-26 | 1.32 | A | A | 14 | 3.50E+09 | Invention |
| 127 | LL-27 | 1.31 | A | A | 14 | 3.90E+09 | Invention |
| 128 | LL-28 | 1.31 | A | A | 14 | 3.90E+09 | Invention |
| 129 | LL-29 | 1.30 | A | A | 16 | 3.50E+09 | Invention |
| 130 | LL-30 | 1.30 | A | A | 14 | 3.90E+09 | Invention |
| 131 | LL-31 | 1.82 | A | A | 14 | 3.90E+09 | Invention |
| 132 | LL-32 | 1.82 | A | A | 15 | 3.90E+09 | Invention |
| 133 | LL-33 | 1.30 | A | A | 16 | 3.50E+09 | Invention |
| 134 | LL-34 | 1.31 | A | A | 14 | 3.90E+09 | Invention |
| 135 | LL-35 | 1.31 | A | A | 15 | 3.90E+09 | Invention |
| 136 | LL-36 | 1.83 | A | A | 15 | 3.50E+09 | Invention |
| 137 | LL-37 | 1.83 | A | A | 13 | 3.90E+09 | Invention |

As is clear from the present Examples, it is noted that the antireflection films of the invention are excellent in SW rubbing resistance and eraser rubbing resistance, excellent in antifouling properties and high in conductivity.

### Example 2

A multilayered antireflection film as described below was prepared.

(Preparation of Coating Solution for Hard Coat Layer (HCL-2))

To 90 parts by weight of MEK, 10 parts by weight of cyclohexanone, 85 parts by weight of a polyfunctional acrylate partially modified with caprolactone (DPCA-20, manufactured by Nippon Kayaku Co., Ltd.), 10 parts by weight of KBM-5103 (silane coupling agent as manufactured by Shin-Etsu Chemical Co., Ltd.), and 5 parts by weight of a photopolymerization initiator (IRGACURE 184, manufactured by Ciba Speciality Chemicals) were added and stirred. The mixture was filtered through a polypropylene-made filter having a pore size of 0.4 μm, thereby preparing a coating solution for hard coat layer (HCL-2).

(Preparation of Antireflection Film (201))

An 80 μm-thick triacetyl cellulose film “TAC-TD80U” (manufactured by Fuji Photo Film Co., Ltd.) was wound out in a rolled state; the foregoing coating solution for hard coat layer (HCL-2) was coated directly thereon by using a microgravure roll with a gravure pattern having 180 lines per inch and a depth of 40 μm and having a diameter of 50 mm and a doctor blade under a condition at a resolution number of gravure roll of 30 rpm and a conveyance rate of 30 m/min; after drying at 60° C. for 150 seconds, the coating layer was hardened upon irradiation with ultraviolet rays having a radiation illuminance of 400 mW/cm² and an irradiation dose of 100 mJ/cm² by using an air-cooled metal halide lamp (manufactured by Eyegraphics Co., Ltd.) of 160 W/cm under purging with nitrogen in an oxygen concentration of 0.1% by volume, thereby forming a layer having a thickness of 7 μm, followed by winding up. The thus prepared and obtained hard coat layer (HC-2) had a surface roughness of Ra=0.005 μm and Rz=0.01 μm.

Each of the foregoing LL-1 to LL-37 was coated and provided on the hard coat layer HC-2 in the same manner as in Example 1, thereby preparing antireflection films 201 to 237.

The resulting antireflection films 201 to 237 were each subjected to a saponification treatment and evaluated in the same manner as in Example 1. As a result, it was noted that an antireflection films having low reflection, excellent scar resistance and antifouling properties and high conductivity is obtainable.

### Example 3

A multilayered antireflection film as described below was prepared.

(Preparation of Coating Solution for Hard Coat Layer (HCL-3))

The following composition was thrown into a mixing tank and stirred to prepare a coating solution for hard coat layer.

To 750.0 parts by weight of trimethylolpropane triacrylate (TMPTA, manufactured by Nippon Kayaku Co., Ltd.), 270.0 parts by weight of poly(glycidyl methacrylate) having a weight average molecular weight of 15,000, 730.0 parts by weight of methyl ethyl ketone, 500.0 parts by weight of cyclohexanone, 50.0 parts by weight of a photopolymerization initiator (IRGACURE 184, manufactured by Ciba Speciality Chemicals) were added and stirred.

The mixture was filtered through a polypropylene-made filter having a pore size of 0.4 μm, thereby preparing a coating solution for hard coat layer (HCL-3).

(Preparation of Titanium Dioxide Fine Particle Dispersion)

A titanium dioxide fine particle containing a cobalt and having been subjected to a surface treatment with aluminum hydroxide and zirconium hydroxide (MPT-129C, manufactured by Ishihara Sangyo Kaisha, Ltd., TiO₂/Co₃O₄/Al₂O₃/ZrO₃=90.5/3.0/4.0/0.5 (weight ratio)) was used as the titanium dioxide fine particle.

To 257.1 parts by weight of this particle, 41.1 parts by weight of the following dispersant and 701.8 parts by weight of cyclohexanone were added, and the mixture was dispersed by a Dyno-Mill, thereby preparing a titanium dioxide dispersion having a weight average particle size of 70 nm. 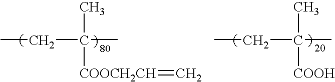
(Preparation of Coating Solution for Middle Refractive Index Layer)

To 99.1 parts by weight of the foregoing titanium dioxide dispersion, 68.0 parts by weight of a mixture (DPHA) of dipentaerythritol pentaacrylate and dipentaerythritol hexaacrylate, 3.6 parts by weight of a photopolymerization initiator (IRGACURE 907), 1.2 parts by weight of a photosensitizer (KAYACURE DETX, manufactured by Nippon Kayaku Co., Ltd.), 279.6 parts by weight of methyl ethyl ketone, and 1,049.0 parts by weight of cyclohexanone were added and stirred. After thoroughly stirring, the mixture was filtered through a polypropylene-made filter having a pore size of 0.4 μm, thereby preparing a coating solution for middle refractive index layer.

(Preparation of Coating Solution for High Refractive Index Layer)

To 469.8 parts by weight of the foregoing titanium dioxide dispersion, 40.0 parts by weight of a mixture (DPHA) of dipentaerythritol pentaacrylate and dipentaerythritol hexaacrylate, 3.3 parts by weight of a photopolymerization initiator (IRGACURE 907, manufactured by Ciba Speciality Chemicals), 1.1 parts by weight of a photosensitizer (KAYACURE DETX, manufactured by Nippon Kayaku Co., Ltd.), 526.2 parts by weight of methyl ethyl ketone, and 459.6 parts by weight of cyclohexanone were added and stirred. The mixture was filtered through a polypropylene-made filter having a pore size of 0.4 μm, thereby preparing a coating solution for high refractive index layer.

(Preparation of Antireflection Film (301))

The foregoing coating solution for hard coat layer was coated on an 80 μm-thick triacetyl cellulose film (TAC-TD80U, manufactured by Fuji Photo Film Co., Ltd.) by using a gravure coater. After drying at 100° C., the coating layer was hardened upon irradiation with ultraviolet rays having a radiation illuminance of 400 mW/cm² and an irradiation dose of 300 mJ/cm² by using an air-cooled metal halide lamp (manufactured by Eyegraphics Co., Ltd.) of 160 W/cm under purging with nitrogen in an oxygen concentration of 1.0% by volume, thereby forming a hard coat layer having a thickness of 8 μm.

On the hard coat layer, the coating solution for middle refractive index layer, the coating solution for high refractive index layer, and the coating solution for low refractive index layer (LL-1) were continuously coated by using a gravure coater having three coating stations.

With respect to the drying condition, the middle refractive index layer was dried at 90° C. for 30 seconds; and with respect to the ultraviolet ray hardening condition, ultraviolet rays were irradiated at a radiation illuminance of 400 mW/cm² and an irradiation dose of 400 mJ/cm² by using an air-cooled metal halide lamp (manufactured by Eyegraphics Co., Ltd.) of 180 W/cm under purging with nitrogen in an atmosphere having an oxygen concentration of not more than 0.1% by volume. The middle refractive index layer after hardening had a refractive index of 1.630 and a thickness of 67 nm.

With respect to the drying condition, the high refractive index layer was dried at 90° C. for 30 seconds; and with respect to the ultraviolet ray hardening condition, ultraviolet rays were irradiated at a radiation illuminance of 600 mW/cm² and an irradiation dose of 400 mJ/cm² by using an air-cooled metal halide lamp (manufactured by Eyegraphics Co., Ltd.) of 240 W/cm under purging with nitrogen in an atmosphere having an oxygen concentration of not more than 0.1% by volume.

The high refractive index layer after hardening had a refractive index of 1.905 and a thickness of 107 nm.

With respect to the drying condition, the low refractive index layer was dried at 120° C. for 60 seconds; and with respect to the ultraviolet ray hardening condition, ultraviolet rays were irradiated at a radiation illuminance of 120 mW/cm² and an irradiation dose of 480 mJ/cm² by using an air-cooled metal halide lamp (manufactured by Eyegraphics Co., Ltd.) of 240 W/cm under purging with nitrogen in an atmosphere having an oxygen concentration of not more than 0.01% by volume.

Samples 302 to 337 were prepared in the same as in the preparation of the thus obtained Sample 301, except for changing the coating solution for low refractive index layer to (LL-2) to (LL-37), respectively. As a result of the saponification treatment and evaluation according to Example 1, the reflectance was largely lowered in all of the samples by providing a middle refractive index layer and a high refractive index layer. It was noted that an antireflection films having low reflection, excellent scar resistance and antifouling properties and high conductivity is obtainable according to the invention.

### Example 4

(Preparation of Coating Solution for Hard Coat Layer (HCL-4)) 100 parts by weight of DeSolite Z7404 (zirconia fine particle-containing hard coat composition solution as manufactured by JSR Corporation), 31 parts by weight of DPHA (UV hardenable resin as manufactured by Nippon Kayaku Co., Ltd.), 10 parts by weight of KBM-5103 (silane coupling agent as manufactured by Shin-Etsu Chemical Co., Ltd.), 8.9 parts by weight of KE-P150 (1.5 μm-silica particle as manufactured by Nippon Shokubai Co., Ltd.), 3.4 parts by weight of MXS-300 (3 μm-crosslinked PMMA particle as manufactured by Soken Chemical & Engineering Co., Ltd.), 29 parts by weight of MEK, and 13 parts by weight of MIBK were thrown in a mixing tank and stirred, thereby preparing a coating solution for hard coat layer.

(Preparation of Antireflection Film)

As a support, a triacetyl cellulose film (TD80U, manufactured by Fuji Photo Film Co., Ltd.) was wound out in a rolled state; the foregoing coating solution for hard coat layer was coated directly thereon by using a microgravure roll with a gravure pattern having 135 lines per inch and a depth of 60 μm and having a diameter of 50 mm and a doctor blade under a condition at a conveyance rate of 10 m/min; after drying at 60° C. for 150 seconds, the coating layer was further hardened upon irradiation with ultraviolet rays having a radiation illuminance of 400 mW/cm² and an irradiation dose of 250 mJ/cm² by using an air-cooled metal halide lamp (manufactured by Eyegraphics Co., Ltd.) of 160 W/cm under purging with nitrogen, thereby forming a hard coat layer, followed by winding up. Ahard coat 401 was prepared by adjusting the revolution number of the gravure roll such that the hard coat layer after hardening had a thickness of 4.0 μm. The thus obtained hard coat 401 had a surface roughness of Ra=0.02 μm, PMS=0.03 μm and Rz=0.25 μm. (Ra (center line mean roughness), RMS (square mean surface roughness) and Rz (n-point mean roughness) were measured by a scanning probe microscope system SPI3800, manufactured by Seiko Instruments Inc.) On the hard coat 401, the low refractive index layer of Example 1 was coated and provided, and the resulting antireflection film was subjected to a saponification treatment and evaluated according to Example 1. As a result, it was noted that an antireflection films having low reflection, excellent scar resistance and antifouling properties and high conductivity is obtainable according to the invention.

### Example 5

<Preparation of Antireflection Film-Provided Polarizing Plate>

Iodine was adsorbed on a stretched polyvinyl alcohol film to prepare a polarizing film. The saponification treated antireflection film of Example 1 was stuck to one side of the polarizing film by using a polyvinyl alcohol based adhesive such that the support (triacetyl cellulose) side of the antireflection film was faced at the polarizing film side. Aviewing angle enlargement film having an optical compensating layer, “WIDE VIEW FILM SA12B” (manufactured by Fuji Photo Film Co., Ltd.) was subjected to a saponification treatment and stuck to the other side of the polarizing film by using a polyvinyl alcohol based adhesive. There was thus prepared a polarizing plate. This polarizing plate was evaluated according to Example 1. As a result, the same effect was obtained by using the low refractive index layer of the invention.

### Example 6

It could be confirmed that transmission type liquid crystal display devices of a TN mode, each having the thus prepared polarizing plate of the invention installed therein, were excellent in visibility, scar resistance and antifouling properties.

### Example 7

The antireflection film sample of Example 2 was stuck to a glass plate on the surface of an organic EL display device via an adhesive. As a result, the reflection on the glass surface was suppressed so that a display device having high visibility was obtained.

### Example 8

(Preparation of ATO-Coated Silica Based Fine Particle (P-3))

A dispersion of an ATO-coated silica based fine particle (P-3) was prepared in the same manner as in the preparation of the antimony oxide-coated silica based fine particle (P-2) in Example 1, except for changing the antimony oxide to ATO.

(Preparation of ITO-Coated Silica Based Fine Particle (P-4))

A dispersion of an ITO-coated silica based fine particle (P-4) was prepared in the same manner as in the preparation of the antimony oxide-coated silica based fine particle (P-2) in Example 1, except for changing the antimony oxide to ITO.

(Preparation of Fluorine-Containing Antifouling Agent (GH-1))

3.0 parts by weight of 1H,1H-perfluoro-3,6,9-trioxadecan-1-ol (a trade name: C7GOL, manufactured by Exfluor Research Corporation) and 3.0 parts by weight of methylolmelamine (a trade name: CYMEL 303, manufactured by Nihon Cytec Industries Inc.) were dissolved in 94 parts by weight of methyl ethyl ketone and refluxed for 3 hours to obtain a fluorine-containing antifouling agent (GH-1) which is a reaction mixture of the both compounds.

(Preparation of Hardening Catalyst (CAT-1))

1.0 part by weight of triethylamine (Illustrative Compound b-19) and 1.9 parts by weight of p-toluenesulfonic acid monohydrate were dissolved in 97.1 parts by weight of methyl ethyl ketone and mixed for 10 minutes to prepare a hardening catalyst (CAT-1).

(Preparation of Hardening Catalyst (CAT-2))

1.0 part by weight of N-methylmorpholine (Illustrative Compound b-19) and 1.9 parts by weight of p-toluenesulfonic acid monohydrate were dissolved in 97.1 parts by weight of methyl ethyl ketone and mixed for 10 minutes to prepare a hardening catalyst (CAT-2).

(Preparation of Antireflection Film)

[Preparation of Coating Solutions for Low Refractive Index Layer (LL-38 to LL-50)]

The respective components as shown in Table 9 were mixed and dissolved in MEK to prepare coating solutions for low refractive index layer each having a solids content of 8%. The numerical values in the parenthesis in Table 9 express a part by weight of the solid of each of the components.

TABLE 9

| | | | |
|---|---|---|---|
| | Fluorine-containing | Silica fine | Hardening |
| Coating solution | polymer | particle | agent |

| No. | No. | (Use amount) | Kind | (Use amount) | Kind | (Use amount) |
|---|---|---|---|---|---|---|
| LL-38 | P38 | (76.0) | — | — | CYMEL 303 | (13.0) |
| LL-39 | P38 | (41.0) | P-1 | (35) | CYMEL 303 | (13.0) |
| LL-40 | P38 | (41.0) | P-3 | (35) | CYMEL 303 | (13.0) |
| LL-41 | P38 | (41.0) | P-4 | (35) | CYMEL 303 | (13.0) |
| LL-42 | P38 | (41.0) | P-1 | (35) | CYMEL 303 | (13.0) |
| LL-43 | P38 | (41.0) | P-1 | (35) | CYMEL 303 | (13.0) |
| LL-44 | P38 | (38.0) | P-1 | (35) | CYMEL 303 | (13.0) |
| LL-45 | P38 | (38.0) | P-1 | (35) | CYMEL 303 | (10.0) |
| LL-46 | P38 | (73.0) | — | — | CYMEL 303 | (10.0) |
| LL-47 | P38 | (38.0) | P-3 | (35) | CYMEL 303 | (10.0) |
| LL-48 | P38 | (38.0) | P-4 | (35) | CYMEL 303 | (10.0) |
| LL-49 | P55 | (76.0) | — | — | CYMEL 303 | (13.0) |
| LL-50 | P55 | (38.0) | P-3 | (35) | CYMEL 303 | (10.0) |

| | Hardening | | Polyfunctional | | | | |
|---|---|---|---|---|---|---|---|
| Coating solution | catalyst | | acrylate or sol | | Polysiloxane | | |
| No. | Kind | (Use amount) | Kind | (Use amount) | Kind | (Use amount) | Remark |
| LL-38 | PTS | (1.0) | Sol solution | (10.0) | — | — | Comparison |
| | | | (a)/ | | | | |
| | | | DPHA (*1) | | | | |
| LL-39 | PTS | (1.0) | Sol solution | (10.0) | — | — | Invention |
| | | | (a)/ | | | | |
| | | | DPHA (*1) | | | | |
| LL-40 | PTS | (1.0) | Sol solution | (10.0) | — | — | Invention |
| | | | (a)/ | | | | |
| | | | DPHA (*1) | | | | |
| LL-41 | PTS | (1.0) | Sol solution | (10.0) | — | — | Invention |
| | | | (a)/ | | | | |
| | | | DPHA (*1) | | | | |
| LL-42 | CAT-1 | (1.0) | Sol solution | (10.0) | — | — | Invention |
| | | | (a)/ | | | | |
| | | | DPHA (*1) | | | | |
| LL-43 | CAT-2 | (1.0) | Sol solution | (10.0) | — | — | Invention |
| | | | (a)/ | | | | |
| | | | DPHA (*1) | | | | |
| LL-44 | CAT-2 | (1.0) | Sol solution | (10.0) | C7GOL | (3.0) | Invention |
| | | | (a)/ | | | | |
| | | | DPHA (*1) | | | | |
| LL-45 | CAT-2 | (1.0) | Sol solution | (10.0) | GH-1 | (6.0) | Invention |
| | | | (a)/ | | | | |
| | | | DPHA (*1) | | | | |
| LL-46 | CAT-2 | (1.0) | Sol solution | (10.0) | GH-1 | (6.0) | Comparison |
| | | | (a)/ | | | | |
| | | | DPHA (*1) | | | | |
| LL-47 | CAT-2 | (1.0) | Sol solution | (10.0) | GH-1 | (6.0) | Invention |
| | | | (a)/ | | | | |
| | | | DPHA (*1) | | | | |
| LL-48 | CAT-2 | (1.0) | Sol solution | (10.0) | GH-1 | (6.0) | Invention |
| | | | (a)/ | | | | |
| | | | DPHA (*1) | | | | |
| LL-49 | PTS | (1.0) | Sol solution | (10.0) | — | — | Comparison |
| | | | (a)/ | | | | |
| | | | DPHA (*1) | | | | |
| LL-50 | CAT-2 | (1.0) | Sol solution | (10.0) | GH-1 | (6.0) | Invention |
| | | | (a)/ | | | | |
| | | | DPHA (*1) | | | | |

Furthermore, in Table 9, “G7GOL” stands for 1H,1H-perfluoro-3,6,9-trioxadecan-1-ol as manufactured by Exfluor Research Corporation.

On the hard coat layer (HLC-2) as prepared in Example 2, each of the coating solutions LL-38 to LL-50 for low refractive index layer was coated and hardened, thereby preparing antireflection films 801 to 813.

By using the thus obtained samples, the foregoing evaluations (1) to (5) were carried out. In addition, the following evaluation (6) was carried out.

(Evaluation 6) Dustproof Properties:

A side of the transparent support of each of the antireflection film samples was stuck on a surface of CRT, and the resulting sample was used in a room having 1,000,000 to 2,000,000 dusts and tissue paper wastes of 0.5 μm or more per 1 ft³ (cubic foot) for 24 hours. The number of attached dusts and tissue paper wastes per 100 cm² of the antireflection film was measured. As a result, the case where the average value is less than 20 was evaluated as “A”; the case where the average value is from 20 to 29 was evaluated as “B”; the case where the average value is from 50 to 199 was evaluated as “C”; and the case where the average value is 200 or more was evaluated as “D”, respectively. The results are shown in Table 10.

TABLE 10

| | Coating | | | | | | | |
|---|---|---|---|---|---|---|---|---|
| | solution for | | | | | | | |
| | low | | | | | | | |
| | refractive | | | Eraser | Marker ink | Surface | | |
| | index layer | Reflectance | SW | rubbing | wiping | resistivity | Dustproof | |
| Sample No. | No. | (%) | resistance | resistance | properties | (Ω/cm²) | properties | Remark |
| 801 | LL-38 | 2.40 | BC | C | 3 | 1.10E+14 | C | Comparison |
| 802 | LL-39 | 2.40 | A | A | 11 | 4.30E+09 | A | Invention |
| 803 | LL-40 | 2.40 | A | A | 11 | 4.20E+09 | A | Invention |
| 804 | LL-41 | 2.42 | A | A | 11 | 4.10E+09 | A | Invention |
| 805 | LL-42 | 2.40 | A | A | 15 | 3.70E+09 | A | Invention |
| 806 | LL-43 | 2.40 | A | A | 15 | 3.40E+09 | A | Invention |
| 807 | LL-44 | 2.40 | A | A | 25 | 3.40E+09 | A | Invention |
| 808 | LL-45 | 2.40 | A | A | 50 | 3.40E+09 | A | Invention |
| 809 | LL-46 | 2.40 | BC | C | 5 | 1.10E+14 | D | Comparison |
| 810 | LL-47 | 2.40 | A | A | 50 | 3.30E+09 | A | Invention |
| 811 | LL-48 | 2.42 | A | A | 50 | 3.20E+09 | A | Invention |
| 812 | LL-49 | 2.40 | BC | C | 3 | 1.10E+14 | C | Comparison |
| 813 | LL-50 | 2.40 | A | A | 50 | 3.30E+09 | A | Invention |

According to Table 10, it is understood that the sample containing a fine particle having a conductive oxide-coated layer of the invention is low in the surface resistivity and excellent in the dustproof properties and scar resistance. Furthermore, it is understood that the sample in which the hardening catalyst is a salt of a base and an acid is large in a lowering of the surface resistivity of the coating film as compared with the sample in which the curing catalyst is an acid (comparison of the sample 802 with the samples 805 and 806). Moreover, it is understood that though the fluorine-containing antifouling agent which is the component (G) of the invention is deteriorated in the dustproof properties and small in an effect for improving the antifouling properties, when used jointly with a fine particle having a conductive oxide-coated layer, not only the scar resistance and the dustproof properties are improved, but also the antifouling properties are drastically improved (comparison of the sample 809 with the samples 808, 810 and 811).

This application is based on Japanese Patent application JP 2005-270279, filed Sep. 16, 2005, the entire content of which is hereby incorporated by reference, the same as if set forth at length.

1. An antireflection film comprising a support and a low refractive index layer made from a coating composition containing the following components (A) and (B):
(A) a fluorine-containing polymer containing at least one fluorine-containing vinyl monomer polymerization unit and at least one hydroxyl group-containing vinyl monomer polymerization unit; and
(B) a particle having a conductive metal oxide-coated layer.

2. The antireflection film according to claim 1, wherein the particle having a conductive metal oxide-coated layer is a particle which is porous in an inside thereof or has voids in an inside thereof.

3. The antireflection film according to claim 1, wherein the particle having a conductive metal oxide-coated layer is a silica based particle having an antimony oxide-coated layer and having a refractive index of from 1.35 to 1.60 and a volume resistivity value of from 10 to 5,000 Ω·cm.

4. The antireflection film according to claim 3, wherein the silica based particle is a porous silica based particle or a silica based particle having voids in an inside thereof.

5. The antireflection film according to claim 1, wherein the coating composition further contains a crosslinking agent capable of reacting with a hydroxyl group.

6. The antireflection film according to claim 1, wherein the coating composition further contains an organosilane compound or at least one of a hydrolyzate of the organosilane compound and a partial condensate of the hydrolyzate.

7. The antireflection film according to claim 1, wherein the coating composition further contains a compound containing two or more (meth)acryloyl groups in one molecule thereof.

8. The antireflection film according to claim 1, wherein the coating composition further contains a compound having a polysiloxane structure represented by the following formula (1) and having a hydroxyl group or a structure capable of reacting with a hydroxyl group to form a bond: 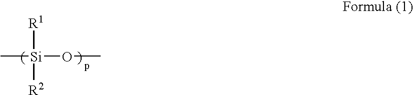
wherein R¹ and R² each independently represents an alkyl group or an aryl group; and p represents an integer of from 2 to 500.

9. The antireflection film according to claim 1, wherein the coating composition further contains a fluorine-containing antifouling agent containing a hydroxyl group or having a structure capable of reacting with a hydroxyl group to form a bond.

10. The antireflection film according to claim 1, wherein the fluorine-containing polymer is a fluorine-containing polymer in which a principal chain thereof is made of only carbon atoms and a content of the hydroxyl group-containing vinyl monomer polymerization unit exceeds 20% by mole.

11. The antireflection film according to claim 1, wherein the fluorine-containing polymer is a copolymer having a polysiloxane structure represented by the following formula (1) in a partial structure thereof: 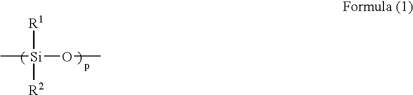
wherein R¹ and R² each independently represents an alkyl group or an aryl group; and p represents an integer of from 2 to 500.

12. The antireflection film according to claim 1, wherein the coating composition further contains at least one salt comprising an organic base and an acid and having a pKa of from 5.0 to 10.5 in terms of a conjugated acid thereof.

13. The antireflection film according to claim 1, wherein the coating composition further contains at least one salt comprising a nitrogen-containing organic base and an acid and having a boiling point of from 35° C. to 85° C.

14. A polarizing plate comprising two protective films and a polarizing film provided between the protective films, wherein one of the protective films is the antireflection film according to claim 1.

15. An image display device comprising the antireflection film according to claim 1, wherein the antireflection film is used for an outermost surface of a display.

16. The polarizing plate according to claim 14, wherein the polarizing plate is used for an outermost surface of a display.
